(19) United States
(12) Patent Application Publication
(10) Pub. No.: US 2014/0173715 A1
(43) Pub. Date: Jun. 19, 2014

(54) INFORMATION PROCESSING SYSTEM, INFORMATION PROCESSING METHOD, DEVICE, AND AUTHENTICATION APPARATUS

(71) Applicant: Shunsuke YANO, Kanagawa (JP)

(72) Inventor: Shunsuke YANO, Kanagawa (JP)

(73) Assignee: RICOH COMPANY, LTD., Tokyo (JP)

(21) Appl. No.: 14/100,090

(22) Filed: Dec. 9, 2013

(30) Foreign Application Priority Data
Dec. 14, 2012 (JP) 2012-273437

(51) Int. Cl. G06F 21/31

(52) U.S. Cl. CPC G06F 21/31
USPC 726/16

(57) ABSTRACT

An information processing system includes a function unit having a plurality of functions; an execution command unit that prompts the function unit to execute one of the plurality of functions; an authentication information obtaining unit that obtains authentication information of a user; and a user authentication and function determination unit that authenticates the user based on the authentication information of the user and determines one function from the plurality of functions. The execution command unit prompts the function unit to execute the one function determined by the user authentication and function determination unit.

### CROSS-REFERENCE TO RELATED APPLICATIONS

The present application is based on and claims priority to Japanese Patent. Application No. 2012-273437 filed on Dec. 14, 2012, the entire contents of which are hereby incorporated by reference.

### BACKGROUND OF THE INVENTION

1. Field of the Invention

The disclosures herein generally relate to an information processing system, an information processing method, a device, and an authentication apparatus.

2. Description of the Related Art

Systems are known for authenticating a user using a user ID and password or an IC card such as an employee ID card before allowing the user to use an image forming apparatus such as a multifunction peripheral (MFP) or some other type of device. In such system, the user may use the image forming apparatus if authentication is successful. However, when user ID and password information is leaked or an IC card is lost, a third party may gain access to the image forming apparatus (so-called “impersonation”). In this respect, techniques with improved security measures are known that involve the use of biometric information (e.g., finger vein, fingerprint) to perform authentication.

For example, Japanese Laid-Open Patent Publication No. 2005-123699 discloses an image forming apparatus employing biometric authentication to maintain security. Biometric authentication provides higher security compared with authentication based on user IDs and passwords or IC cards.

Also, as a technique for improving operability of a device, a so-called “shortcut” method is known that involves assigning operations of commonly used functions to specific keys or buttons, for example.

When authentication is performed using a user ID and password, an IC card, or biological information, a user has to first perform required operations for authentication, and then perform input operations for implementing a function of a device (e.g., image forming apparatus). Note that “required operations for authentication” may include operations such as inputting a user ID and password, inserting an IC card into a prescribed slot, or holding a finger over a prescribed device in the case of performing finger vein authentication, for example. Also, “input operations for implementing a function of a device” may include inputting a desired number of copies and pressing a copy start button to make copies of a document in a case where the function to be implemented corresponds to a function of an image forming apparatus, for example.

Also, even when the shortcut method is used, at least the above required operations for authentication have to be separately performed.

### SUMMARY OF THE INVENTION

It is an object of at least one embodiment of the present invention to provide a technique for simplifying required input operations for authentication and executing a function of a device.

According to one embodiment of the present invention, an information processing system includes a function unit having a plurality of functions; an execution command unit that prompts the function unit to execute one of the plurality of functions; an authentication information obtaining unit that obtains authentication information of a user; and a user authentication and function determination unit that authenticates the user based on the authentication information of the user and determines one function from the plurality of functions. The execution command unit prompts the function unit to execute the one function determined by the user authentication and function determination unit.

According to an aspect of the present invention, required input operations for authentication and executing a function of a device may be simplified and user operability may be improved.

### BRIEF DESCRIPTION OF THE DRAWINGS

FIG. 1 illustrates an exemplary overall configuration of an information processing system according to a first embodiment of the present invention;

FIG. 2 is a block diagram illustrating an exemplary hardware configuration of an image forming apparatus of the information processing system according to the first embodiment;

FIG. 3 is a block diagram illustrating an exemplary hardware configuration of a biometric authentication server of the information processing system according to the first embodiment;

FIG. 4 illustrates an exemplary functional configuration of the information processing system according to the first embodiment;

FIG. 5A is a sequence chart illustrating an exemplary operation flow for obtaining biometric information in the information processing system according to the first embodiment;

FIG. 5B is a sequence chart illustrating an exemplary process flow from biometric authentication to execution of a function in the information processing system according to the first embodiment;

FIG. 6 is a table illustrating exemplary information used for biometric authentication and determining a function to be executed in the information processing system according to the first embodiment and an information processing system according to a fourth embodiment of the present invention;

FIG. 7 is a block diagram illustrating an exemplary functional configuration of an information processing system according to a second embodiment of the present invention;

FIG. 8 is a sequence chart illustrating an exemplary operation flow from biometric authentication to execution of a function in the information processing system according to the second embodiment;

FIG. 9A is a table illustrating exemplary information used for biometric authentication and obtaining biometric information identification information in the information processing system according to the second embodiment and an information processing system according to a fifth embodiment of the present invention;

FIG. 9B is a table illustrating exemplary information used for determining a function to be executed based on biometric information identification information in the information processing system according to the second embodiment and the information processing system according to the fifth embodiment;

FIG. 10 is a block diagram illustrating an exemplary functional configuration of an information processing system according to a third embodiment of the present invention;

FIG. 11 is a sequence chart illustrating an exemplary operation flow from biometric authentication to execution of a function in the information processing system according to the third embodiment;

FIG. 12 illustrates an exemplary overall configuration of the information processing system according to the fourth embodiment;

FIG. 13 illustrates an exemplary functional configuration of a service providing system of the information processing system according to the fourth embodiment established at an organization providing cloud services;

FIG. 14A illustrates an exemplary functional configuration of a biometric information reading device of the information processing system of FIG. 12;

FIG. 14B illustrates an exemplary functional configuration of an image forming apparatus of the information processing system of FIG. 12;

FIG. 14C illustrates an exemplary functional configuration of a biometric authentication application of the information processing system of FIG. 12;

FIG. 15 is a sequence chart illustrating an exemplary process flow of performing biometric authentication and determining a function to be executed in the information processing system of FIG. 12;

FIG. 16A is a table illustrating an exemplary data configuration of company management information of the information processing system of FIG. 12;

FIG. 16B is a table illustrating an exemplary data configuration of user management information of the information processing system of FIG. 12;

FIG. 16C is a table illustrating an exemplary data configuration of device management information of the information processing system of FIG. 12;

FIG. 17 is a sequence chart illustrating an exemplary process flow of performing biometric authentication and determining a function to be executed in the information processing system according to the fifth embodiment;

FIG. 18A illustrates an exemplary overall configuration of an information processing system according to a sixth embodiment of the present invention;

FIG. 18B illustrates an exemplary functional configuration of a service providing system of the information processing system of FIG. 18A established at an organization providing cloud services;

FIG. 18C illustrates an exemplary functional configuration of an authentication control application illustrated in FIG. 18B;

FIG. 19 is a sequence chart illustrating an exemplary process flow of performing biometric authentication and determining a function to be executed in the information processing system of FIG. 18A;

FIG. 20A illustrates an exemplary overall configuration of an information processing system according to a seventh embodiment of the present invention;

FIG. 20B illustrates an exemplary functional configuration of a service providing system of the information processing system of FIG. 20A established at an organization providing cloud services;

FIG. 21A illustrates an exemplary functional configuration of a biometric information reading device of the information processing system of FIG. 20A;

FIG. 21B illustrates an exemplary functional configuration of an image forming apparatus of the information processing system of FIG. 20A;

FIG. 22 is a sequence chart illustrating an exemplary process flow of performing biometric authentication and determining a function to be executed in the information processing system of FIG. 20A;

FIG. 23 illustrates an exemplary overall configuration of an information processing system according to an eighth embodiment of the present invention;

FIG. 24 is a table illustrating an exemplary data configuration of information used for biometric authentication and determining a function to be executed in the information processing system of FIG. 23;

FIG. 25 illustrates an exemplary overall configuration of an information processing system according to a ninth embodiment of the present invention;

FIG. 26 illustrates an exemplary functional configuration of a service providing system of the information processing system of FIG. 25 established at an organization providing cloud services;

FIG. 27A illustrates an exemplary functional configuration of a print server of the information processing system of FIG. 25;

FIG. 27B illustrates an exemplary functional configuration of an image forming apparatus of the information processing system of FIG. 25;

FIG. 27C illustrates an exemplary functional configuration of a print service application of the information processing system of FIG. 25;

FIG. 28 is a table illustrating an exemplary data configuration of output data management information in the print server of the information processing system of FIG. 25;

FIG. 29 is a table illustrating an exemplary data configuration of information used for determining a function to be executed based on biometric information identification information in the information processing system of FIG. 25;

FIG. 30A is a table illustrating an exemplary data configuration of company management information of the information processing system of FIG. 25;

FIG. 30B is a table illustrating an exemplary data configuration of user management information of the information processing system of FIG. 25;

FIG. 30C is a table illustrating an exemplary data configuration of device management information of the information processing system of FIG. 25;

FIG. 31 is a flowchart illustrating exemplary process operations that are performed after the biometric authentication and the executing function determination in a case where a client terminal or a mobile terminal of the information processing system of FIG. 25 submits a job to the print service;

FIG. 32 is a table illustrating an exemplary data configuration of output management information in the print service application of the information processing system of FIG. 25;

FIG. 33 is a flowchart illustrating exemplary process operations according to the function to be executed in the information processing system of FIG. 25;

FIG. 34 is a sequence chart illustrating exemplary process operations that are performed after the biometric authentication and the executing function determination in a case of using the print service of the information processing system of FIG. 25;

FIG. 35 is a flowchart illustrating an exemplary flow of authentication operations performed when logging in from the image forming apparatus in the information processing system of FIG. 25;

FIG. 36 illustrates an exemplary overall configuration of an information processing system according to a tenth embodiment of the present invention;

FIG. 37 illustrates an exemplary functional configuration of a service providing system of the information processing system of FIG. 36 established at an organization providing cloud services;

FIG. 38A illustrates an exemplary functional configuration of a print service application of the information processing system of FIG. 36;

FIG. 38B illustrates an exemplary functional configuration of an image forming apparatus of the information processing system of FIG. 36;

FIG. 39A is a table illustrating an exemplary data configuration of process execution information in the information processing system of FIG. 36;

FIG. 39B is a table illustrating an exemplary data configuration of company management information of the information processing system of FIG. 36;

FIG. 39C is a table illustrating an exemplary data configuration of user management information of the information processing system of FIG. 36; and

FIG. 39D is a table illustrating an exemplary data configuration of device management information of the information processing system of FIG. 36.

### DESCRIPTION OF THE PREFERRED EMBODIMENTS

In the following, embodiments of the present invention are described with reference to the accompanying drawings.

### First Embodiment

<Overall Configuration of Information Processing System>

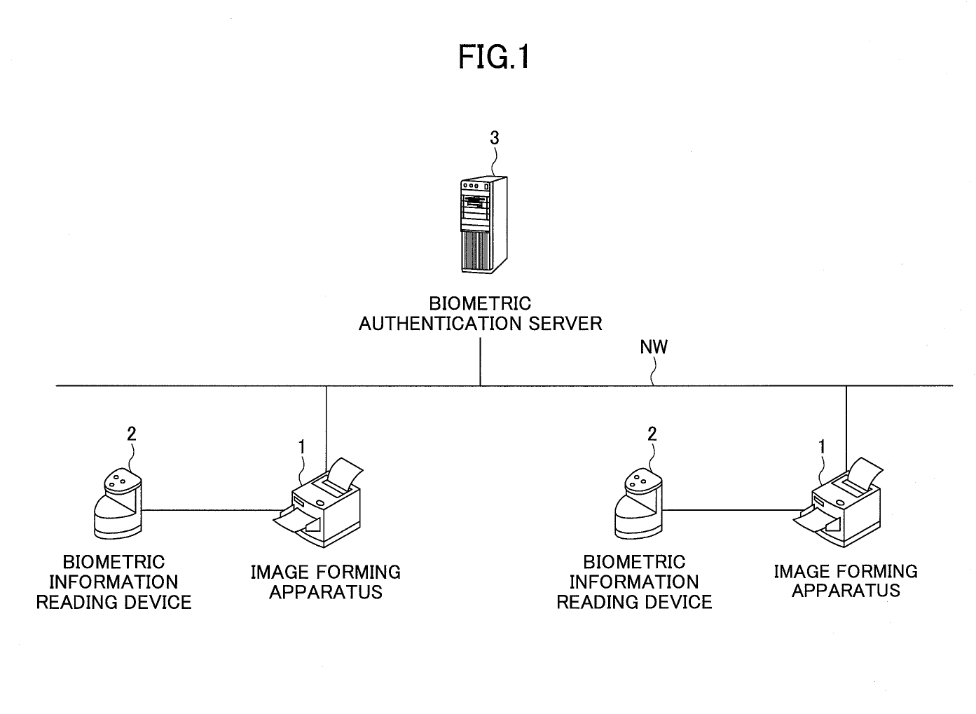

FIG. 1 illustrates an exemplary overall configuration of an information processing system according to a first embodiment of the present invention. The information processing system may include one or more (two in this example) image forming apparatuses 1 that authenticated users are allowed to use, biometric information reading devices 2 connected to the respective image forming apparatuses 1, and at least one biometric authentication server 3. The image forming apparatuses 1 and the biometric authentication server 3 are connected to each other via a network NW.

The image forming apparatus 1 obtains biometric information of the user via the biometric information reading device 2, and sends the biometric information to the biometric authentication server 3. The biometric information of the user is to be used as authentication information for authenticating the user and function determination information for determining a function to be executed using the image forming apparatus 1. The biometric authentication server 3 receives the biometric information, compares the biometric information with pre-stored biometric information to perform user authentication. The biometric authentication server 3 also determines the function of the image forming apparatus 1 that is pre-registered (stored, managed) in association with the relevant biometric information. Then, the biometric authentication server 3 sends the authentication result and the determination result to the image forming apparatus 1. The image forming apparatus 1 receives the authentication result and the determination result and controls operations of the image forming apparatus 1 based on the received information. For example, the image forming apparatus 1 may control operations of allowing or disallowing use of the image forming apparatus 1, and in the case of allowing use, the image forming apparatus 1 may execute the function determined in the above-described manner.

<Hardware Configuration of Image Forming Apparatus>

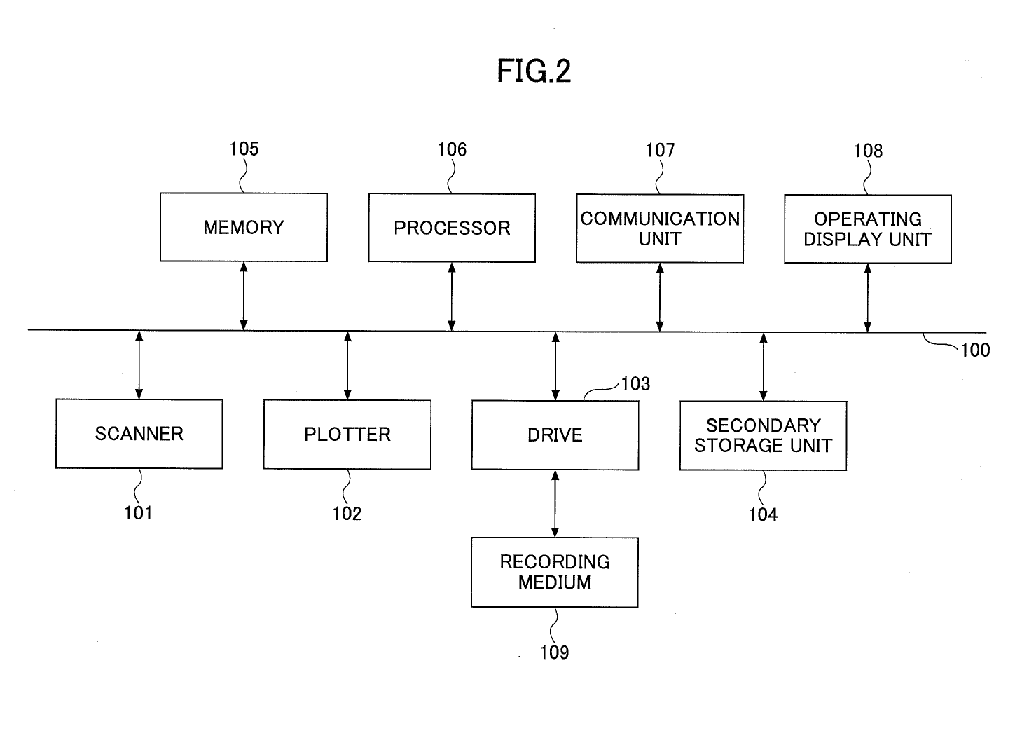

FIG. 2 is a block diagram illustrating an exemplary hardware configuration of the image forming apparatus 1 of FIG. 1.

The image forming apparatus 1 may include a scanner 101, a plotter 102, a drive 103, a secondary storage unit 104, a memory 105, a processor (e.g., CPU) 106, a communication unit 107, and an operating display unit 108 that are connected to each other via a bus 100.

The scanner 101 may include a scanner engine (not shown) and an engine controller (not shown) for controlling the scanner engine, for example, and is configured to scan an object such as a document to obtain image data of the scanned object. The plotter 102 may include a plotter engine (not shown) and an engine controller (not shown) for controlling the plotter engine, for example, and is configured to output (e.g., print) image data.

The drive 103 reads/writes information from/on a recording medium 109. For example, the drive 103 reads programs and data (e.g., fixed data) from the recording medium 109. The recording medium 109 may be implemented by any type of medium that records information optically, electrically, or magnetically. Examples of the recording medium 109 include a compact disk read-only memory (CD-ROM), a flexible disk, and a magneto-optical disk. The recording medium 109 may also be implemented by a semiconductor memory such as a read-only memory (ROM) or a flash memory that electrically records information.

The secondary storage unit 104 may be implemented, for example, by a hard disk and stores, for example, programs and data read from the recording medium 109 by the drive 103. The memory 105 may include a ROM (not shown) storing programs executed by the processor 106 to perform various processes and a random access memory (RAM) (not shown) used as a work area by the processor 106 during such processes. The processor 106 controls overall operations of the image forming apparatus 1.

The communication unit 107 may include a modem and a local area network (LAN) card, for example, and is configured to connect the image forming apparatus 1 to the network NW. The operating display unit 108 may include various operation keys and a liquid crystal display (LCD) touch panel, for example. The operating display unit 108 receives various user inputs for operating the image forming apparatus 1 and displays information to be reported to the user.

Note that the image forming apparatus is one exemplary embodiment of a device.

<Hardware Configuration of Biometric Authentication Server>

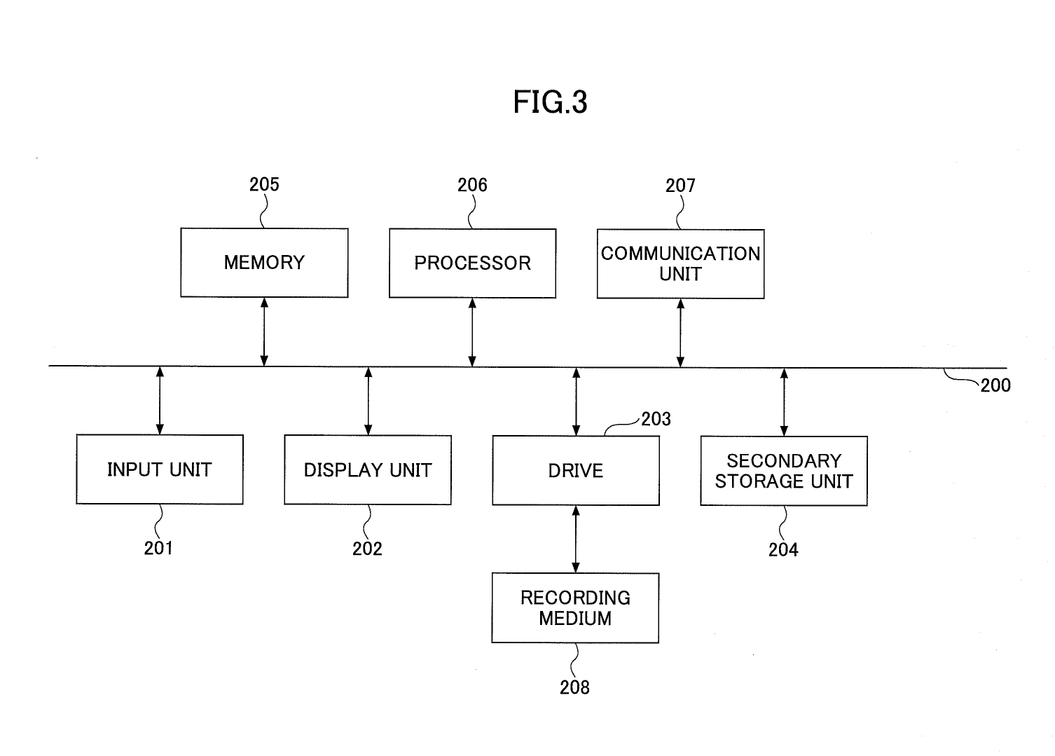

FIG. 3 is a block diagram illustrating an exemplary hardware configuration of the biometric authentication server 3.

The biometric authentication server 3 may include an input unit 201, a display unit 202, a drive 203, a secondary storage unit 204, a memory 205, a processor (e.g., CPU) 206, and a communication unit 207 that are connected to each other via a bus 200.

The input unit 201 may include a keyboard and a mouse (not shown) and is used to input various instructions (or signals). The display unit 202 may include a liquid crystal display (LCD) (not shown) and displays various windows and data.

The drive 203, the secondary storage 204, the memory 205, the processor 206, the communication unit 207, and a recording medium 208 have configurations and functions similar to those of the corresponding components of the image forming apparatus 1.

Note that the biometric authentication server 3 is one exemplary embodiment of an authentication apparatus.

<Functional Configuration of Information Processing System>

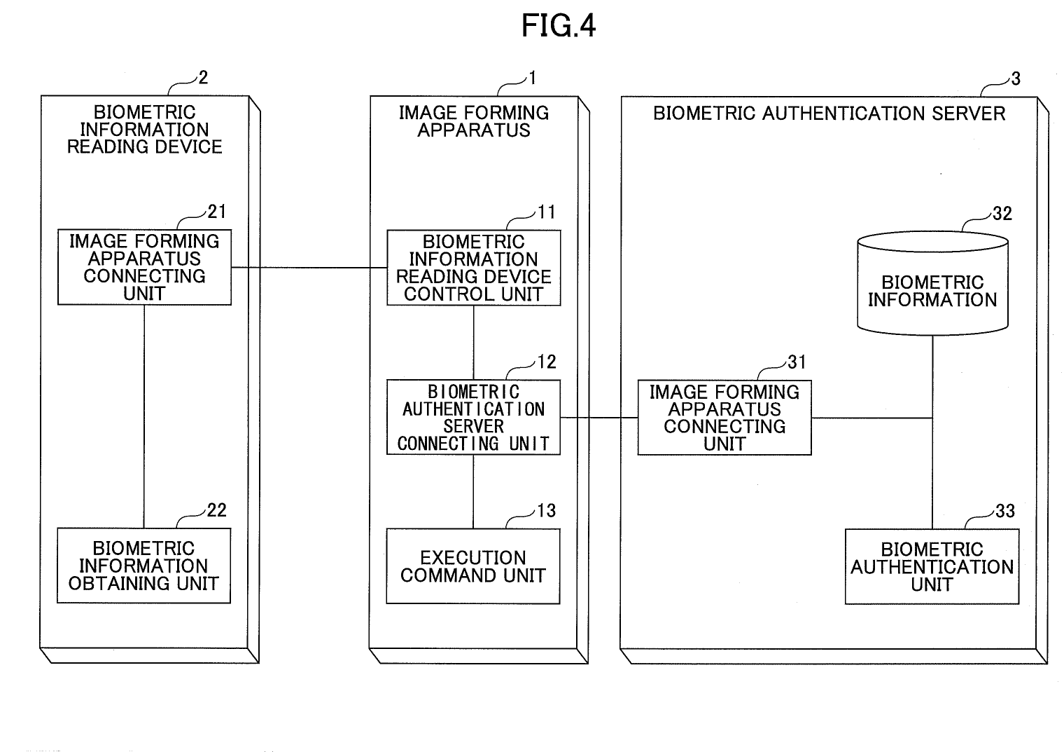

FIG. 4 is a block diagram illustrating functional configurations of the image forming apparatus 1, the biometric information reading device 2, and the biometric authentication server 3 illustrated in FIG. 1.

The image forming apparatus 1 may include a biometric information reading device control unit 11, a biometric authentication server connecting unit 12, and an execution command unit 13. The biometric information reading device control unit 11, the biometric authentication server connecting unit 12, and the execution command unit 13 may be implemented by executing one or more programs installed in the image forming apparatus 1 by the processor 106. Note that components of the image forming apparatus 1 that are not particularly relevant to the present invention are omitted.

The biometric information reading device control unit 11 controls operations of the biometric information reading device 2. The biometric authentication server connecting unit 12 establishes communication with the biometric authentication server 3 to send a biometric authentication request and receive an authentication result, for example. The execution command unit 13 issues an execution request to prompt the image forming apparatus 1 to actually execute a “function to be executed” that is associated with biometric information of an authenticated user that is transmitted from the biometric authentication server 3.

The biometric information reading device 2 includes an image forming apparatus connecting unit 21 and a biometric information obtaining unit 22. Note that components of the biometric information reading device 2 that are not particularly relevant to the present invention are omitted.

The image forming apparatus connecting unit 21 establishes communication with the image forming apparatus 1 to receive a biometric information capture request, for example. The biometric information obtaining unit 22 obtains (captures) biometric information (e.g., finger vein pattern, palm vein patter, fingerprint, palm print) from a finger or palm that is held over the o biometric information reading device 2. Note that the biometric information may be obtained using conventional biometric information capturing techniques and detailed descriptions thereof are omitted.

The biometric authentication server 3 may include an image forming apparatus connecting unit 31, a group information storing unit 32, a biometric authentication information storing unit 33, and a biometric authentication unit 34. The image forming apparatus connecting unit 31 and the biometric authentication unit 34 may be implemented by executing one or more programs installed in the biometric authentication server 3 by the processor 206. The group information storing unit 32 and the biometric authentication information storing unit 33 may be implemented by, for example, the memory 205 or the secondary storage unit 204. Components of the biometric authentication server 3 that are not essential to describe the present invention are omitted.

The biometric authentication server 3 may include an image forming apparatus connecting unit 31, a biometric information storing unit 32, and a biometric authentication unit 33. The image forming apparatus connecting unit 31, the biometric information storing unit 32, and the biometric authentication unit 33 may be implemented by executing one or more programs installed in the biometric authentication server 3 by the processor 206. Note that components of the biometric authentication server 3 that are not particularly relevant to the present invention are omitted.

The image forming apparatus connecting unit 31 establishes communication with the image forming apparatus 1 to send a biometric authentication result, for example. The biometric information storing unit 32 stores (manages) pre-registered biometric information and corresponding user information such as the “function to be executed” associated with the biometric information. The biometric authentication unit 33 performs biometric authentication based on biometric information transmitted from the image forming apparatus 1 together with a biometric authentication request. Note that conventional techniques may be used to compare the obtained biometric information with pre-registered biometric information to perform finger vein authentication, palm vein authentication, fingerprint authentication, or palm print authentication, for example, and detailed descriptions of such techniques are omitted.

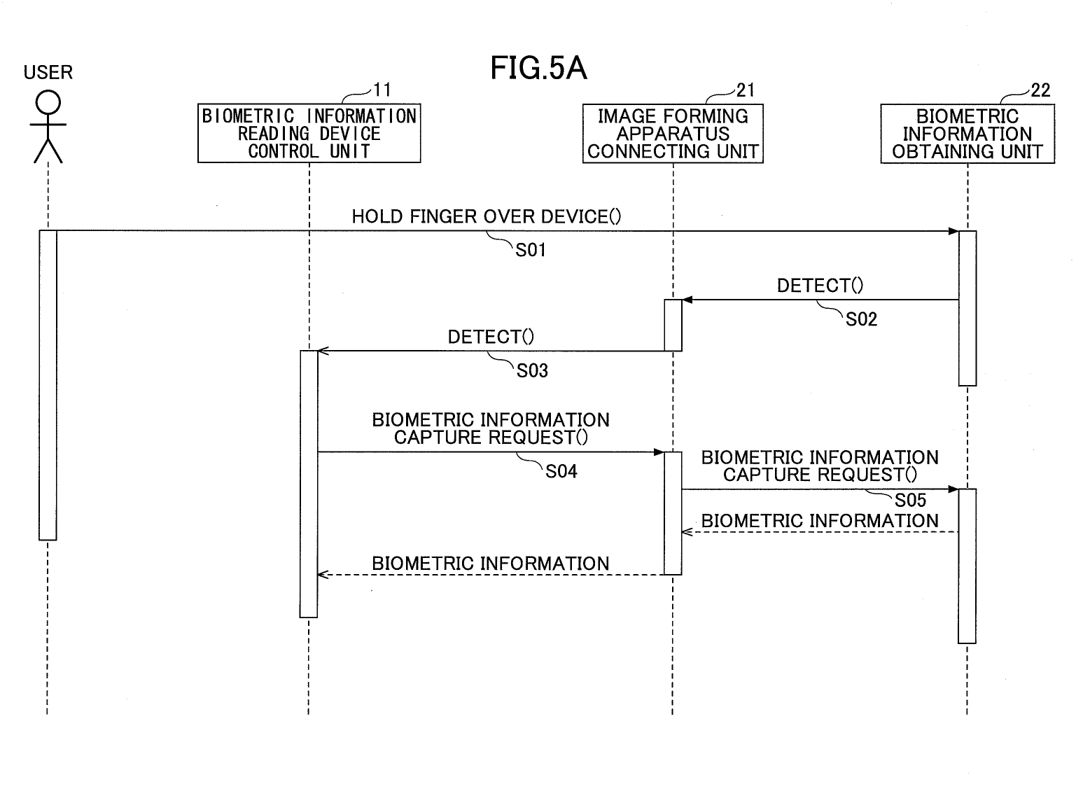

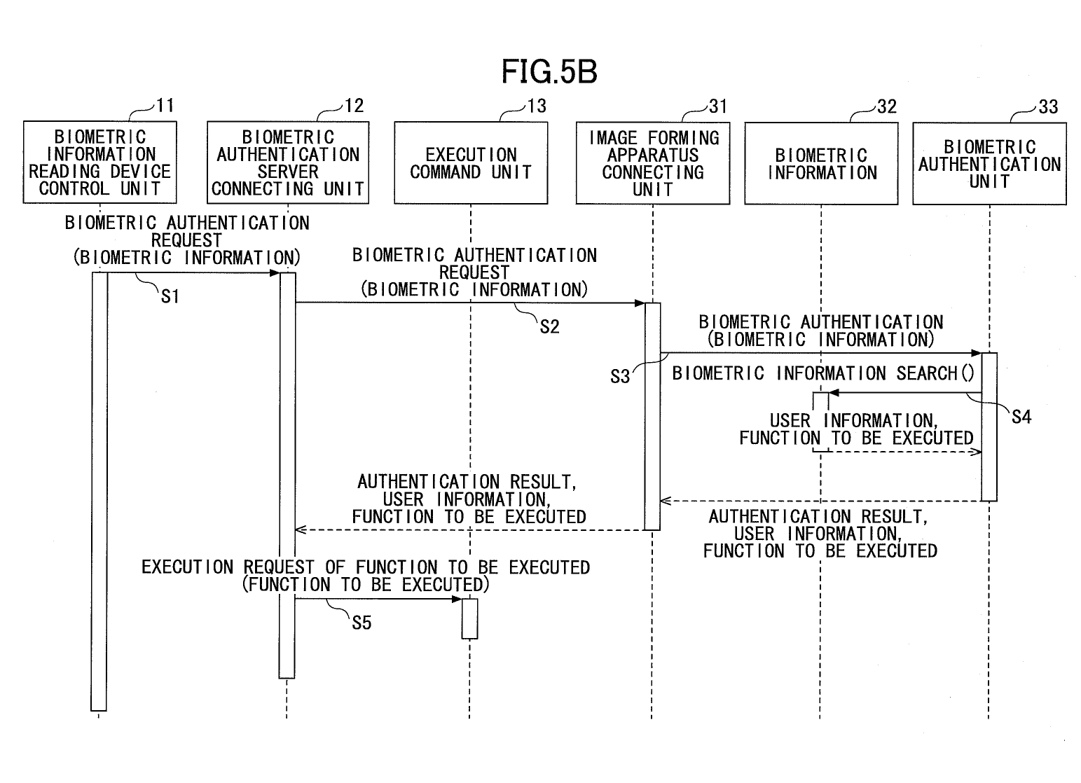

FIG. 5A is a sequence chart illustrating an exemplary operation flow for obtaining biometric information in the information processing system of the first embodiment.

In FIG. 5A, first, in step S01, a user may hold a finger over the biometric information obtaining unit 22 of the biometric information reading device 2 (in the case of performing finger vein authentication or fingerprint authentication). In turn, the biometric information obtaining unit 22 may detect that the finger has been held over the biometric information reading device 2, and send finger detection event information to the biometric information reading device control unit 11 of the image forming apparatus 1 via the image forming apparatus connecting unit 21 (steps S02 and S03).

Upon receiving the detection event information, the biometric information reading device control unit 11 sends a biometric information capture request to the image forming apparatus connecting unit 21 of the biometric information reading device 2 (step S04). In turn, the image forming apparatus connecting unit 21 issues a biometric information capture request to the biometric information obtaining unit 22 to capture the desired biometric information (step S05). Biometric information obtained in this manner is then sent to the biometric information reading device control unit 11 of the image forming apparatus 1.

FIG. 5B is a sequence chart illustrating an exemplary process flow operations from “biometric authentication request” to “function execution” in the information processing system according to the first embodiment.

In FIG. 5B, the biometric information reading device control unit 11 of the image forming apparatus 1 issues a biometric authentication request including the biometric information obtained in the manner described above with reference to FIG. 5A, and sends the biometric authentication request to the biometric authentication server connecting unit 12 (step S1). In turn, the biometric authentication server connecting unit 12 sends a biometric authentication request including the obtained biometric information to the image forming apparatus connecting unit 31 of the biometric authentication server 3 (step S2).

Upon receiving the biometric authentication request, the image forming apparatus connecting unit 31 passes the received biometric information to the biometric authentication unit 33 (step S3 “biometric authentication”). The biometric authentication unit 33 uses the received biometric information as a key to search information stored in the biometric information storing unit 32. The biometric authentication unit 33 then determines the search result (authentication result), and performs the following process steps if biometric information matching the key is found from the search. That is, the biometric authentication unit 33 sends “user information” and “function to be executed” stored (managed) in association with the matching biometric information in the biometric information storing unit 32 to the biometric authentication server connecting unit 12 of the image forming apparatus 1 via the image forming apparatus connecting unit 31 (step S4 “biometric information search”).

In the case where authentication is successful (authentication OK); namely, when a match is found from the search, the biometric authentication server connecting unit 12 allows the user to use the image forming apparatus 1, and sends an execution request of the “function to be executed” to the execution command unit 13 (step S5 “execution request of function to be executed”). In turn, the execution command unit 13 directs an application (not shown) of the image forming apparatus 1 to execute the “function to be executed.” As a result, a function unit (e.g., scanner 101 or plotter 102 of FIG. 2) of the image forming apparatus 1 may be prompted to execute the “function to be executed.”

Note that allowing the user to use the image forming apparatus 1 as described above may include notification operations such as display operations by the operating display unit 108 indicating the successful authentication result, for example. In other examples, the notification operations may simply involve the image forming apparatus 1 executing the “function to be executed.”

In the case where the result of the biometric information search is authentication failure (authentication NG); namely, when no match is found, the biometric authentication unit 33 of the biometric authentication server 3 merely sends the authentication result to the biometric authentication server connecting unit 12 of the image forming apparatus 1 via the image forming apparatus connecting unit 31. In this case, step S5 is not performed, and instead, the biometric authentication server connecting unit 12 notifies the user of the image forming apparatus 1 of the authentication result. For example, the biometric authentication server connecting unit 12 may prompt the operating display unit 108 to display the authentication result.

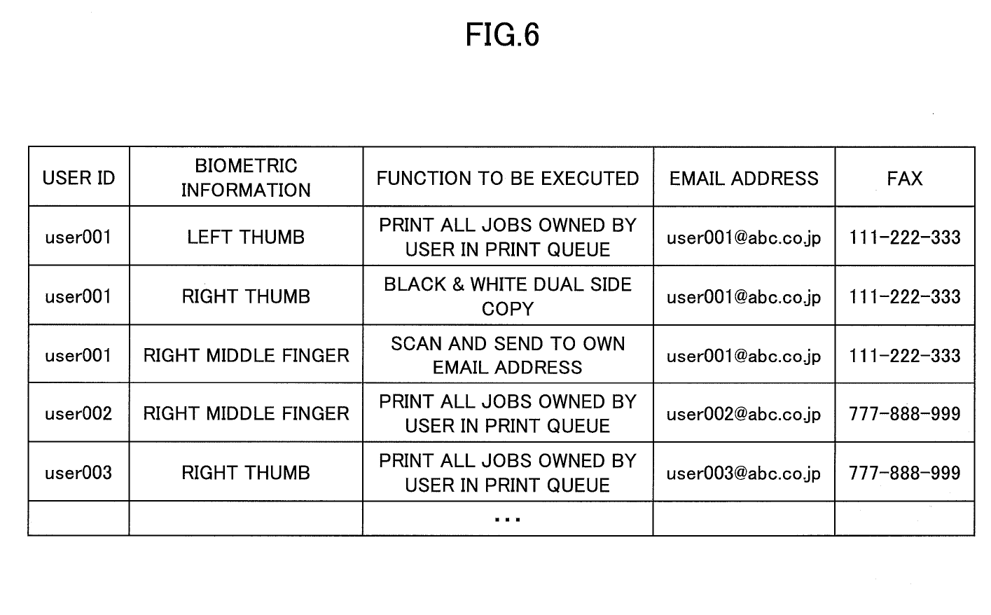

FIG. 6 is a table illustrating an exemplary data configuration of information maintained (managed) by the biometric information storing unit 32 that is used for biometric authentication and determining a function to be executed.

As illustrated in FIG. 6, the biometric information storing unit 32 stores (manages) the information items “user ID,” “biometric information,” “function to be executed,” “email address,” and “fax” in association with each other.

In FIG. 6, “user ID” corresponds to information for identifying each user that is registered in the biometric information storing unit 32. “Biometric information” corresponds to biometric information registered by the user. For example, “left thumb” is indicated as biometric information in the first record of FIG. 6, and this means that biometric information such as the finger vein or fingerprint of the left thumb of the user with the user ID “user 001” is registered. Biometric authentication and determination of the “function to be executed” as described above may be performed by comparing the registered biometric information with the biometric information obtained by the biometric information reading device 2 to determine whether they match (step S4 of FIG. 5B).

In FIG. 6, “function to be executed” refers to a function to be executed using the image forming apparatus 1. For example, assuming that, as the search result of step S4 of FIG. 5B, the biometric information obtained by the biometric information reading device 2 was determined to match the biometric information in the first record of FIG. 6 (i.e., biometric information of left thumb of user with the user ID “user001”), the authentication of the user (authentication result) would be determined to be successful, and “print all jobs owned by user in print queue” included in the record under “function to be executed” would be determined as the function to be executed by the image forming apparatus 1. Also, the user ID “user001” may be obtained as corresponding user information of the user.

The information obtained from the biometric information storing unit 32 in the above-described manner may be sent to the image forming apparatus 1 that has issued the biometric authentication request. In turn, the image forming apparatus 1 may use the obtained user information “user001” as a key to extract all print jobs of the user that are stored (queued) in the recording medium 109 or the secondary storage unit 104 and print out the print jobs using the plotter 102.

Also, in FIG. 6, “email address” corresponds to the registered email address of the user, and “fax” corresponds to the registered fax number of the user.

According to an aspect of the information processing system of the first embodiment, when using the image forming apparatus 1 to execute a certain function, the image forming apparatus 1 may be easily prompted to execute the desired function. That is, the execution of the desired function may be prompted by simply providing the corresponding biometric information (e.g., left thumb biometric information) pre-registered in association with the “function to be executed” in the biometric authentication server 3 to the biometric information reading device 2 that is connected to the image forming apparatus 1 (e.g., by holding the left thumb finger over the biometric information reading device 2 in step S01 of FIG. 5A). That is, a desired function (“function to be executed”) may be assigned to biometric information of a finger of a user so that by holding the finger over the biometric information reading device 2, authentication of the user and execution of the assigned “function to be executed” may be achieved at the same time. That is, the image forming apparatus 1 may be prompted to execute the function upon successful authentication of the user.

Note that conventionally, in the case of having the image forming apparatus 1 execute a function such as “print all jobs owned by user in print queue,” which is described above as an example of a “function to be executed,” the following operations may have to be performed, for example. First, operations for user authentication have to be performed such as inputting a user ID and password. Then, operations for displaying a list of jobs previously submitted by the user, operations for selecting all the jobs in the job list, and operations for printing the selected jobs have to be performed. As described above, in a conventional system, at least a few types of operations have to be successively performed to execute the above desired function.

On the other hand, in the information processing system according to the first embodiment, the desired function may be executed by simply performing one type of operation such as holding a finger over the biometric information reading device 2, for example. In this way, user operations required for having the image forming apparatus 1 execute a function may be simplified.

Note that in the information processing system according to the first embodiment, the biometric authentication unit 33 and the biometric information storing unit 32 correspond to an exemplary embodiment of a user authentication and function determination unit. Also, the scanner 101 and the plotter 102 correspond to exemplary embodiments of a function unit. Also, the execution command unit 13 corresponds to an exemplary embodiment of an execution command unit. Also, the biometric information reading device control unit 11 corresponds to an exemplary embodiment of an authentication information obtaining unit.

### Second Embodiment

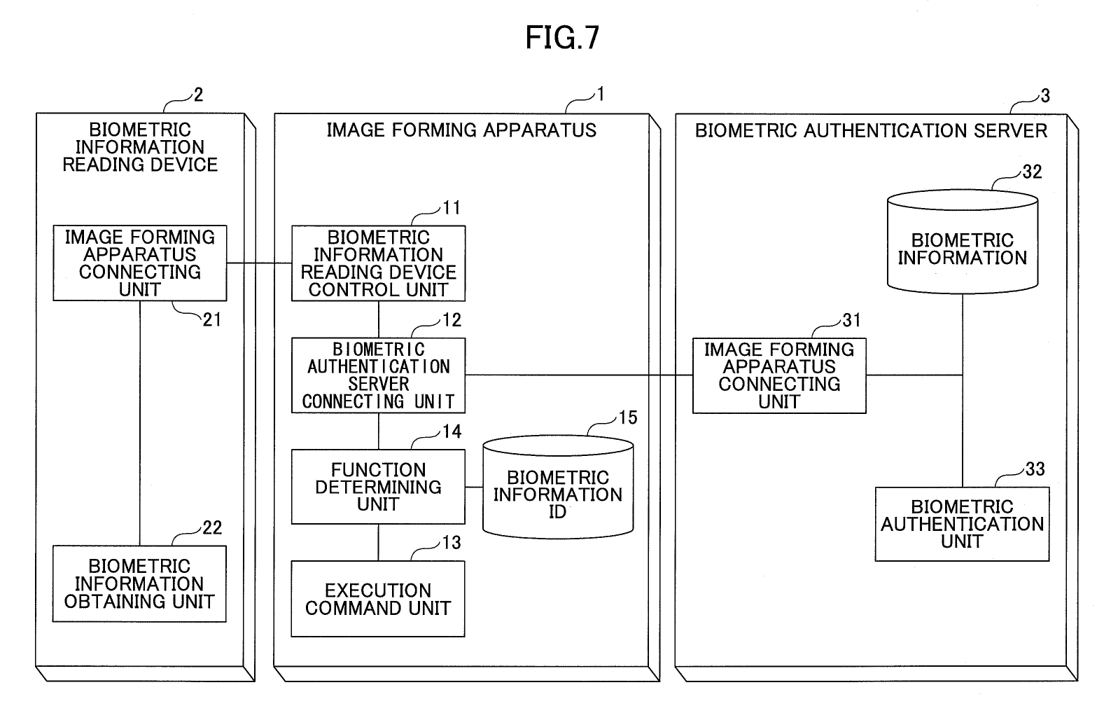

In the following, an information processing system according to a second embodiment of the present invention is described with reference to FIGS. 7-9B.

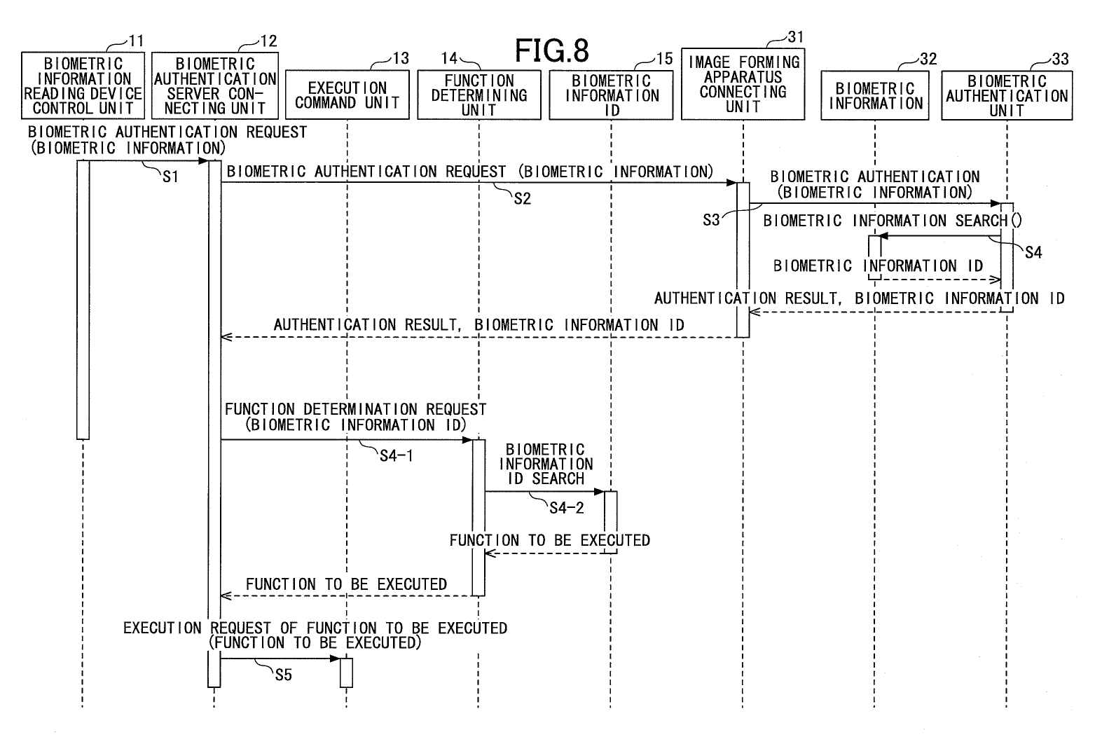

The information processing system according to the second embodiment differs from the first embodiment in the following manner. In the information processing system according to the first embodiment, “authentication result,” “user information,” and “function to be executed” are passed back as return values or search results of the biometric information search (step S4 of FIG. 5B). On the other hand, in the information processing system according to the second embodiment, “authentication result” and “biometric information ID” are passed back as return values of the biometric information search (step S4 of FIG. 8). In turn, the image forming apparatus 1 that receives the return values from the biometric authentication server 3 extracts and determines a “function to be executed” corresponding to the received “biometric information ID” and executes the determined “function to be executed.”

In the information processing system according to the second embodiment, for example, the following advantageous effects may be obtained in addition to the advantageous effects obtained by the information processing system according to the first embodiment. In one aspect, by having the biometric authentication server 3 transmit the return value “biometric information ID” rather than “function to be executed” to the image forming apparatus 1, the “function to be executed” corresponding to the “biometric information ID” may be flexibly set up at the image forming apparatus 1 and user convenience may be improved, for example. The information processing system according to the second embodiment is described in greater detail below.

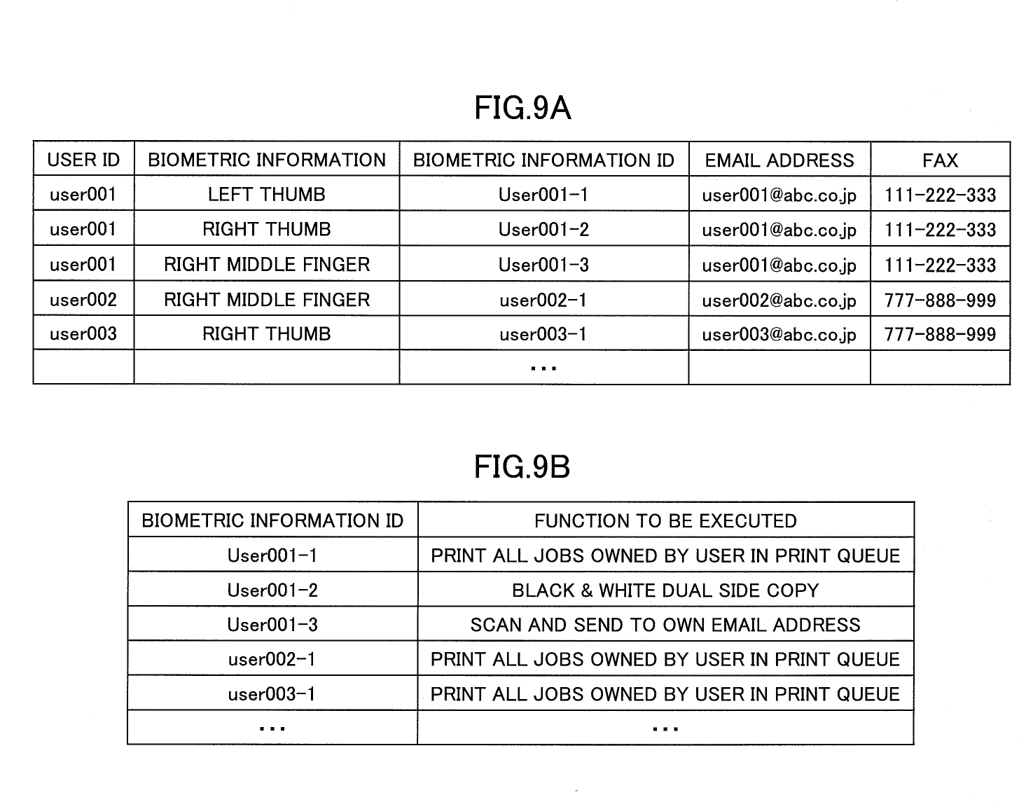

FIG. 7 is a block diagram illustrating an exemplary functional configuration of the information processing system according to the second embodiment. FIG. 8 is a sequence chart illustrating an exemplary operation flow from biometric authentication to execution of a function in the information processing system according to the second embodiment. FIG. 9A is a table illustrating exemplary information used for biometric authentication and obtaining biometric information identification information in the information processing system according to the second embodiment, and FIG. 9B is a table illustrating exemplary information used for determining a function to be executed based on biometric information identification information in the information processing system according to the second embodiment.

The configuration of FIG. 7 differs from that of FIG. 4 in the following manner. In the information processing system of the second embodiment, the biometric information storing unit 32 of the biometric authentication server 3 stores (manages) information used for biometric authentication and obtaining biometric information identification information as illustrated in FIG. 9A rather than information used for biometric authentication and determining a function to be executed as illustrated in FIG. 6. That is, the biometric information storing unit 32 stores (manages) the information item “biometric information ID” instead of “function to be executed.” Thus, the information item “function to be executed” is not included in the return values of the biometric information search (step S4), but the information item “biometric information ID” is included instead.

As illustrated in FIG. 9A, the “biometric information ID” may be a combination of the user ID of the relevant user (e.g., “user001”) and a serial number (e.g., “−1”), for example. In this way, the image forming apparatus 1 that receives such information item may easily recognize the user ID included in the biometric information ID and determine the corresponding user associated with the biometric information ID. Thus, “user information” may be omitted from the return values of the biometric information search, for example. However, the return values are not limited to the illustrated example. In other examples, the biometric information ID may not include a user ID, and the return values may include “user information” and “biometric information ID.”

Referring back to FIG. 7, in the information processing system of the second embodiment, the image forming apparatus 1 additionally includes a function determining unit 14 and a biometric information ID storing unit 15. These functional components may also be implemented by executing one or more programs installed in the image forming apparatus 1 by the processor 106 as with the other functional components of the image forming apparatus 1. The biometric information ID storing unit 15 stores (manages) information for determining a function to be executed based on biometric information identification information as illustrated in FIG. 9B, for example.

In FIG. 9B, the biometric information ID storing unit 15 stores (manages) the information items “biometric information ID” and “function to be executed” in association with each other as information for determining a function to be executed based on biometric information identification information.

Note that the information item “biometric information ID” of FIG. 9B corresponds to the “biometric information ID” stored (managed) by the biometric information storing unit 32 as illustrated in FIG. 9A. Also, the information item “function to be executed” in FIG. 9B corresponds to the information item “function to be executed” of FIG. 6 that is stored by the biometric information storing unit 32 in the information processing system of the first embodiment.

In the following, operations from biometric authentication to execution of a function in the information processing system of the second embodiment that vary from the operations executed in the information processing system of the first embodiment as illustrated in FIG. 5B are described with reference to FIG. 8.

As described above, in step S4 (biometric information search) of FIG. 8, the biometric authentication unit 33 of the biometric authentication server 3 uses the biometric information received in step S3 as a key to search the information stored (managed) in the biometric information storing unit 32 (see FIG. 9A). If biometric information matching the received biometric information is found from the search, the biometric authentication unit 33 performs the following operations. Namely, the biometric authentication unit 33 transmits (returns) the authentication result (successful authentication) and the “biometric information ID” stored in association with the matching biometric information in the biometric information storing unit 32 to the biometric authentication server connecting unit 12 of the image forming apparatus 1 via the image forming apparatus connecting unit 31.

In the case where the authentication result is successful (authentication OK); namely, when biometric information matching the key is found, the biometric authentication server connecting unit 12 sends a function determination request including the “biometric information ID” included in the received return values to the function determining unit 14 (step S4-1). In turn, the function determining unit 14 uses the “biometric information ID” included in the function determination request as a key to search the biometric information ID storing unit 15 (step S4-2 “biometric information ID search”). In this way, the function determining unit 14 may extract and determine a “function to be executed” stored in association with the “biometric information ID” in the biometric information ID storing unit 15 and return the determined “function to be executed” to the biometric authentication server connecting unit 12.

In response to receiving the determined “function to be executed” from the function determining unit 14, the biometric authentication server connecting unit 12 may allow the corresponding user to use the image forming apparatus 1 and send an execution request for executing the “function to be executed” to the execution command unit 13 (step S5 “execution request of function to be executed”). In turn, the execution command unit 13 directs an application of the image forming apparatus 1 to execute the “function to be executed.” In this way, a function unit (e.g., scanner 101 or plotter 102 of FIG. 2) may be prompted to execute the “function to be executed.”

On the other hand, in the case where the result of the biometric information search (step S4) is authentication failure (authentication NG); namely, when no match is found from the search, the biometric authentication unit 33 merely returns the authentication result to the biometric authentication server connecting unit 12 of the image forming apparatus 1 via the image forming apparatus connecting unit 31. In this case, steps S4-1, S4-2, and S5 are not executed, and instead, the biometric authentication server connecting unit 12 notifies the user of the image forming apparatus 1 of the authentication result.

Note that in the information processing system of the second embodiment, biometric information storing unit 32 corresponds to an exemplary embodiment of an authentication information managing unit, the biometric authentication unit 33 corresponds to an exemplary embodiment of an authentication unit, the biometric information ID storing unit 15 corresponds to an exemplary embodiment of an authentication information identification information managing unit, and the function determining unit 14 corresponds to an exemplary embodiment of a function determining unit. Also, the execution command unit 13 corresponds to an exemplary embodiment of an execution command unit. Also, the scanner 101 and the plotter 102 correspond to exemplary embodiments of a function unit. Also, the biometric information reading device control unit 11 corresponds to an exemplary embodiment of an authentication information obtaining unit.

### Third Embodiment

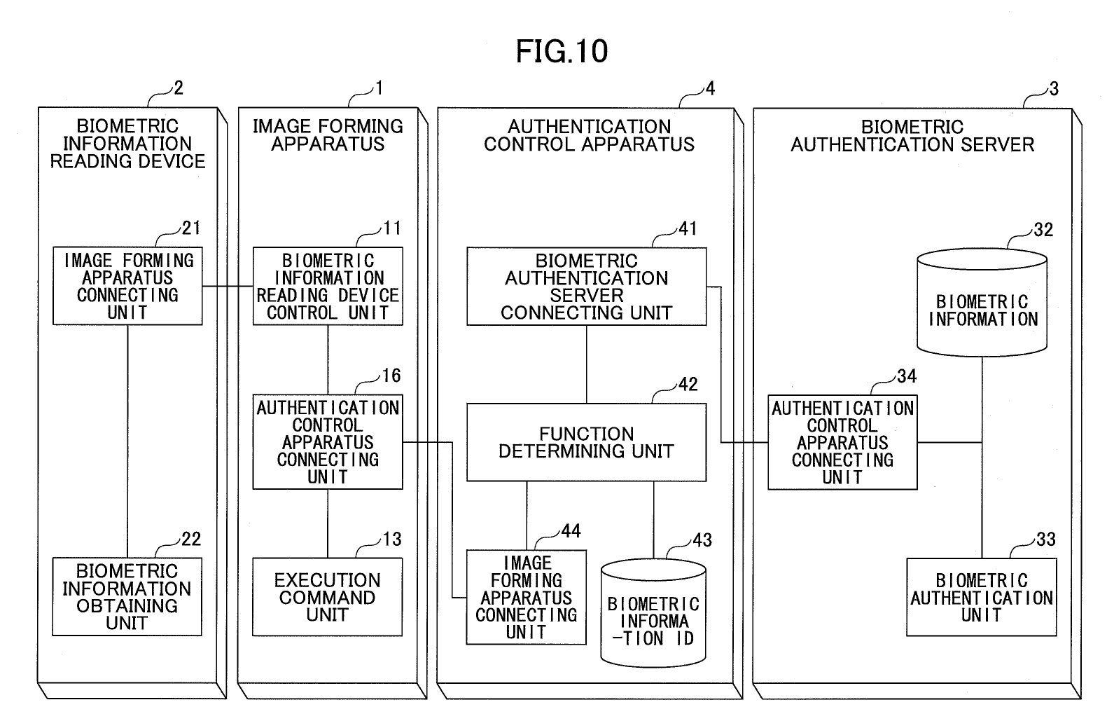

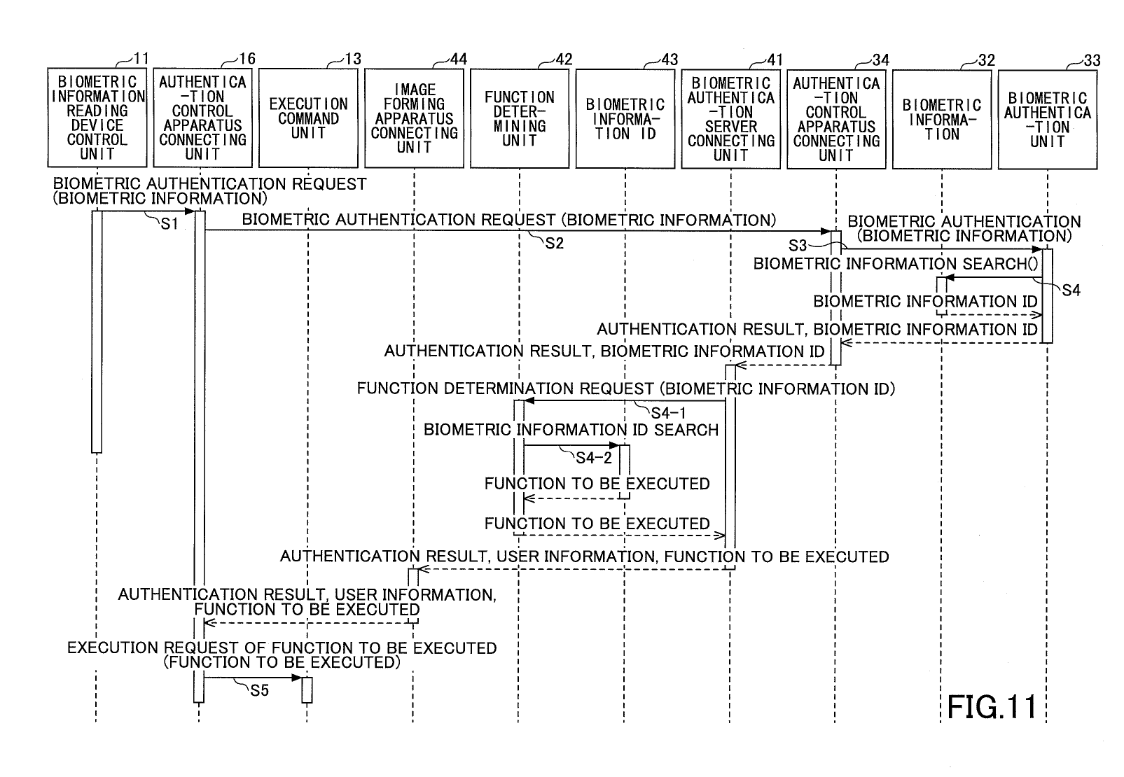

In the following, an information processing system according to a third embodiment of the present invention is described with reference to FIGS. 10 and 11.

The information processing system according to the third embodiment include functions and features similar to those of the information processing system according to the second embodiment. Thus, components and operations of the information processing system of the third embodiment that are identical to those of the second embodiment are given the same reference numerals and their descriptions are mostly omitted so that the following descriptions primarily relate to aspects of the third embodiment that differ from those of the second embodiment.

The information processing system according to the third embodiment differs from the information processing system according to the second embodiment in the following manner. In the information processing system according to the second embodiment as illustrated in FIG. 7, the image forming apparatus 1 includes the function determining unit 14 and the biometric information ID storing unit 15, and the image forming apparatus 1 is configured to determine the “function to be executed” based on the “biometric information ID” from the biometric authentication server 3. On the other hand, the information processing system according to the third embodiment as illustrated in FIG. 10 includes an authentication control apparatus 4 including a function determining unit 42 and a biometric information ID storing unit 43. The authentication control unit 4 is configured to determine the “function to be executed” based on the “biometric information ID” from the biometric authentication server 3 and communicate the determined “function to be executed” to the image forming apparatus 1.

In the information processing system according the third embodiment, for example, the following advantageous effects may be obtained in addition to the advantageous effects obtained by the information processing system according to the second embodiment. In one aspect, there may be a case where the image forming apparatus 1 is replaced by another image forming apparatus. In such a case, in the information processing system according to the second embodiment, the information for determining a function to be executed based on biometric information identification information as illustrated in FIG. 9B that is stored in the biometric information ID storing unit 15 of the image forming apparatus 1 may have to be transferred to the other image forming apparatus. In contrast, in the information processing system according to the third embodiment, the authentication control apparatus 4 may continue using the information for determining a function to be executed based on biometric information identification information stored in the biometric information ID storing unit 43 even when the image forming apparatus 1 is replaced. Accordingly, the burden and trouble associated with replacing the image forming apparatus 1 may be reduced, for example. The information processing system according to the third embodiment is described in greater detail below.

FIG. 10 is a block diagram illustrating an exemplary functional configuration of the information processing system according to the third embodiment. FIG. 11 is a sequence chart illustrating an exemplary operation flow from biometric authentication to execution of a function in the information processing system according to the third embodiment.

In FIG. 10, the image forming apparatus 1 includes an authentication control apparatus connecting unit 16 instead of the biometric authentication server connecting unit 12. As with the other components of the image forming apparatus, the authentication control apparatus connecting unit 16 may be implemented by executing one or more programs installed in the image forming apparatus 1 by the processor 106. The authentication control apparatus connecting unit 16 is configured to establish communication with the authentication control apparatus 4 to transmit a biometric information ID, for example.

The authentication control apparatus 4 may have a hardware configuration similar to that of the biometric authentication server 3 as described above with reference to FIG. 3, for example, and is connected to the image forming apparatus 1 and the biometric authentication server 3 via the network NW.

The authentication control apparatus 4 includes a biometric authentication server connecting unit 41, the function determining unit 42, the biometric information ID storing unit 43, and an image forming apparatus connecting unit 44. As with the other functional components described above, the biometric authentication server connecting unit 41, the function determining unit 42, the biometric information ID storing unit 43, and the image forming apparatus connecting unit 44 may be implemented by having a processor of the authentication control apparatus 4 execute one or more programs installed in the authentication control apparatus 4.

The biometric authentication server connecting unit 41 is configured to establish communication with the biometric authentication server 3 to receive a biometric information ID, for example. The image forming apparatus connecting unit 44 is configured to establish communication with the image forming apparatus 1 to transmit a “function to be executed,” for example. The function determining unit 42 and the biometric information ID storing unit 43 may respectively have functions and configurations identical to those of the function determining unit 14 and the biometric information ID storing unit 15 included in the image forming apparatus of the information processing system according to the second embodiment.

In the following, referring to FIG. 11, operations from biometric authentication to execution of a function in the information processing system according to the third embodiment that vary from the operations executed in the information processing system according to the second embodiment are described.

In step S4 (biometric information search) of FIG. 11, the biometric authentication unit 33 of the biometric authentication server 3 transmits information (return values) obtained from searching information stored in the biometric information storing unit 32 (see FIG. 9A) to the biometric authentication server connecting unit 41 of the authentication control apparatus 4. In the case where the authentication result included in the result values is successful authentication (authentication OK); namely, when a match is found from the search, the biometric authentication server connecting unit 41 sends a function determination request including the “biometric information ID” included in the return values to the function determining unit 42 (step S4-1). In turn, the function determining unit 42 uses the “biometric information ID” included in the function determination request as a key to search information stored in the biometric information ID storing unit (step S4-2 “biometric information ID search”). The function determining unit 42 extracts and determines a corresponding “function to be executed” stored in association with the “biometric information ID” in the biometric information ID storing unit 43 and returns the determined “function to be executed” to the biometric authentication server connecting unit 41.

The biometric authentication server connecting unit 41 of the authentication control apparatus 4 passes the authentication result, the user information, and the function to be executed to the image forming apparatus connecting unit 44. In turn, the image forming apparatus connecting unit 44 transmits these information items to the authentication control apparatus connecting unit 16 of the image forming apparatus 1. Upon receiving the information items, the authentication control apparatus connecting unit 16 allows the relevant user to use the image forming apparatus 1 and sends an execution request for executing the “function to be executed” to the execution command unit 13 (step S5 “execution request of function to be executed”). In turn, the execution command unit 13 directs an application of the image forming apparatus 1 to execute the “function to be executed.” In this way, a function unit (e.g., scanner 101 or plotter 102 of FIG. 2) of the image forming apparatus 1 may be prompted to execute the “function to be executed.”

On the other hand, in the case where the result of the biometric information search (step S4) is authentication failure (authentication NG); namely, when no match is found from the search, the biometric authentication unit 33 of the biometric authentication server 3 merely returns the authentication result to the biometric authentication server connecting unit 41 of the authentication control apparatus 4 via an authentication control apparatus connecting unit 34. In this case, steps S4-1, S4-2, and S5 are not executed, and instead, the biometric authentication server connecting unit 41 transmits the authentication result to the authentication control apparatus connecting unit 16 of the image forming apparatus via the image forming apparatus connecting unit 44. In turn, the authentication control apparatus connecting unit 16 notifies the user of the image forming apparatus 1 of the authentication result.

Note that in the information processing system of the third embodiment, biometric information storing unit 32 corresponds to an exemplary embodiment of an authentication information managing unit, the biometric authentication unit 33 corresponds to an exemplary embodiment of an authentication unit, the biometric information ID storing unit 43 corresponds to an exemplary embodiment of an authentication information identification information managing unit, and the function determining unit 42 corresponds to an exemplary embodiment of a function determining unit. Also, the execution command unit 13 corresponds to an exemplary embodiment of an execution command unit. Also, the scanner 101 and the plotter 102 correspond to exemplary embodiments of a function unit. Also, the biometric information reading device control unit 11 corresponds to an exemplary embodiment of an authentication information obtaining unit.

### Fourth Embodiment

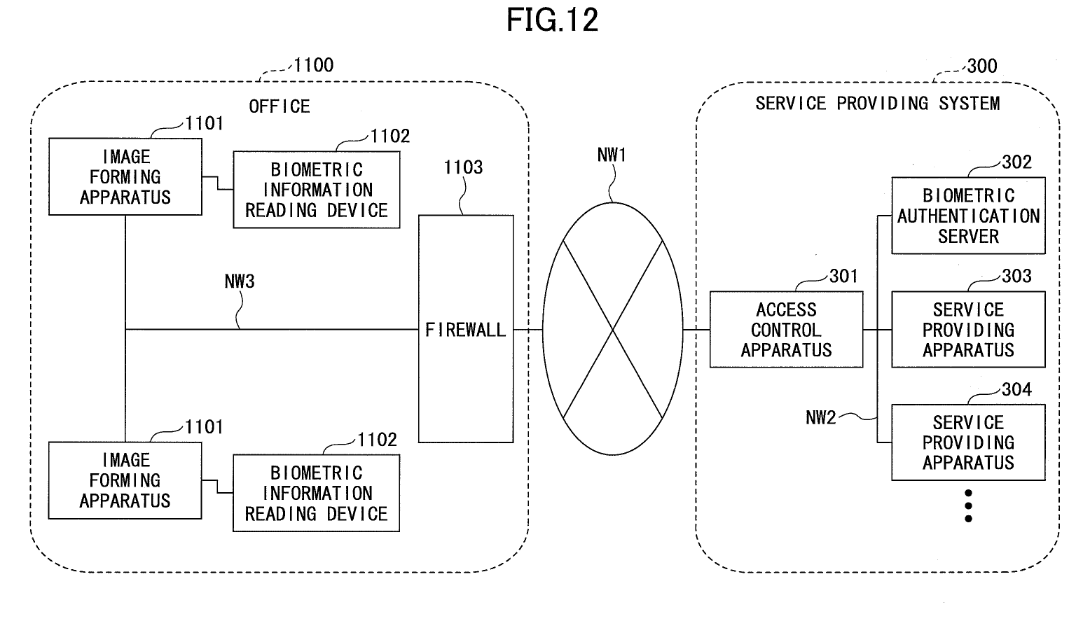

In the following, an information processing system according to a fourth embodiment of the present invention is described with reference to FIGS. 12-16C.

FIG. 12 illustrates an exemplary overall configuration of the information processing system according to the fourth embodiment.

In the information processing system of FIG. 12, one or more image forming apparatuses 1101 provided within an office 1100 may communicate via a wide-area network NW1 such as the Internet with a service providing system 300. The service providing system 300 is an exemplary embodiment of a second information processing system established at a second organization.

The service providing system 300 may be established at an organization (e.g., company) that provides a cloud service via the network NW1, for example. Although a cloud service is used in the present embodiment, aspects of the present invention may be applied to any other type of service provided via a network such as a service provided by an application service provider (ASP) or a Web service.

The service providing system 300 provides services via the network NW1. The service providing system 300 may include an access control apparatus 301, a biometric authentication server 302, and service providing apparatuses including a service providing apparatus 303 and a service providing apparatus 304 that are connected to each other via a network NW2 such as a local area network (LAN). The access control apparatus 301, the biometric authentication server 302, the service providing apparatus 303, and the service providing apparatus 304 may have a hardware configuration similar to that of the biometric authentication server 3 as illustrated in FIG. 3, for example.

The office 1100 is, for example, an office of a company that uses the service provided by the service providing system 300. In the office 1100, the image forming apparatuses 1101 and a firewall 1103 are connected to each other via a network NW3 such as a local area network (LAN). Also, a biometric information reading device 1102 is connected to the image forming apparatus 1101. The image forming apparatus 1101 in the office 1100 may have a hardware configuration similar to that of the image forming apparatus 1 as illustrated in FIG. 2. The image forming apparatus 1101 may be a multifunction peripheral including a scanning function, a printing function, a copying function, and a facsimile function, for example.

Note that although only one office 1100 is illustrated in FIG. 12, the service providing system 300 may be connected to plural offices of companies or organizations via the network NW1 and can provide services to those offices.

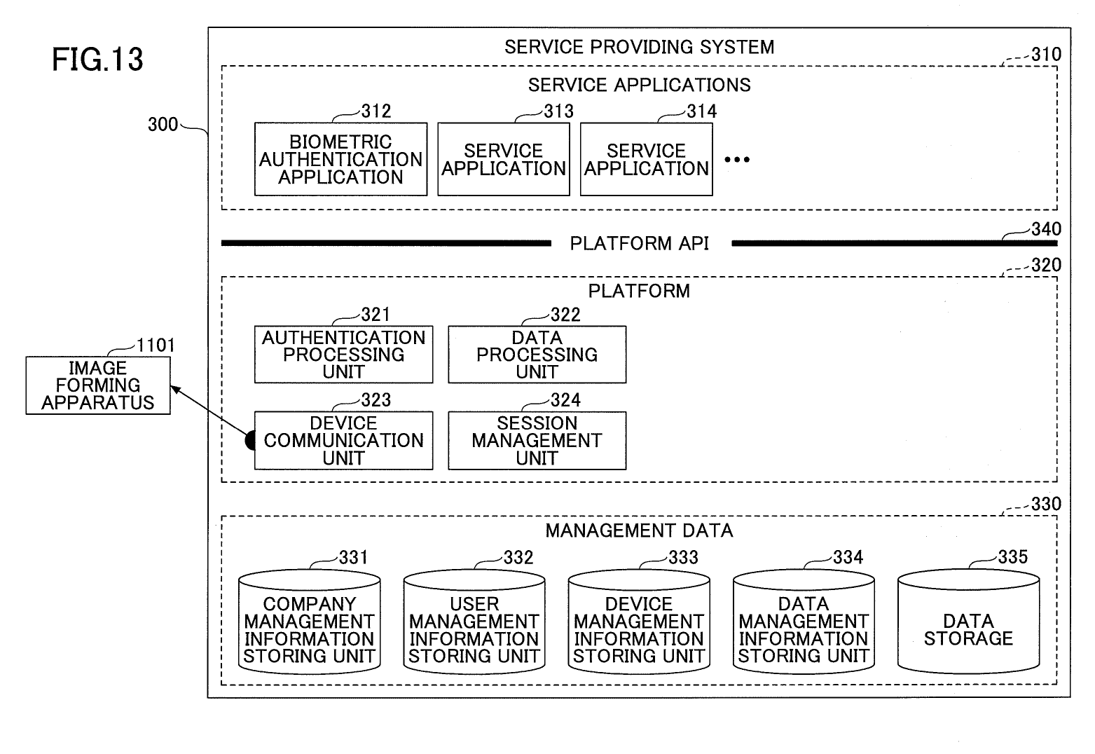

FIG. 13 illustrates an exemplary functional configuration of the service providing system 300 located at the organization providing cloud services in the information processing system according to the fourth embodiment.

As illustrated in FIG. 13, the service providing system 300 may include service applications 310 and a platform 320. The service applications 310 and the platform 320 may be implemented by one or more programs installed in the apparatuses 301-304 of the service providing system 300. Assuming that the apparatuses 301-304 each have a hardware configuration similar to that of the biometric authentication server 3 as illustrated in FIG. 3, the programs may be executed by the processor 206 of the respective apparatuses to perform various processes. Alternatively, the service providing system 300 of FIG. 13 may be implemented by one service providing apparatus including all functions of the service providing system 300. Also in this case, the service providing apparatus may have a hardware configuration similar to that of the biometric authentication server 3 as illustrated in FIG. 3.

The service providing system 300 may also include a company management information storing unit 331, a user management information storing unit 332, a device management information storing unit 333, a data management information storing unit 334, and a data storage 335 as management data storing units 330. Assuming that the apparatuses 301-304 each have a hardware configuration similar to that of the biometric authentication server as illustrated in FIG. 3, these storing units 330 may be implemented by the secondary storage unit 204 of the respective apparatuses. Alternatively, the storing units may be implemented by a storage unit (not shown) connected via a network to the service providing system 300.

The platform 320 includes common functions or basic functions that are used by the service applications 310. For example, the platform 320 may include an authentication processing unit 321, a data processing unit 322, a device communication unit 323, and a session management unit 324. The functions of these units are made public to the service applications 310 via a platform application programming interface (API) 340. In other words, the service applications 310 can use the functions of these units that are made public by the platform API 340.

A biometric authentication application 312 of the service applications 310 is an application program for performing biometric authentication and returning the authentication result. In a case where the authentication is successful, the biometric authentication application 312 returns “user information” and a “function to be executed” stored in association the authenticated biometric information. The biometric authentication application 312 may be installed in the biometric authentication server 302 of FIG. 12, for example.

Other service applications 310 such as service application 313, service application 314, and so on are application programs for providing various services such as a printing service and a scanning service, for example. The service applications 310 may stored in the service providing apparatuses 303 and 304 of FIG. 12, for example.

The authentication processing unit 321 authenticates users of the image forming apparatuses 1101 and returns authentication results. The session management unit 324 manages communication sessions between the service providing system 300 and the image forming apparatuses 1101. The device communication unit 323 controls communications via the networks NW1 and NW3 between the service providing system 300 and the image forming apparatuses 1101. The authentication processing unit 321, the session management unit 324, and the device communication unit 323 may be provided, for example, in the access control unit 301 of FIG. 12.

The data processing unit 322 performs processes on data received from the image forming apparatuses 1101 and data to be stored (managed) in the data storage 335. For example, the data processing unit 322 may perform processes such as converting application data into print data, and removing (deleting) stored data. The data processing unit 322 may be provided in each of the access control apparatus 301, the biometric authentication server 302, and the service providing apparatuses 303 and 304 of FIG. 12.

The company management information storing unit 331 stores information on companies, organizations, groups, and so on related to services provided by the service providing system 300. The user management information storing unit 332 stores information on users of services provided by the service providing system 300. The device management information storing unit 333 stores information (e.g., company code described later) related to apparatuses in a user system environment (e.g., an office) that use services provided by the service providing system 300. The data management information storing unit 334 stores information on data stored in the data storage 335. The data storage 335 stores, for example, data received from the image forming apparatuses 1101, data received from other external apparatuses, and data processed based on the received data.

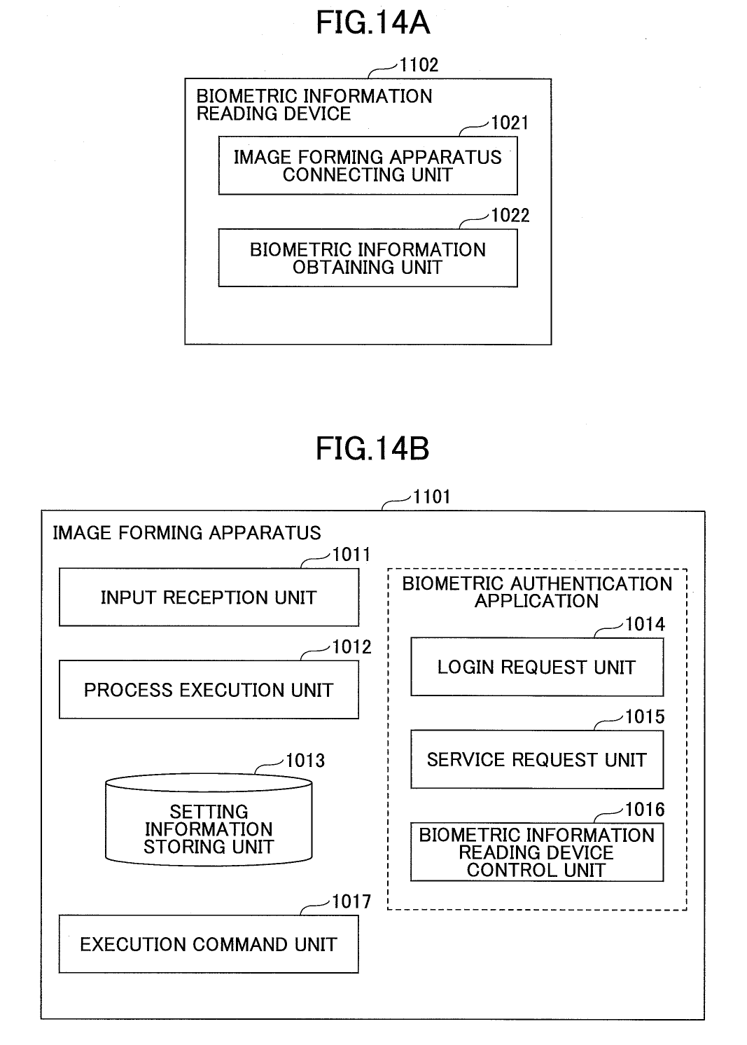

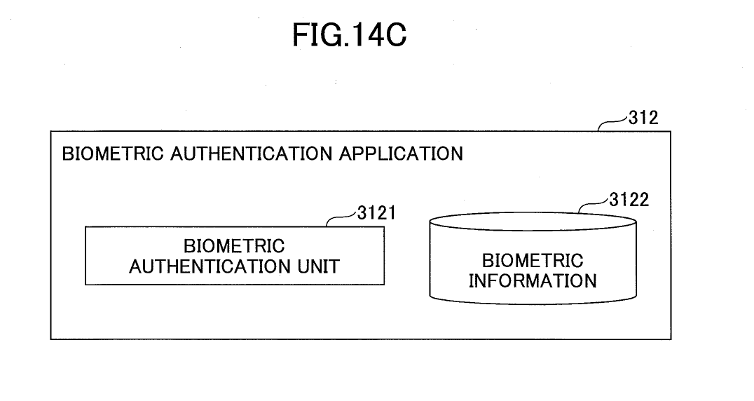

FIG. 14A illustrates an exemplary functional configuration the biometric information reading device 1102 in the information processing system of FIG. 12. FIG. 14B illustrates an exemplary functional configuration of the image forming apparatus 1101 of the information processing system of FIG. 12. FIG. 14C illustrates an exemplary functional configuration of the biometric authentication application 312 of the information processing system of FIG. 12.

Referring to FIG. 14B, the image forming apparatus 1101 includes an input reception unit 1011, a process execution unit 1012, a setting information storing unit 1013, a login request unit 1014, a service request unit 1015, a biometric information reading device control unit 1016, and an execution command unit 1017. The input reception unit 1011, the process execution unit 1012, the login request unit 1014, the service request unit 1015, the biometric information reading device control unit 1016, and the execution command unit 1017 are implemented by executing one or more programs installed in the image forming apparatus 1101 by a processor (CPU). For example, when the image forming apparatus 1101 has a hardware configuration similar to that of the image forming apparatus 1 as illustrated in FIG. 2, the processor corresponds to the processor 106. Also when the image forming apparatus 1101 has a hardware configuration as illustrated in FIG. 2, the setting information storing unit 1013 may be implemented by the memory 105 or the secondary storage unit 104, for example.

The input reception unit 1011 of the image forming apparatus 1101 receives, for example, user operations (e.g., touch operations) and inputs via an operations panel and a keyboard (not shown) of the image forming apparatus 1101. The login request unit 1014 sends a login request to the service providing system 300. The service request unit 1015 requests services of the service providing system 300. The process execution unit 1012 executes output processes such as printing and display of output data, or obtains image data by scanning a documents, for example. The execution command unit 1017 requests an application of the image forming apparatus 1101 to execute a “function to be executed” in the case where biometric authentication is successful. In this way, a function unit (e.g., scanner 101 or plotter 102 of FIG. 2 in the case where the image forming apparatus 1101 has a configuration similar to that of the image forming apparatus 1) may be prompted to execute the “function to be executed.” The setting information storing unit 1013 stores setting information for using services of the service providing system 300. The biometric information reading device control unit 1016 controls the biometric information reading device 1102 (e.g., requests the biometric information reading device 1102 to capture biometric information).

The biometric information reading device 1102 includes an image forming apparatus connecting unit 1021 and a biometric information obtaining unit 1022. The biometric information reading device 1102 may have a configuration similar to that of the biometric information reading device 2 of FIG. 4. The image forming apparatus connecting unit 1021 communicates with the image forming apparatus 1101 to receive a request to capture biometric information from and send the captured biometric information to the image forming apparatus 1101. The biometric information obtaining unit 1022 obtains (or captures) biometric information.

Referring to FIG. 14C, the biometric authentication application 312 includes a biometric authentication unit 3121 and a biometric information storing unit 3122. The biometric authentication unit 3121 performs biometric authentication and returns an authentication result. In the case where authentication is successful, the biometric authentication unit 3121 also returns “user information” and a “function to be executed” that are stored in association with the relevant biometric information in the biometric information storing unit 3122. The biometric information storing unit 3122 may be substantially similar to the biometric information storing unit 32 described above with reference to FIG. 4 and stores biometric information and information associated with the biometric information such as “user information” and “function to be executed.” For example, the biometric information storing unit 3122 may store information used for biometric authentication and determining a function to be executed as illustrated in FIG. 6.

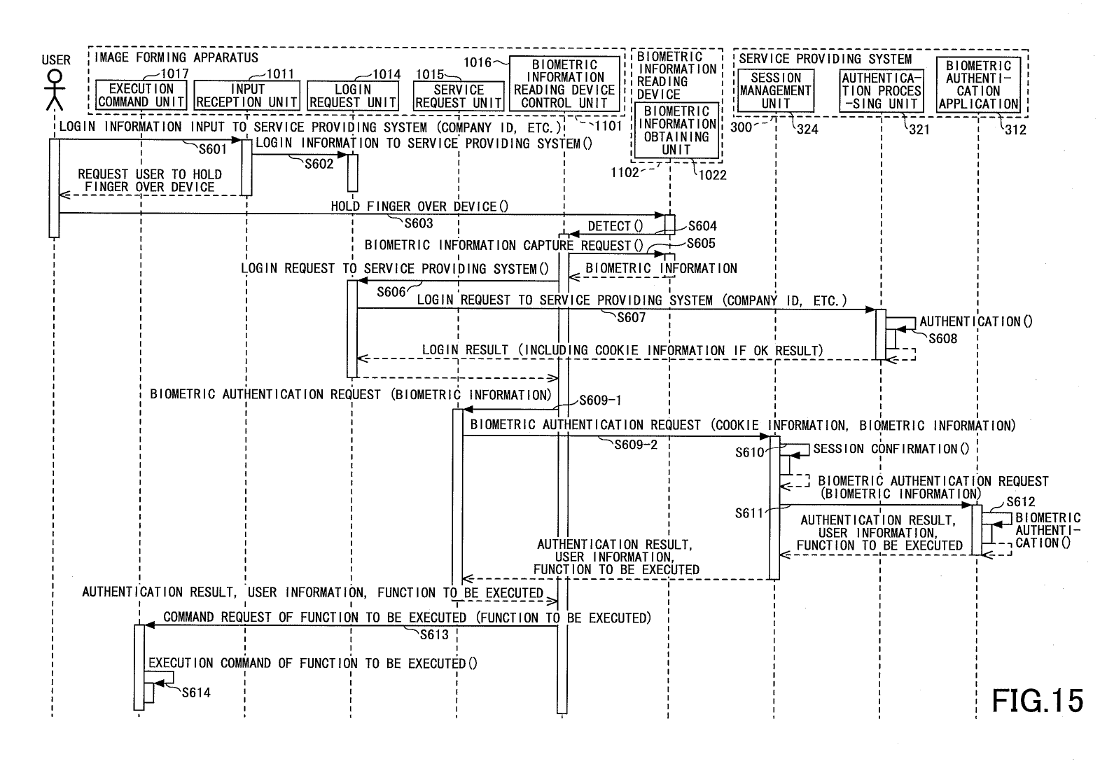

In the following, a process flow of operations for biometric authentication and determining a function to be executed implemented in the information processing system of FIG. 12 are described with reference to FIG. 15.

In FIG. 15, first in step S601, when a user inputs login information via an operating display unit (e.g., operating display unit 108 of FIG. 2 in the case where the image forming apparatus 1101 has a configuration identical to that of the image forming apparatus 1) of the image forming apparatus 1101, the input reception unit 1011 receives the input. The input reception unit 1011 then passes the received login information to the login request unit 1014 (step S602). Note that in one embodiment, a portion or all of the received login information may be stored in the setting information storing unit 1013 so that user input operations may be simplified or omitted the next time the user attempts to login to the image forming apparatus 1101. In another embodiment, a proxy user may be provided and a portion or all of login information may be stored in the setting information storing unit 1013 beforehand so that user input operations may be simplified or omitted.

Then, according to instructions (guidance) issued by the input reception unit 1011 via the operating display unit, the user holds, for example, a finger or a palm over the biometric information reading device 1102 connected to the image forming apparatus 1101 (step S603). Upon detecting the finger or the palm, the biometric information obtaining unit 1022 of the biometric information reading device 1102 sends a notification of the detection to the biometric information reading device control unit 1016 of the image forming apparatus 1101 (step S604 “detect”). In turn, the biometric information reading device control unit 1016 issues a biometric information capture request to obtain biometric information of the detected finger or palm, for example (step S605). In response, the biometric information obtaining unit 1022 captures biometric information (e.g., finger/palm vein pattern, fingerprint, palm print) of the detected finger or palm and returns the captured biometric information to the biometric information reading device control unit 1016 of the image forming apparatus 1101.

Then, the biometric information reading device control unit 1016 of the image forming apparatus 1101 sends a service providing system login request for logging into the service proving system 300 to the login request unit 1014 (step S606). Upon receiving the service providing system login request, the login request unit 1014 sends the login information obtained in step S602 to the service providing system 300 along with the service providing system login request (step S607).

Upon receiving the service providing system login request from the login request unit 1014, the authentication processing unit 321 of the service providing system 300 performs authentication determination based on the received login information (step S608), and returns a login response (login result) based on the authentication result to the login request unit 1014 of the image forming apparatus 1101. The login request unit 1014 passes the received login result to the biometric information reading device control unit 1016. In the case where the login result is login OK (authentication successful), the authentication processing unit 321 also sends a token (e.g., cookie) along with the login result. In this case, the token may be stored in association with login information included in the above service providing system login request in the data storage 335 of the service providing system 300, for example.

In the case where the login result is login OK (successful authentication), the biometric information reading device control unit 1016 of the image forming apparatus 1101 sends a biometric authentication request including the biometric information obtained in step S605 to the service request unit 1015 (step S608). Upon receiving the biometric authentication request, the service request unit 1015 sends the received biometric information and the token obtained in step S608 as a biometric authentication request to the session management unit 321 of the service providing system 300 (steps S609-1 and S609-2).

The session management unit 321 of the service providing system 300 confirms whether the token received in step S609-2 is included in the token stored in the data storage 335 (step S610 “session confirmation”). If the received token is stored in the data storage 335, the session management unit 324 sends the biometric information received in step S609-2 to the biometric authentication application 312 (step S611 “biometric authentication request”).

In turn, the biometric authentication application 312 of the service providing system 300 performs biometric authentication based on the received biometric information. If the authentication is successful, the biometric authentication application 312 returns the authentication result along with “user information” and “function to be executed” associated with the authenticated biometric information to the service request unit 1015 of the image forming apparatus 1101 via the session management unit 324 (step S612). Note that biometric authentication performed by the biometric authentication application 312 (biometric authentication unit 3121) in step S612 may be similar to the biometric information search performed in step S4 of FIG. 5B so that overlapping descriptions are omitted.

The service request unit 1015 of the image forming apparatus 1101 sends the authentication result received from the service providing system 300 to the biometric information reading device control unit 1016 (including “user information” and “function to be executed” in the case where authentication is successful). The biometric information reading device control unit 1016 of the image forming apparatus 1101 logs into the image forming apparatus 1101 using the received user information in the case where authentication is successful. Further, the biometric information reading device control unit 1016 communicates the received “function to be executed” to the execution command unit 1017 (step S613 “execution request of function to be executed”).

In turn, the execution command unit 1017 of the image forming apparatus 1101 executes the following operations based on the “function to be executed” communicated from the biometric information reading device control unit 1016. The execution command unit 1017 directs an application of the image forming apparatus 1101 to executed the “function to be executed” (step S614 “execution command of function to be executed”). In this way, a function unit (e.g., scanner 101 or plotter 102 of FIG. 2 in the case where the image forming apparatus 1101 has a configuration similar to that of the image forming apparatus 1) may be prompted to execute the “function to be executed.”

On the other hand, in the case where the result of the biometric authentication (step S612) is authentication failure (authentication NG); namely, when no match is found, the biometric authentication application 312 merely returns the authentication result to the service request unit 1015 of the image forming apparatus 1101 via the session management unit 324. In turn, the service request unit 1015 passes the authentication result to the biometric information reading device control unit 1016. In this case, steps S613 and S614 are not performed, and instead, the biometric information reading device control unit 1016 communicates the authentication result to the user of the image forming apparatus 1101.

As with the information processing system according to the first embodiment, in one aspect of the information processing system according to the fourth embodiment, when using the image forming apparatus 1101 to execute a certain function, the image forming apparatus 1101 may be easily prompted to execute the function. That is, by providing corresponding biometric information pre-registered in association with a “function to be executed” in the biometric authentication application 312 through holding a finger (e.g., left thumb) over the biometric information reading device 1102 connected to the image forming apparatus 1101 (step S603 of FIG. 15), for example, the image forming apparatus 1101 may be prompted to execute the “function to be executed.”

Further, in the information processing system according to the fourth embodiment, the following advantageous effects may be obtained in addition to the advantageous effects described above. In the fourth embodiment, the process for determining the corresponding “function to be executed” associated with the biometric information obtained by the biometric information reading device 1102 is performed at the service providing system 300 (biometric authentication application 312), which is established at the organization providing cloud services. Thus, a biometric authentication server such as the biometric authentication server 3 does not have to be provided at the office 1100 illustrated in FIG. 12. In this way, office space costs for providing the biometric authentication server may be conserved. Also, administration of the information processing system may be facilitated owing to the reduction or elimination of required operations for managing the biometric authentication server at the office 1100.

Note that in the information processing system of the fourth embodiment, the biometric authentication application 312 corresponds to an exemplary embodiment of a user authentication and function determination unit. Also, in the case where the image forming apparatus 1101 has a configuration identical to that of the image forming apparatus 1 of FIG. 2, the scanner 101 and the plotter 102 correspond to exemplary embodiments of a function unit. The execution command unit 1017 corresponds to an exemplary embodiment of an execution command unit. Also, the biometric information reading device control unit 1016 corresponds to an exemplary embodiment of an authentication information obtaining unit.

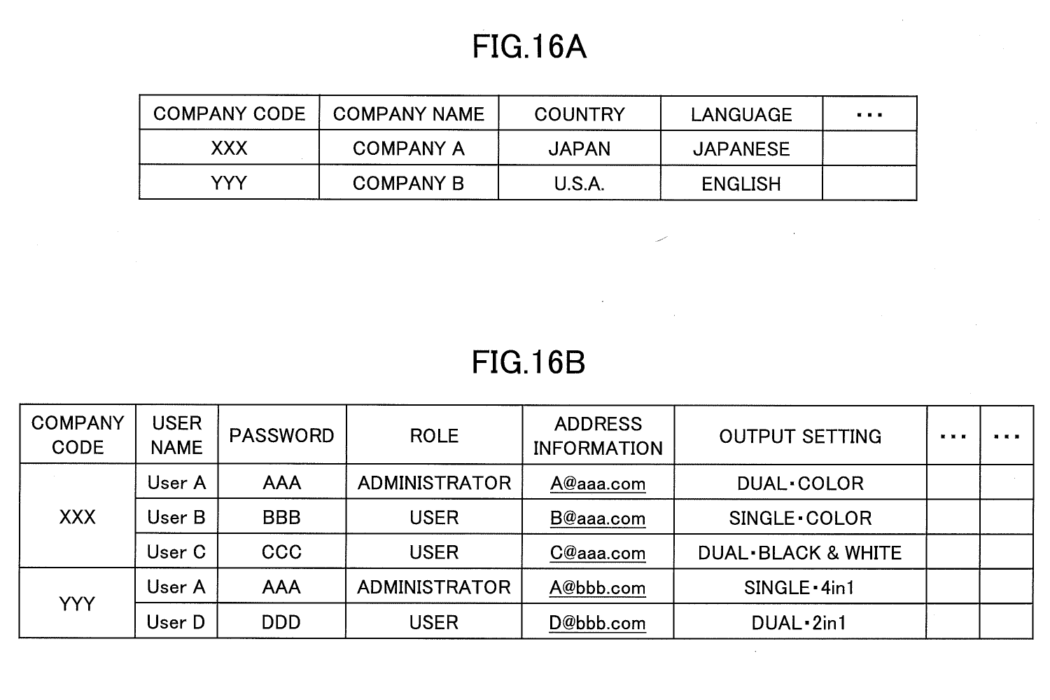

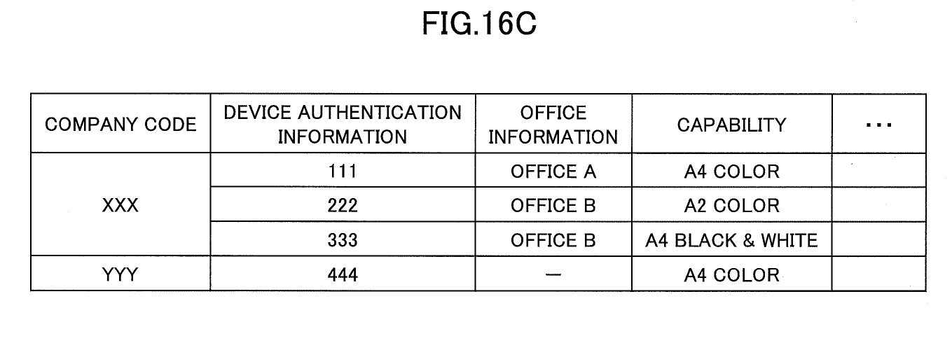

In the following, information stored in the company management information storing unit 331, the user management information storing unit 332, and the device management information storing unit 333 are described with reference to FIGS. 16A-16C.

FIG. 16A is a table illustrating an exemplary data configuration of company management information of the information processing system of FIG. 12. FIG. 16B is a table illustrating an exemplary data configuration of user management information of the information processing system of FIG. 12. FIG. 16C is a table illustrating an exemplary data configuration of device management information of the information processing system of FIG. 12.

In FIGS. 16A-16C, “company code” (company ID) corresponds to information for identifying a group such as a company or an organization. The company code is information that can identify a group of one or more users or devices. The “company code” is not limited to identifying a company, but may also identify contract information identifying a contract with a group of users or devices, for example. Note that the “company code” is unique information assigned to each group, and the information of FIGS. 16A-16C are managed based on the company code.

In FIG. 16B, “user name” and “password” correspond to information for identifying a user. The “user name” may be a user ID, and in some embodiments, the “password” may be omitted. Also, information for identifying an electronic medium owned by the user such as an IC card, a mobile phone, a tablet terminal, an electronic book terminal (e.g., card ID, device serial ID, phone number, profile information of terminal) may be used as information for identifying the user. Note that a “user name” and a “password” managed under a given company code has to be unique within the given company code. However, the “user name” and “password” may overlap if their corresponding company codes are different.

In FIG. 16C, “device authentication information” corresponds to information for determining whether a device (e.g., image forming apparatus 1101) meets certain conditions. For example, the “device authentication information” may be an ID indicating that a certain application is installed in the device or a device number indicating the type of the device.

### Fifth Embodiment

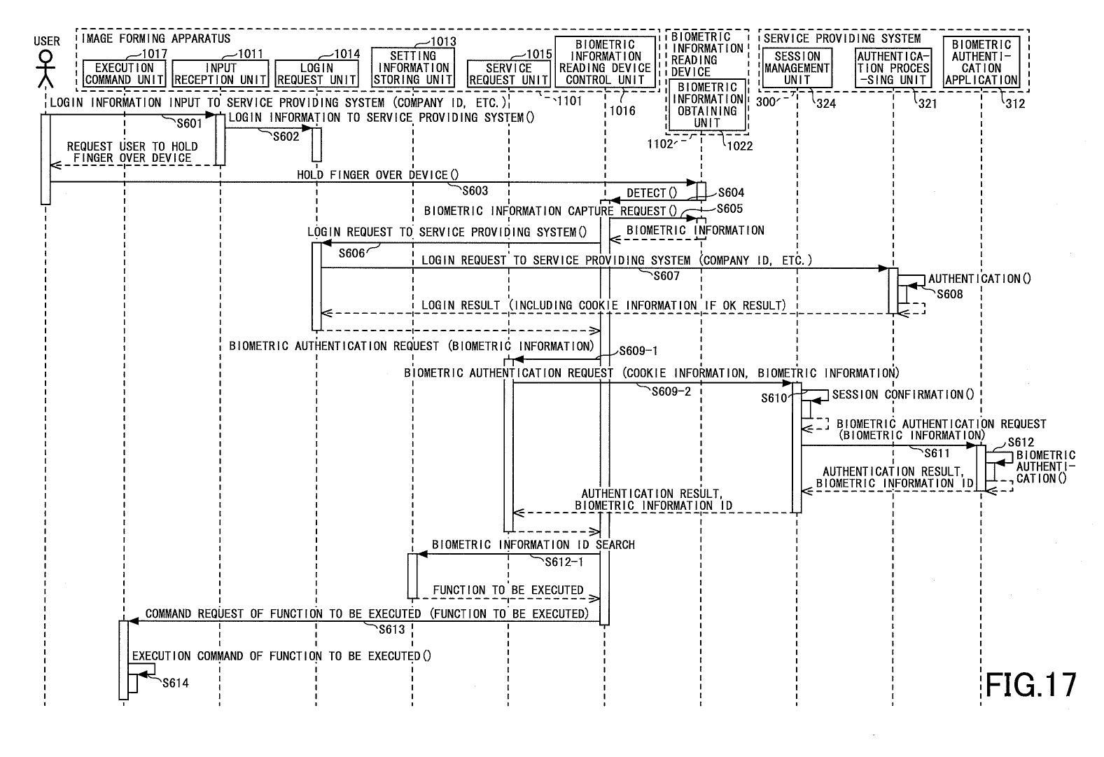

In the following, an information processing system according to a fifth embodiment of the present invention is described with reference to FIG. 17.

Note that the information processing system according to the fifth embodiment has features and functions similar to the information processing system according to the fourth embodiment. Therefore, identical features and functions are given the same reference numerals and their descriptions are omitted.

The information processing system according to the fifth embodiment differs from the information processing system according to the fourth embodiment in a manner similar to the way the information processing system according to the second embodiment differs from the information processing system according to the first embodiment.

That is, in the information processing system according to the fourth embodiment, “authentication result,” “user information,” and “function to be executed” are passed back as return values of the biometric authentication (step S612 of FIG. 15). On the other hand, in the information processing system according to the fifth embodiment, “authentication result” and “biometric information ID” are passed back as return values of the biometric authentication (step S612 of FIG. 17). In turn, the image forming apparatus 1101 that receives the return values from the biometric authentication application 312 extracts and determines a “function to be executed” corresponding to the received “biometric information ID” and executes the determined “function to be executed.”

In the information processing system according to the fifth embodiment, for example, the following advantageous effects may be obtained in addition to the advantageous effects obtained by the information processing system according to the fourth embodiment. In one aspect, by having the biometric authentication application 312 transmit the return value “biometric information ID” rather than “function to be executed” to the image forming apparatus 1101, the “function to be executed” corresponding to the “biometric information ID” may be flexibly set up at the image forming apparatus 1101 and user convenience may be improved, for example. The information processing system according to the fifth embodiment is described in greater detail below.

The configuration of the information processing system according to the fifth embodiment differs from that of the information processing system according to the fourth embodiment in the following manner. In the information processing system of the fifth embodiment, the biometric information storing unit 3122 of the biometric authentication application 312 stores (manages) information used for biometric authentication and obtaining biometric information identification information as illustrated in FIG. 9A rather than information used for biometric authentication and determining a function to be executed as illustrated in FIG. 6. That is, the biometric information storing unit 3122 stores (manages) the information item “biometric information ID” instead of “function to be executed.” Thus, the information item “function to be executed” is not included in the return values of the biometric authentication (step S612), but the information item “biometric information ID” is included instead.

As illustrated in FIG. 9A, the “biometric information ID” may be a combination of the user ID of the relevant user (e.g., “user001”) and a serial number (e.g., “−1”), for example. In this way, the image forming apparatus 1101 that receives such information item may easily recognize the user ID included in the biometric information ID and determine the corresponding user associated with the biometric information ID. Thus, “user information” may be omitted from the return values of the biometric information search, for example. However, the return values are not limited to the illustrated example. In other examples, the biometric information ID may not include a user ID, and the return values may include “user information” and “biometric information ID.”

In the information processing system of the fifth embodiment, the setting information storing unit 1013 of the image forming apparatus 1101 stores (manages) information for determining a function to be executed based on biometric information identification information as illustrated in FIG. 9B, for example. That is, the setting information storing unit 1013 stores (manages) the information items “biometric information ID” and “function to be executed” in association with each other as information for determining a function to be executed based on biometric information identification information.

Note that the information item “biometric information ID” of FIG. 9B corresponds to the “biometric information ID” stored (managed) by the biometric information storing unit 3122 as illustrated in FIG. 9A. Also, the information item “function to be executed” in FIG. 9B corresponds to the information item “function to be executed” of FIG. 6 that is stored by the biometric information storing unit 3122 in the information processing system of the fourth embodiment.

In the following, operations from biometric authentication to execution of a function in the information processing system of the fifth embodiment that vary from the operations executed in the information processing system of the fourth embodiment as illustrated in FIG. 15 are described with reference to FIG. 17.

In step S612 (biometric authentication), the biometric authentication unit 3121 of the biometric authentication application 312 uses the biometric information received in step S611 as a key to search the information stored (managed) in the biometric information storing unit 3122 (see FIG. 9A). If biometric information matching the received biometric information is found, the biometric authentication unit 3121 performs the following operations. Namely, the biometric authentication unit 3121 transmits (returns) the authentication result (successful authentication) and the “biometric information ID” stored in association with the matching biometric information in the biometric information storing unit 3122 to the service request unit 1015 of the image forming apparatus 1101 via the session management unit 324.

The service request unit 1015 passes the received information to the biometric information reading device control unit 1016. In the case where the authentication result is successful (authentication OK); namely, when biometric information matching the key is found, the biometric information reading device control unit 1016 allows the relevant user to use the image forming apparatus 1101. Also, the biometric information reading device control unit 1016 uses the “biometric information ID” received in step S612 as a key to search information stored in the setting information storing unit 1013 (step S612-1 “biometric information ID search”). In this way, the biometric information reading device control unit 1016 may extract and determine a “function to be executed” stored in association with the “biometric information ID” in the setting information storing unit 13.

The biometric information reading device control unit 1016 sends the determined “function to be executed” along with an execution request have the determined function executed to the execution command unit 1017 (step S613 “execution request of function to be executed). The execution command unit 1017 directs an application of the image forming apparatus 1101 to execute the “function to be executed.” In this way, a function unit (e.g., scanner 101 or plotter 102 of FIG. 2 in the case where the image forming apparatus 1101 has a configuration similar to that of the image forming apparatus 1) may be prompted to execute the “function to be executed.”

On the other hand, in the case where the result of the biometric authentication (step S612) is authentication failure (authentication NG); namely, when no match is found, the biometric authentication application 312 merely returns the authentication result to the service request unit 1015 of the image forming apparatus 1101 via the session management unit 324. The service request unit 1015 passes the authentication result to the biometric information reading device control unit 1016. In this case, steps S612-1, S613, and S614 are not executed, and instead, the biometric information reading device control unit 12 notifies the user of the image forming apparatus 1101 of the authentication result.

Note that in the information processing system of the fifth embodiment, biometric information storing unit 3122 of the biometric authentication application 312 corresponds to an exemplary embodiment of an authentication information managing unit, the biometric authentication unit 3121 corresponds to an exemplary embodiment of an authentication unit, the setting information storing unit 1013 corresponds to an exemplary embodiment of an authentication information identification information managing unit, the service request unit 1015 corresponds to an exemplary embodiment of a function determining unit. Also, the execution command unit 1017 corresponds to an exemplary embodiment of an execution command unit. Also, in the case where the image forming apparatus 1101 has a configuration similar to that of the image forming apparatus 1, the scanner 101 and the plotter 102 correspond to exemplary embodiments of a function unit. Also, the biometric information reading device control unit 1016 corresponds to an exemplary embodiment of an authentication information obtaining unit.

### Sixth Embodiment

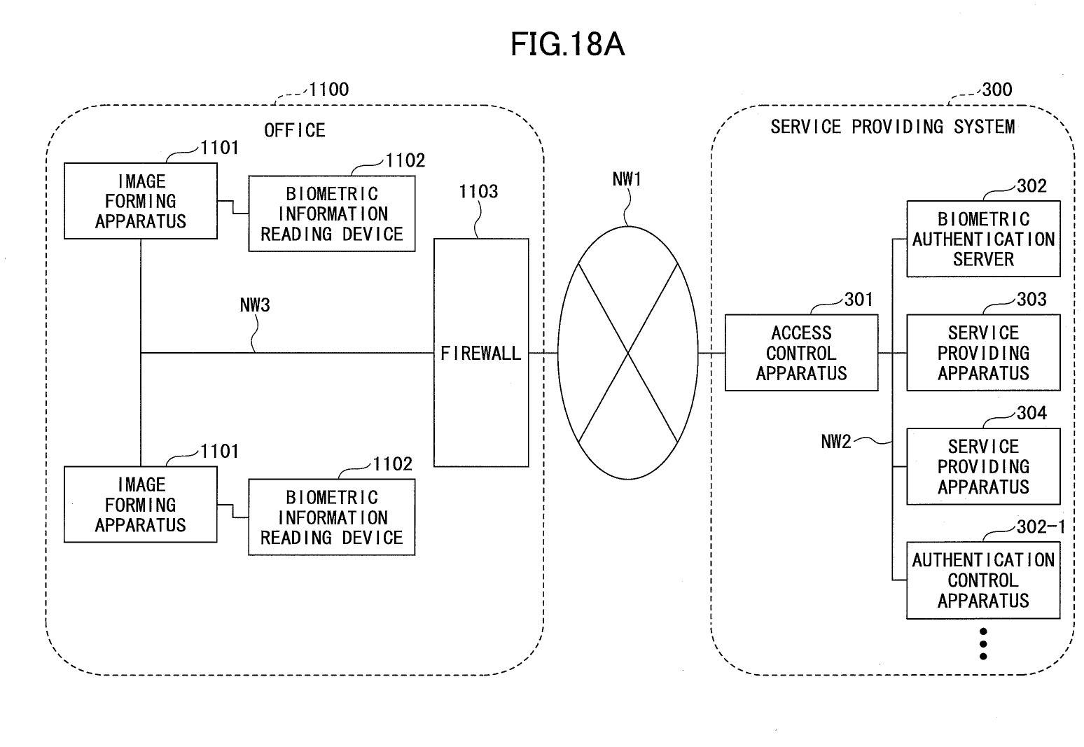

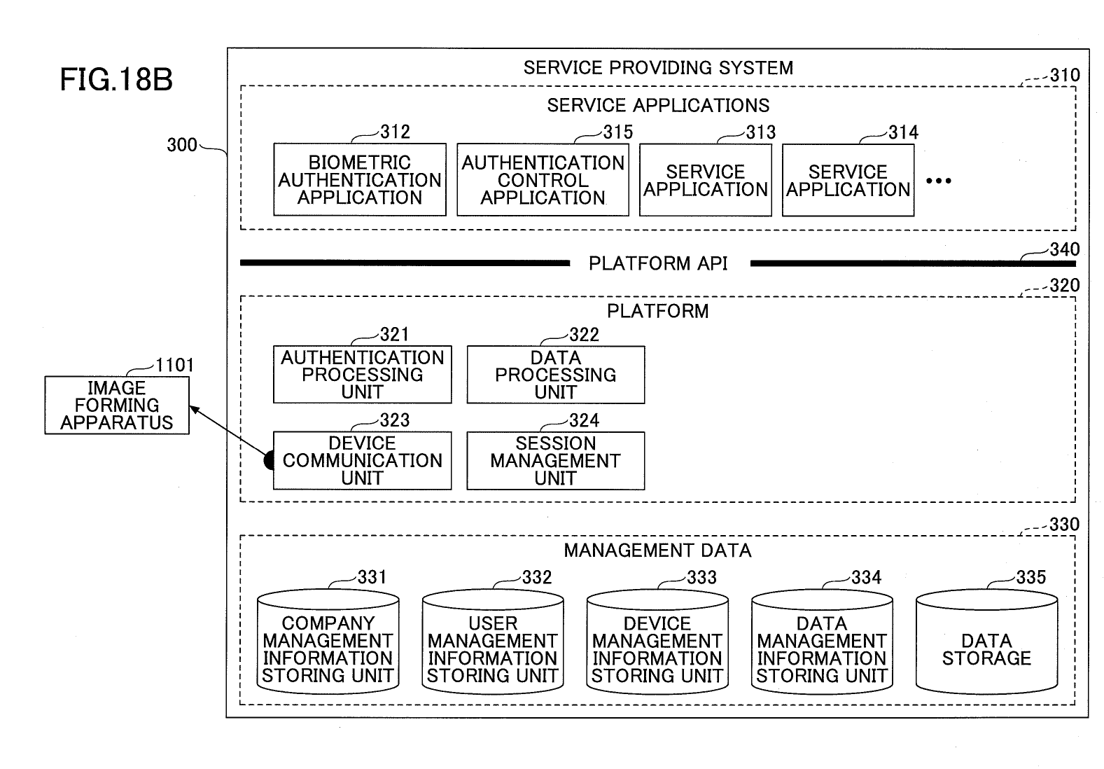

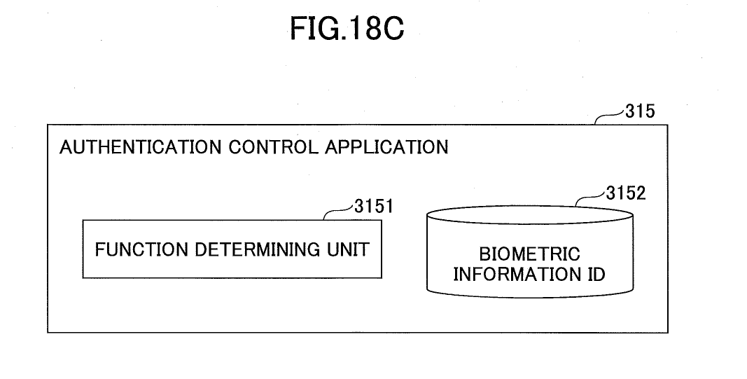

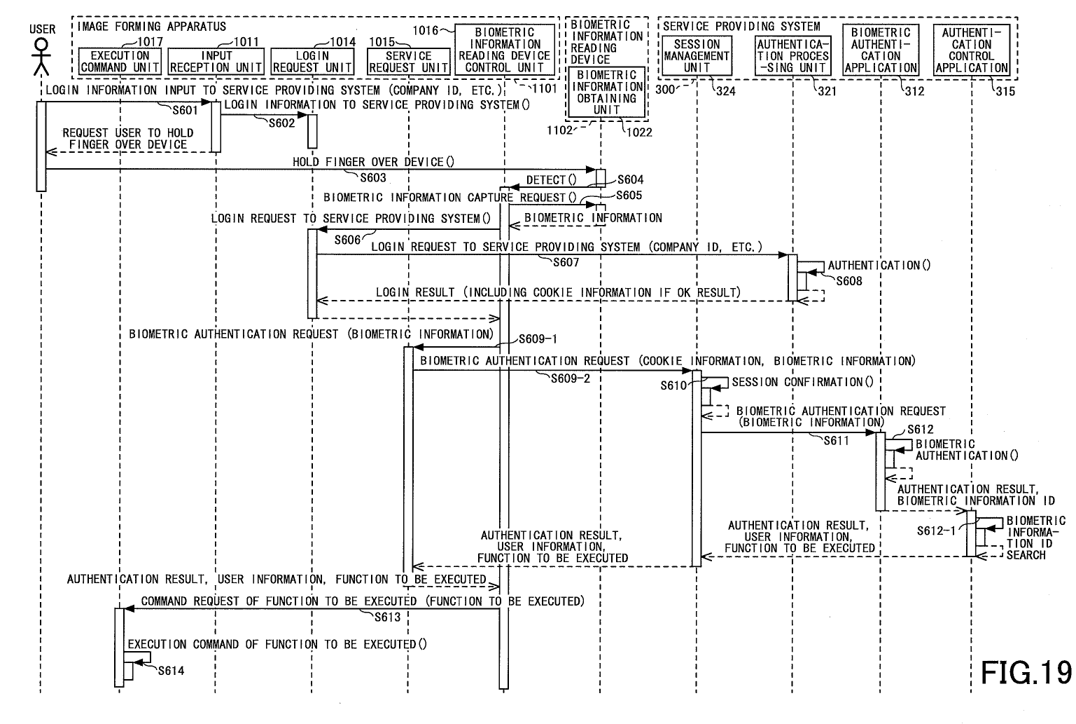

In the following, an information processing system according to a sixth embodiment of the present invention is described with reference to FIGS. 18A-19.

Note that the information processing system according to the sixth embodiment has features and functions similar to the information processing system according to the fifth embodiment. Therefore, identical features and functions are given the same reference numerals and their descriptions are omitted.

The information processing system according to the sixth embodiment differs from the information processing system according to the fifth embodiment in a manner similar to the way the information processing system according to the third embodiment differs from the information processing system according to the second embodiment.

That is, in the information processing system according to the fifth embodiment as illustrated in FIG. 17, the image forming apparatus 1101 is configured to determine the “function to be executed” based on the “biometric information ID” from the biometric authentication application 312. On the other hand, in the information processing system according to the sixth embodiment as illustrated in FIG. 19 the service providing system 300 includes an authentication control application 315. The authentication control application 315 is configured to determine the “function to be executed” based on the “biometric information ID” from the biometric authentication application 312 and communicate the determined “function to be executed” to the image forming apparatus 1101.

In the information processing system according the sixth embodiment, for example, the following advantageous effects may be obtained in addition to the advantageous effects obtained by the information processing system according to the fifth embodiment. In one aspect, there may be a case where the image forming apparatus 1101 is replaced by another image forming apparatus. In such a case, in the information processing system according to the fifth embodiment, the information for determining a function to be executed based on biometric information identification information as illustrated in FIG. 9B that is stored in the setting information storing unit 1013 of the image forming apparatus 1101 may have to be transferred to the other image forming apparatus. In contrast, in the information processing system according to the sixth embodiment, the authentication control application 315 includes a biometric information ID storing unit 3152 (see FIG. 18C) that stores the information for determining a function to be executed based on biometric information identification information, and the authentication control application 315 may continue to use such information. That is, the information for determining a function to be executed based on biometric information identification information does not have to be transferred in the information processing system according to the sixth embodiment. Accordingly, the burden and trouble associated with replacing the image forming apparatus 1101 may be reduced, for example. The information processing system according to the sixth embodiment is described in greater detail below.

As illustrated in FIG. 18A, in the information processing system according to the sixth embodiment, the service providing system 300 includes an authentication control apparatus 302-1. The authentication control apparatus 302-1 is connected to the network NW2 within the service providing system 300 so that it is able to communicate with the access control apparatus 301, the authentication server 302, and the service providing apparatuses 303 and 304 via the network NW2. Further, as with the authentication server 302 and the service providing apparatuses 303 and 304, the authentication control apparatus 302-1 may communicate with the image forming apparatus 1101 and the biometric information reading device 1102 via the network NW2, the access control apparatus 301, the network NW1 such as the Internet, the firewall 1103, and the network NW3, for example.

Also, as illustrated in FIG. 18B, in the information processing system according to the sixth embodiment, the authentication control application 315 is added to the service applications 310 of the service providing system 300. The authentication control application 315 may be installed in the authentication control apparatus 302-1 and functions of the authentication control application 315 may be implemented by the authentication control apparatus 302-1.

Also, as illustrated in FIG. 18C, the authentication control application 315 includes a function determining unit 3151 and the biometric information storing unit 3152. The biometric information storing unit 3152 may store the information for determining a function to be executed based on biometric information identification information as illustrated in FIG. 9B, for example. The function determining unit 3151 uses a biometric information ID passed from the biometric authentication application 312 as a key to search the information stored in the biometric information storing unit 3152 and extract/determine a corresponding “function to be executed.”

In the following, referring to FIG. 19, operations from biometric authentication to execution of a function in the information processing system according to the sixth embodiment that vary from the operations executed in the information processing system according to the fifth embodiment are described.

In step S612 (biometric authentication) of FIG. 19, the biometric authentication unit 3121 of the biometric authentication application 312 transmits information (return values) obtained from searching information stored in the biometric information storing unit 3122 (see FIG. 9A) to the function determining unit 3121 of the authentication control application 315. In the case where the authentication result included in the result values is successful authentication (authentication OK); namely, when a match is found from the search, the function determining unit 3151 performs the following operations. That is, the function determining unit 5131 uses the “biometric information ID” included in the return values as a key to search the biometric information stored in the biometric information storing unit 3152 (step S612-1 “biometric information ID search”). The function determining unit 3151 extracts and determines corresponding “user information” and “function to be executed” stored in association with the “biometric information ID” in the biometric information ID storing unit 3152 and communicates the determined “user information” and “function to be executed” and the authentication result to the session management unit 324.

In turn, the session management unit 324 communicates the “authentication result,” “user information,” and “function to be executed” to the biometric information reading device control unit 1016 via the service request unit 1015. In turn, the biometric information reading device control unit 1016 allows the relevant user to use the image forming apparatus 1101 and sends an execution request to have the determined function executed to the execution command unit 1017 (step S613 “execution command of function to be executed”). In turn, the execution command unit 1017 directs an application of the image forming apparatus 1101 to execute the “function to be executed” (step S614 “execution command of function to be executed”). In this way, a function unit of image forming apparatus 1101 (e.g., scanner 101 or plotter 102 of FIG. 2 in the case where the image forming apparatus 1101 has a configuration similar to that of the image forming apparatus 1) may be prompted to execute the “function to be executed.”

On the other hand, in the case where the result of the biometric authentication (step S612) is authentication failure (authentication NG); namely, when no match is found, the biometric authentication unit 3121 of the biometric authentication application 312 merely communicates the authentication result to the authentication control unit 315. In turn, the authentication control unit 315 communicates the authentication result to the image forming apparatus 1101 via the session management unit 324. At the image forming apparatus 1101, the authentication result is passed from the service request unit 1015 to the biometric information reading device control unit 1016. In this case, steps S612-1, S613, and S614 are not executed, and instead, the biometric information reading device control unit 1016 notifies the user of the authentication result.

Note that in the information processing system of the sixth embodiment, biometric information storing unit 3122 of the biometric authentication application 312 corresponds to an exemplary embodiment of an authentication information managing unit, the biometric authentication unit 3121 corresponds to an exemplary embodiment of an authentication unit. Also, the biometric information ID storing unit 3152 of the authentication control application 315 corresponds to an exemplary embodiment of an authentication information identification information managing unit, and the function determining unit 3151 corresponds to an exemplary embodiment of a function determining unit. Also, the execution command unit 1017 corresponds to an exemplary embodiment of an execution command unit. Also, in a case where the image forming apparatus 1101 has a configuration similar to that of the image forming apparatus 1, the scanner 101 and the plotter 102 correspond to exemplary embodiments of a function unit. Also, the biometric information reading device control unit 1016 corresponds to an exemplary embodiment of an authentication information obtaining unit.

### Seventh Embodiment

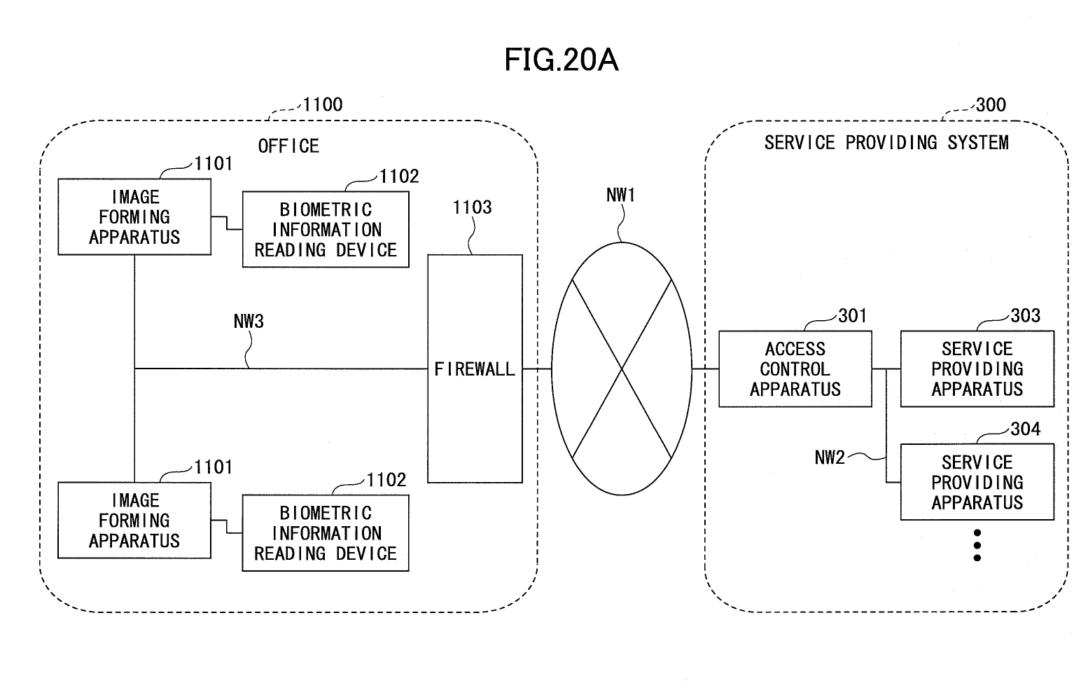

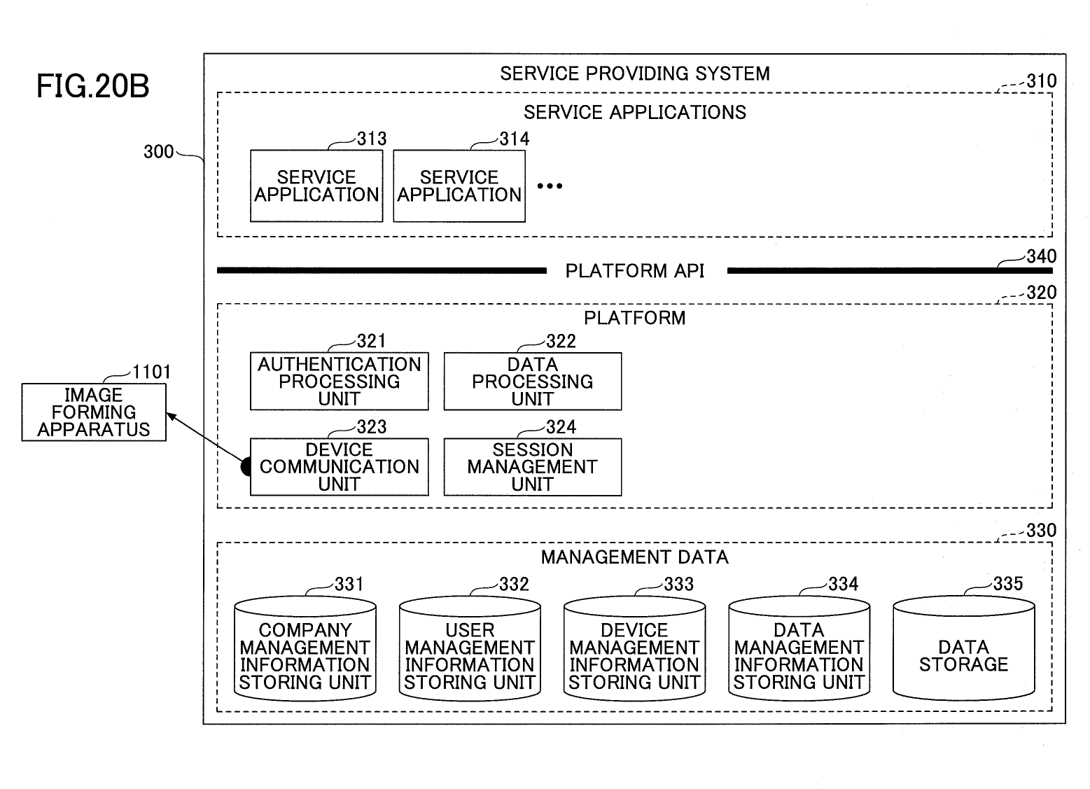

In the following, an information processing system according to a seventh embodiment of the present invention is described with reference to FIGS. 20A-22.

Note that the information processing system according to the seventh embodiment has features and functions similar to the information processing system according to the fourth embodiment. Therefore, identical features and functions are given the same reference numerals and their descriptions are omitted.

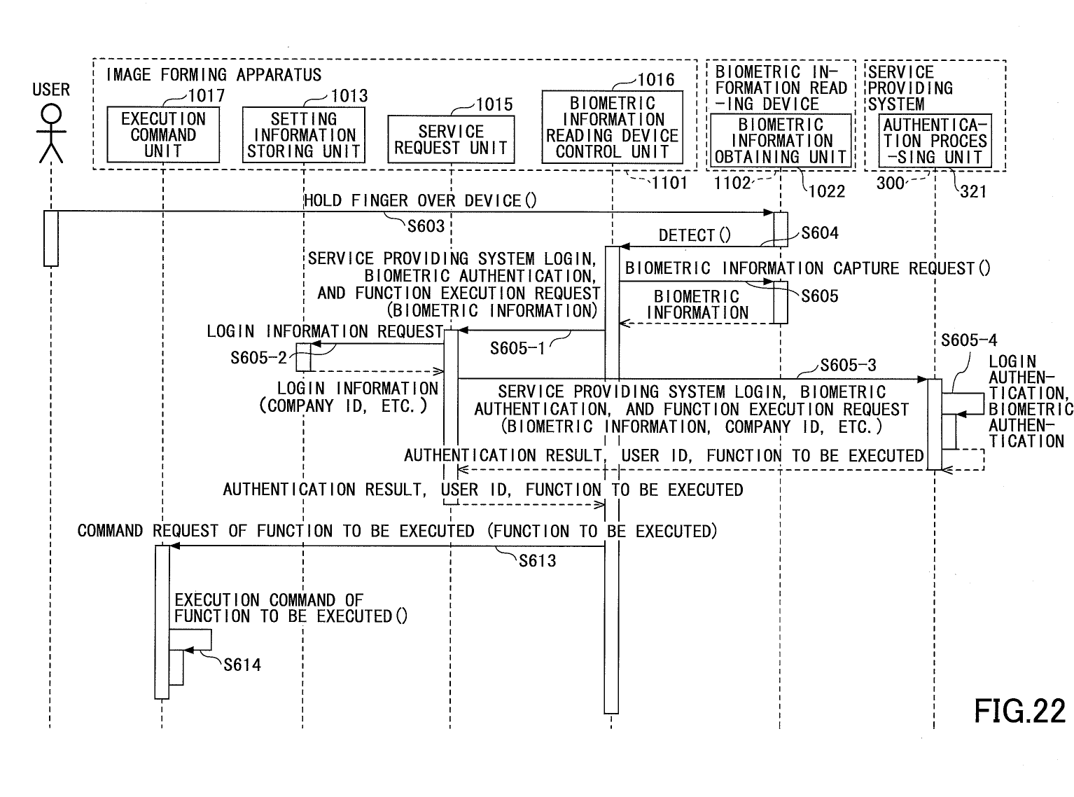

The information processing system according to the seventh embodiment differs from the information processing system according to the fourth embodiment in the following manner. In the information processing system according to the fourth embodiment, as illustrated in FIG. 15, login authentication (step S608) and biometric authentication (step S612) are separately performed. That is, the login authentication and the biometric authentication are separately execute by the authentication processing unit 321 and the biometric authentication application 312, respectively. On the other hand, in the information processing system according to the seventh embodiment, these authentication processes are executed as one process by the authentication processing unit 321 (see step S605-4 of FIG. 22).

As can be appreciated by comparing the sequence chart of FIG. 15 with the sequence chart of FIG. 22, in the information processing system according to the seventh embodiment, operations from biometric authentication to execution of a function may be simplified. Further, as is described below with reference to FIG. 20B, the authentication processing unit 321 is included in the platform 320. Thus, for example, aspects of the present embodiment are applicable to a case where the “function to be executed” determined in step S605-4 (“login authentication, biometric authentication”) corresponds to a function of an application included in the service application 314 of the service providing system 300. In the following, the information processing system of the seventh embodiment is described in greater detail with reference to the drawings.

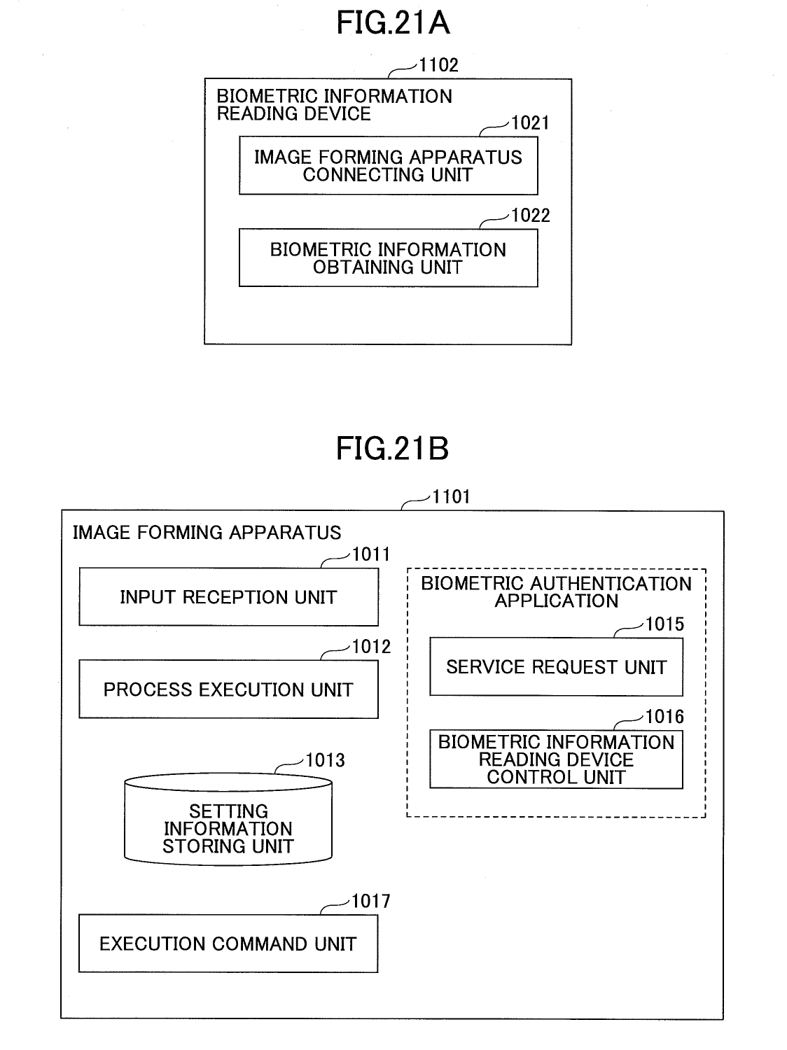

In the information processing system according to the seventh embodiment, the function of the biometric authentication server 302 is included in the access control apparatus 301 so that the biometric authentication server 302 is not provided as a separate apparatus within the service providing system 300 (see FIG. 20A). Also, in the information processing system according to the seventh embodiment, the function of the biometric authentication application 312 is included in the authentication processing unit 321 so that the biometric authentication application 312 is not separately provided within the service providing system 300 (see FIG. 20B). Further, the function of the login request unit 1014 is included in the service request unit 1015 so that the login request unit 1014 is not separately provided within the image forming apparatus 1101 (see FIG. 21B).

In the following, a process flow of operations from biometric authentication to execution of a function performed in the information processing system according to the seventh embodiment is described with reference to FIG. 22.

As illustrated in FIG. 22, first, the user holds, for example, a finger or a palm over the biometric information reading device 1102 connected to the image forming apparatus 1101 (step S603). Upon detecting the finger or the palm, the biometric information obtaining unit 1022 of the biometric information reading device 1102 sends a notification of the detection to the biometric information reading device control unit 1016 of the image forming apparatus 1101 (step S604 “detect”). In turn, the biometric information reading device control unit 1016 issues a biometric information capture request to obtain biometric information of the detected finger or palm, for example (step S605). In response, the biometric information obtaining unit 1022 captures biometric information (e.g., finger/palm vein pattern, fingerprint, palm print) of the detected finger or palm and returns the captured biometric information to the biometric information reading device control unit 1016 of the image forming apparatus 1101.

Upon receiving the obtained biometric information from the biometric information obtaining unit 1022, the biometric information reading device control unit 1016 of the image forming apparatus 1101 performs the following operations with respect to the service request unit 1015. The biometric information reading device control unit 1016 includes the obtained biometric information in a service providing system login, biometric authentication, and function execution request and sends the request to the service request unit 1015 (step S605-1). In turn, the service request unit 1015 reads login information (company code (company ID), etc.) pre-registered in the setting information storing unit 1013 (step S605-2 “login information request”). The service request unit 1015 then includes the read login information and the biometric information obtained in step S605-1 in the service providing system login, biometric authentication, and function execution request and sends the request to the authentication processing unit 321 of the service providing system 300 (step S605-3).

In turn, the authentication processing unit 321 of the service providing system 300 performs login authentication and biometric authentication (step S605-4). The login authentication and biometric authentication of step S605-4 may be performed by the authentication processing unit 321 in a manner similar to step S608 (authentication) and step S612 (biometric authentication) described above. Note, however, that although a token is generated in step S608 of FIG. 15 in the case where authentication is successful, such a token does not need to be generated in information processing system according to the seventh embodiment because login authentication to login to the service providing system 300 and the biometric authentication including determination of a “function to be executed” are performed in one process.

If the result of the login authentication and biometric authentication (step S605-4) is “successful authentication,” the authentication processing unit 321 of the service providing system 300 returns the authentication result and corresponding “user information” and “function to be executed” associated with the biometric information received in step S604-3 to the service request unit 1015 of the image forming apparatus 1101. Note that “successful authentication” of the login authentication and biometric authentication refers to a case where login access to the service providing system 300 based on the login information is successful and biometric authentication based on the biometric information obtained in step S605 is successful. In such a case, the corresponding “user information” and “function to be executed” stored and managed in association with the biometric information by the authentication processing unit 321 may be obtained in the manner described above. Note in performing the login authentication and biometric authentication (step S605-4), the authentication processing unit 321 may use the company management information storing unit 331, the user management information storing unit 332, and the device management information storing unit 333 as necessary. In one particular embodiment, the user management information storing unit 332 may store information similar to the information for biometric authentication and determining a function to be executed illustrated in FIG. 6, and the authentication processing unit 321 may use such information upon performing biometric authentication.

The service request unit 1015 of the image forming apparatus 1101 sends the authentication result (including the “user information” and “function to be executed”) from the authentication processing unit 321 of the service providing system 300 to the biometric information reading device control unit 1016. The biometric information reading device control unit 1016 logs into the image forming apparatus 1101 using the received “user information” and communicates the received “function to be executed” to the execution command unit 1017 (step S613 “execution request of function to be executed”). Note that operations following step S613 may be identical to the operations performed in the information processing system according to the fourth embodiment so that their descriptions are omitted.

On the other hand, in the case where the result of the login authentication and biometric authentication (step S605-4) is authentication failure (authentication NG), the authentication processing unit 321 of the service providing system 300 merely returns the authentication result to the service request unit 1015 of the image forming apparatus 1101. In turn, the service request unit 1015 passes the authentication result to the biometric information reading device control unit 1016. In this case, steps S613 and S614 are not performed, and instead, the biometric information reading device control unit 1016 notifies the user of the image forming apparatus 1101 of the authentication result.

Note that in the information processing system according to the seventh embodiment, the authentication processing application 321 corresponds to an exemplary embodiment of a user authentication and function determination unit. Also, the execution command unit 1017 corresponds to an embodiment of an execution command unit. Also, in the case where the image forming apparatus 1101 has a configuration identical to that of the image forming apparatus 1 of FIG. 2, the scanner 101 and the plotter 102 correspond to exemplary embodiments of a function unit. Also, the biometric information reading device control unit 1016 corresponds to an exemplary embodiment of an authentication information obtaining unit.

### Eighth Embodiment

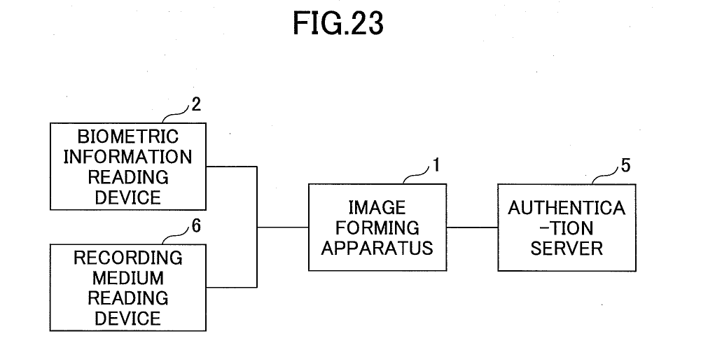

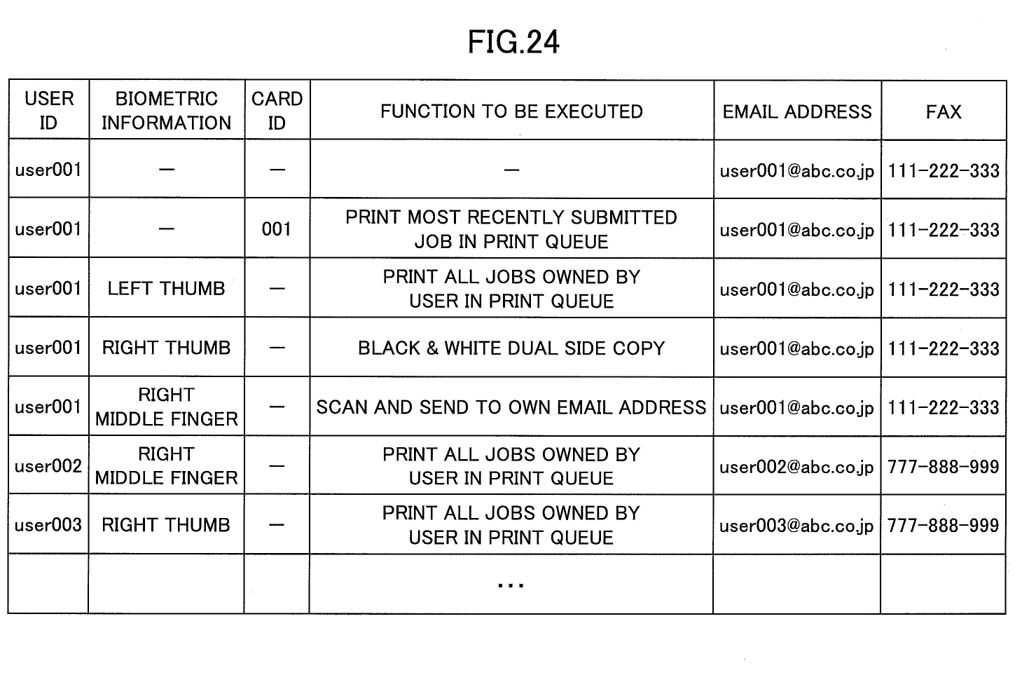

In the following, an information processing system according to an eighth embodiment of the present invention is described with reference to FIGS. 23 and 24.

The information processing system according to the eighth embodiment has features and functions substantially similar to those of the information processing system according to the first embodiment. Therefore, identical features, functions, and operations are given the same reference numerals and their descriptions are omitted.

Note that a user authentication method to be used is not limited to biometric authentication but may include other user authentication methods. For example, a user may directly input his user ID (and optionally a password) via the operating display unit 108 of FIG. 2 or input a card ID of an IC card via an IC card reader. In the information processing system according to the eighth embodiment, information items such as “function to be executed” are managed in association with such various forms of authentication information (authentication methods), and execution of a function is controlled based on the authentication method used to perform user authentication.

As illustrated in FIG. 23, the information processing system according to the eighth embodiment includes the image forming apparatus 1, the biometric information reading device 2, a recording medium reading device 6, and an authentication server 5. The image forming apparatus 1 and the authentication server 5 may be connected via an network similar to the network NW1 illustrated in FIG. 1, for example, so that they may establish communication with each other. The biometric information reading device 2 and the recording medium reading device 6 are connected to the image forming apparatus 1.

The image forming apparatus 1 may be a device such as a MFP, a copier, a scanner, a printer, a LP (laser printer), for example. At least one image forming apparatus 1 is included in the present system. The authentication server 5 is configured to perform various authentication processes according to various authentication methods such as biometric authentication, IC card authentication, and user ID authentication, for example. Note that at least one authentication server 5 is provided in the present system, and in some embodiments, a separate authentication server may be provided for each individual authentication method. The recording medium reading device 6 may be an IC card reader, for example, or some other device capable of reading information recorded in a recording medium. The biometric information reading device 2 may be identical to that used in the information processing system according to the first embodiment.

FIG. 24 is a table illustrating an exemplary data configuration of information used for biometric authentication and determining a function to be executed in the information processing system of FIG. 23.

Note that the third through seventh records listed in the table of FIG. 24 respectively correspond to the first through fifth records listed in the table of FIG. 6. Accordingly, operations performed in the information processing system of the eighth embodiment with respect to the biometric information stored in these records may be identical to the operations performed in the information processing system of the first embodiment so that overlapping descriptions thereof are omitted.

On the other hand, the first record of FIG. 24 relates to a case where user authentication is performed based on user ID information that is input to the image forming apparatus 1. Note that a corresponding “function to be executed” for this case is not set up in FIG. 24. This means that unlike operations executed with respect to the third through seventh records of FIG. 24, in the case where user ID information is input as authentication information, the image forming apparatus 1 does not perform operations for determining a function to be executed. Instead, the image forming apparatus 1 displays a normal menu screen. In turn, a user may select a desired function from the menu screen and prompt the image forming apparatus 1 to execute the desired function.

In the second record of FIG. 24, card ID “001” is set up instead of biometric information. The second record relates to a case where information stored in a recording medium such as an IC card is read by the recording medium reading device 6. If the read information matches the card ID “001” stored in the second record, a corresponding function to be execute “print most recently submitted job in print queue” stored in the second record in association with the card ID “001” is executed by the image forming apparatus 1 connected to the recording medium reading device 6.

In one aspect of the information processing system according to the eight embodiment, for example, a “function to be executed” may be controlled based on various types of authentication information such as card ID information and user ID information in addition to biometric information.

### Ninth Embodiment

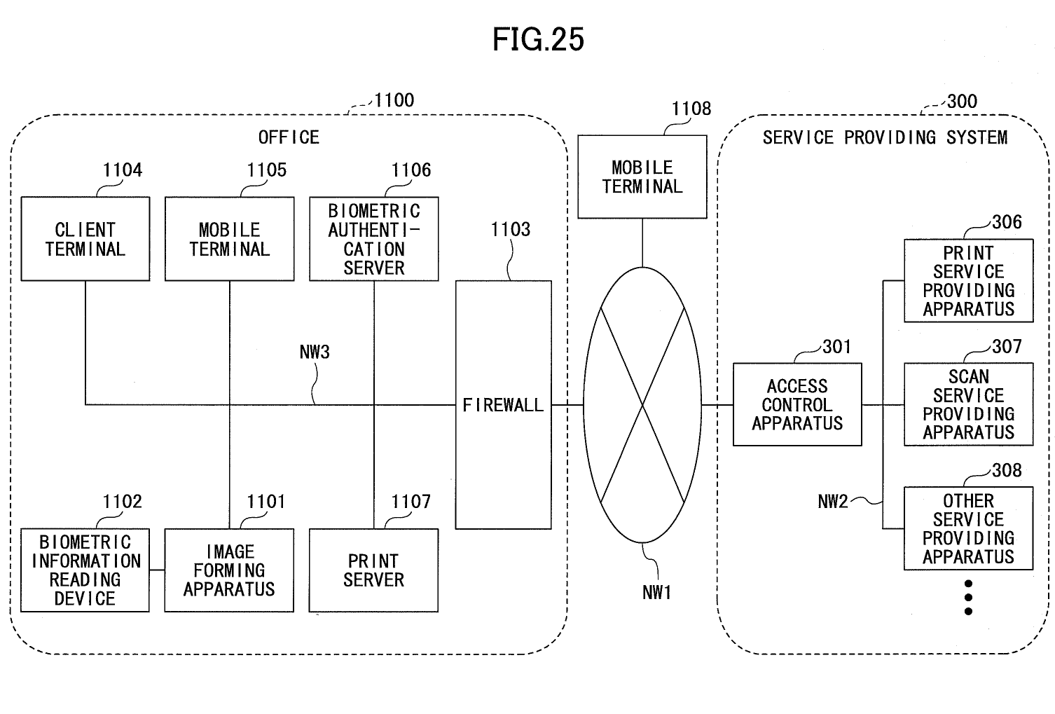

In the following, an information processing system according to a ninth embodiment of the present invention is described with reference to FIGS. 25-35.

The information processing system according to the ninth embodiment has features and functions substantially similar to those of the information processing system according to the fifth embodiment. Therefore, identical features, functions, and operations are given the same reference numerals and their descriptions are omitted.

As described above, in the information processing system according to the fifth embodiment, the biometric authentication application 312 is provided in the service providing system 300. On the other hand, as illustrated in FIG. 25, in the information processing system according to the ninth embodiment, a biometric authentication server 1106 is provided at the office 1100. Thus, in the information processing system according to the ninth embodiment, the biometric authentication performed by the biometric authentication application 312 of the service providing system 300 in the information processing system according to the fifth embodiment is performed by the biometric authentication server 1106 at the office 1100.

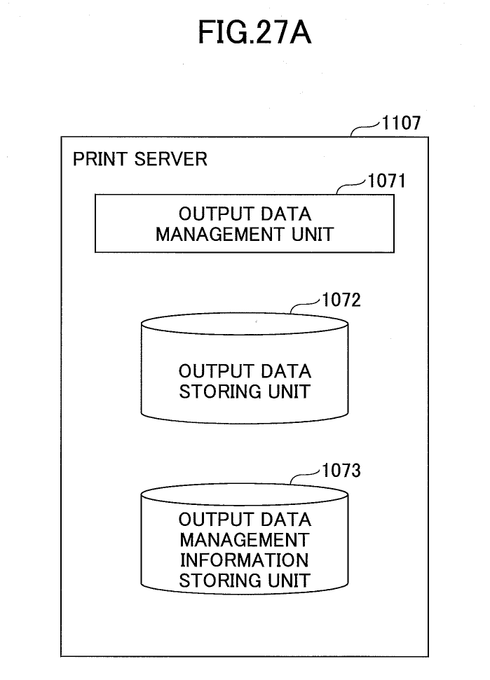

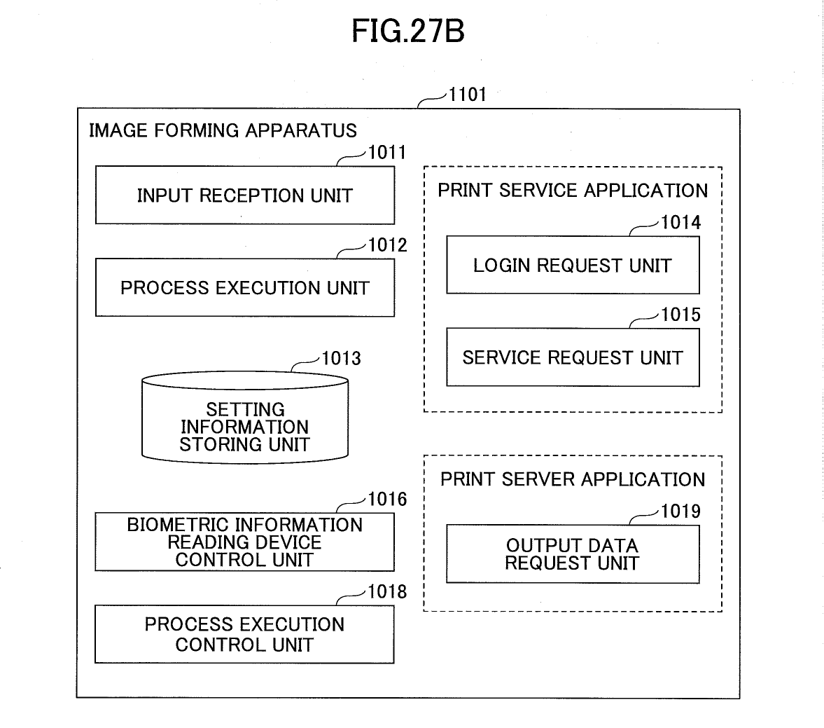

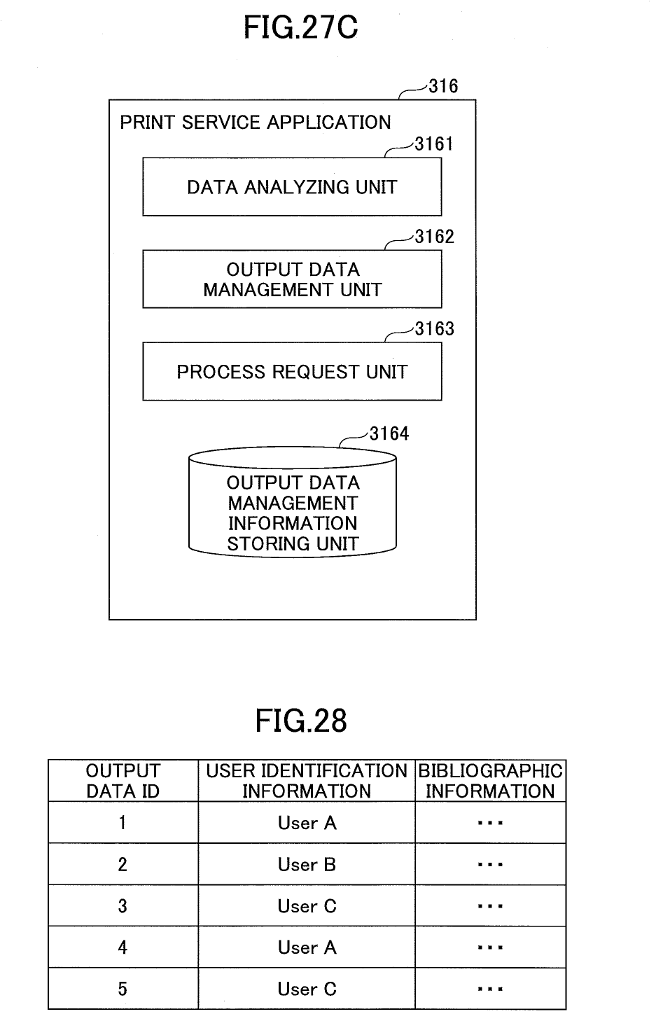

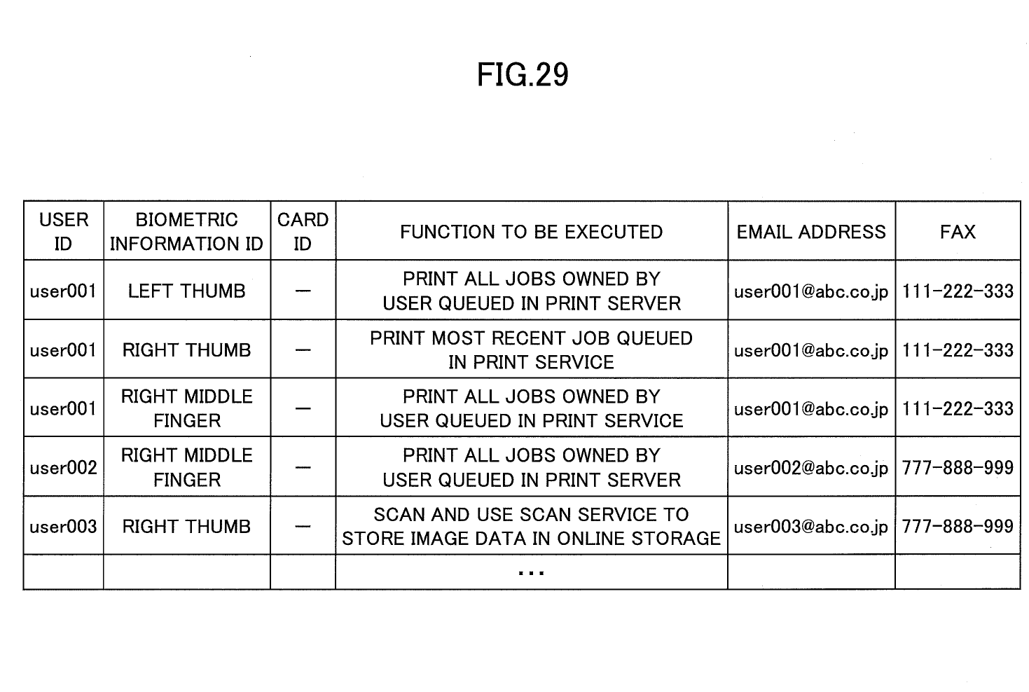

That is, the biometric authentication server 1106 at the office 1100 includes a biometric information storing unit that stores information similar to the information used for biometric authentication and determining a function to be executed stored in the biometric information storing unit 3122 of the biometric authentication application 312 of the fifth embodiment. Also, the biometric authentication server 1106 includes a biometric authentication unit that is configured to obtain “biometric information ID” by referring to the biometric information stored in the biometric information storing unit in a manner similar to the biometric information ID search performed by the biometric authentication unit 3121 of the biometric authentication application 312. The image processing apparatus 1101 includes a process execution control unit 1018 (see FIG. 27B) that is configured to use the obtained biometric information as a key to search information stored in the setting information storing unit 1013 (see FIG. 29) to determine a corresponding “function to be executed.”

Further, in the information processing system according to the ninth embodiment, a function provided by the service providing system 300 may be set up as a “function to be executed.” Thus, in the information processing system according to the ninth embodiment, a user at the office 1100 may perform authentication based on his/her own biometric information (e.g., finger vein pattern, fingerprint) using the biometric information reading device 1102. In turn, a corresponding “function to be executed” stored in association with the biometric information within the image forming apparatus 1101 may be determined at the image forming apparatus 1101. In the case where the determined “function to be executed” corresponds to a function of the service providing system 300, the function may be executed by the service providing system 300. In this case, the user may not necessarily have to perform input operations for logging into the service providing system 300, and instead, login information stored at the device making the login request may be automatically read and used in logging into the service providing system 300, for example.

In this way, the user at the office may only be required to provide biometric information by holding his/her finger over the biometric information reading device 1102, for example, to automatically execute a desired function. Further, the desired function to be executed may correspond to a function of the service providing system 300. According to an aspect of the present embodiment, user convenience may be improved in a large-scale information processing system including the information processing system within the office 1100 and the service providing system 300, for example, in which a wide range of functions are to be executed. In the following, the information processing system according to the ninth embodiment is described in greater detail with reference to the drawings.

FIG. 25 illustrates an exemplary overall configuration of the information processing system according to the ninth embodiment. In FIG. 25, one or more devices or apparatuses including the image forming apparatus 1101, the biometric information reading device 1102, a client terminal 1104, mobile terminals 1105 and 1108, the biometric authentication server 1106, a print server 1107, the access control apparatus 301, and service providing apparatuses including a print service providing apparatus 306, a scan service providing apparatus 307, and other service providing apparatus 308, for example, are connected to each other via a wired or wireless network such as the networks NW1, NW2, and NW3 so that they may establish communication with each other. Note that the information processing system illustrated in FIG. 25 is merely an illustrative example. Also, the access control apparatus 301, the print service providing apparatus 306, the scan service providing apparatus 307, and the other service providing apparatus 308 may be provided in plural numbers within the service providing system 300, or alternatively, two or more of the apparatuses 301-308 may be combined in one apparatus, for example. Further, some of the functions of the service providing system 300 may be provided at the office 1100 or vice versa. Also, some of the devices within the office 1100 may be connected to an external network outside the office 1100, for example.

In FIG. 25, the access control apparatus 301 corresponds to an information processing apparatus such as a personal computer (PC) or a server that manages operations for providing various services. The service providing apparatuses 306-308 may correspond to information processing apparatuses such as a PC or a server that provide services such as a print service, a scan service, or some other type of service. The client terminal 1104 corresponds to an information processing apparatus such as a PC that is used by a user, and mobile terminals 1105 and 1108 correspond to a portable terminal such as a mobile phone, a smart phone, or a tablet terminal used by the user. The image forming apparatus 1101 may be a MFP, a copier, a scanner, a printer, or a LP, for example.

The biometric authentication server 1106 may have a hardware configuration similar to that of the biometric authentication server 3 as illustrated in FIG. 3. The print server 1107 corresponds to an information processing apparatus such as a PC, a server, or a thin client that stores and provides print data. The biometric information reading device 1102 may have a configuration and function similar to the biometric information reading device 2 illustrated in FIG. 1. Note that one or more of the above apparatuses may be provided within the information processing system of the present embodiment.

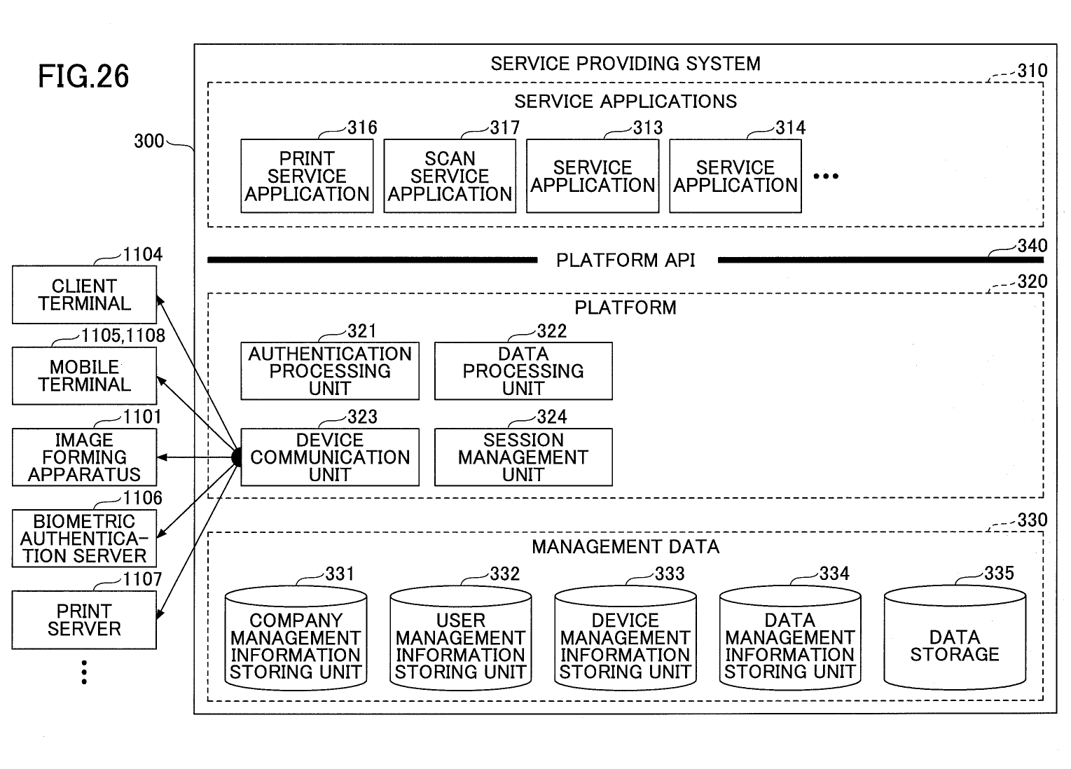

FIG. 26 illustrates an exemplary functional configuration of the service providing system 300 of the information processing system of FIG. 25. In FIG. 26, the service applications 310 include a print service application 316, a scan service application 317, and other service applications 313 and 314 corresponding to application programs that are configured to provide various services. The platform 320 includes common functions or basic functions that are used by the service applications 310. For example, the platform 320 may include the authentication processing unit 321, the data processing unit 322, the device communication unit 323, and the session management unit 324. The functions of these units are made public to the service applications 310 via a platform application programming interface (API) 340. In other words, the service applications 310 can use the functions of these units that are made public by the platform API 340.

The authentication processing unit 321 authenticates users of a device or an administrator terminal, for example. The session management unit 324 manages communication sessions between the service providing system 300 and devices. The device communication unit 323 controls communications established by devices. Note that the devices described above may include the client terminal 1104, the mobile terminals 1105 and 1108, the image forming apparatus 1101, the biometric authentication server 1106, and the print server 1107, for example.

The data processing unit 322 performs processes on data received from the devices and data stored in the data storage 335. For example, the data processing unit 322 may perform processes such as converting application data into print data and removing (deleting) stored data. The company management information storing unit 331 stores information on companies, organizations, groups, and so on related to services provided by the service providing system 300. The user management information storing unit 332 stores information on users of services provided by the service providing system 300. The device management information storing unit 333 stores information related to devices in a user system environment (e.g., an office) that use services provided by the service providing system 300. The data management information storing unit 334 stores information on data stored in the data storage 335. The data storage 335 stores, for example, data received from the devices, data received from other external apparatuses, and data processed based on the received data.

FIG. 27A illustrates an exemplary functional configuration of the print server 1107. FIG. 28 is a table illustrating an exemplary data configuration of output data management information stored in the print server 1107. The print server 1107 includes an output data management unit 1071, an output data storing unit 1072, and an output data management information storing unit 1073. The output data management unit 1071 of the print server 1107 may manage (store) output data into a data configuration as illustrated in FIG. 28, and execute processes such as providing a list of output data, for example. The output data storing unit 1072 stores output data. The output data management information storing unit 1073 stores information related to the output data.

FIG. 27B illustrates an exemplary functional configuration of the image forming apparatus 1101 of the information processing system of FIG. 25. In FIG. 27B, the image forming apparatus includes the input reception unit 1011, the process execution unit 1012, the setting information storing unit 1013, the login request unit 1014, the service request unit 1015, the biometric information reading device control unit 1016, a process execution control unit 1018, and an output data request unit 1019. The input reception unit 1011 receives, for example, user operations (e.g., touch operations) and inputs via an operations panel and a keyboard (not shown) of the image forming apparatus 1101. The process execution unit 1012 executes processes such as printing or displaying output data or scanning a document, for example. The setting information storing unit 1013 stores setting information required for using the service providing system 300. The biometric information reading device control unit controls the biometric information reading device 1102 to obtain biometric information. The process execution control unit 1018 prompts an apparatus or a function unit to execute a “function to be executed” based on information on the “function to be executed” obtained through biometric authentication by the biometric authentication server 1106. The login request unit 1014 sends a login request to the service providing system 300. The service requesting unit 1015 requests services of the service providing system 300. The output data request unit 1019 sends a print request to the print to have output data printed.

FIG. 27C illustrates an exemplary functional configuration of the print service application 316. In FIG. 27C, the print service application 316 includes a data analyzing unit 3161, an output data management unit 3162, a process request unit 3163, and an output data management information storing unit 3164. The data analyzing unit 3161 analyzes data received from an external source and determines required processes for providing a print service. The output data management unit 3162 manages output data and executes processes such as providing a list of output data. The process request unit 3163 requests processes by functions of the platform 320 that is made public by the platform API 340. The output data management information storing unit 3164 stores information relating to output data.

FIG. 29 is a table illustrating an exemplary data configuration of information used for determining a function to be executed based on biometric information identification information that is stored in the setting information storing unit 1013 of the image forming apparatus 1101.

Note that the information used for determining a function to be executed based on biometric information identification information illustrated in FIG. 29 is similar to the information illustrated in FIG. 9B that is used in the information processing system according to the second and fifth embodiments. However, in the second and fifth embodiments, the “function to be executed” corresponds to a function of the image forming apparatus (the image forming apparatus connected to the biometric information reading device to which a user inputs his/her biometric information). In contrast, as illustrated in FIG. 29, in the information processing system according to the ninth embodiment, the “function to be executed” may include a function of a device or apparatus other than the image forming apparatus 1101. Also, in the information used for determining a function to be executed based on biometric information identification information of FIG. 29, the name of a body part such as “left thumb” is used as the “biometric information ID” rather than a combination of a user ID and serial number as in FIG. 9B.

In the first record of FIG. 29, “print all jobs owned by user queued in print server” is stored as the corresponding “function to be executed.” This function involves using a function of the print server 1107 corresponding to a device other than the image forming apparatus 1101. In the second record of FIG. 29, “print most recent job queued in print service” is stored as the corresponding “function to be executed.” This function involves the use of a function of the print service providing apparatus 306 (i.e., the print service application 316).

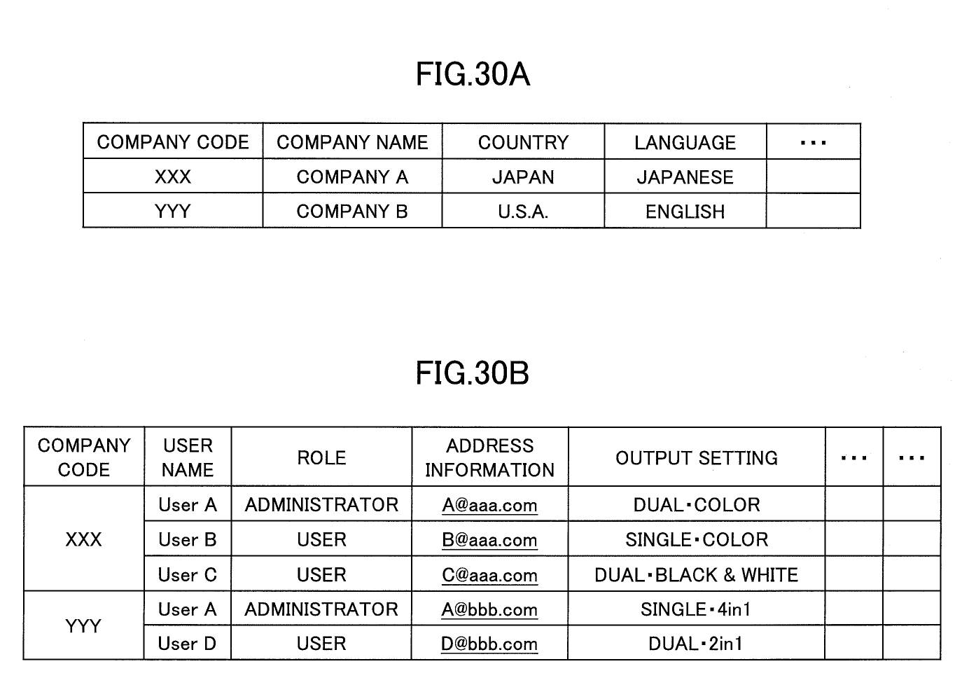

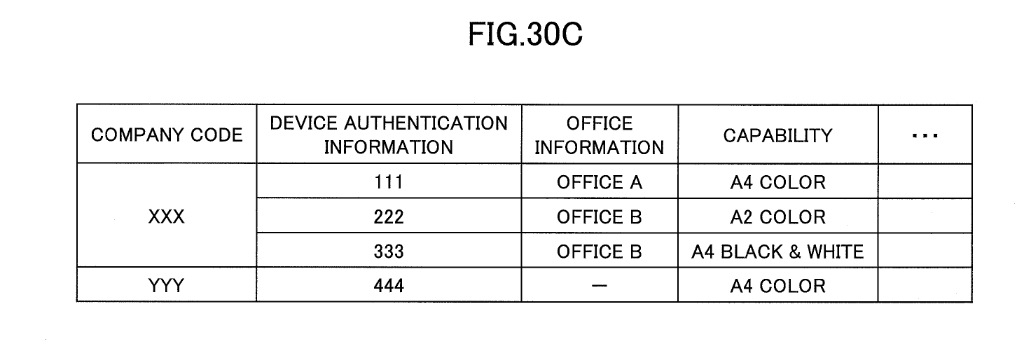

In the following, information stored in the company management information storing unit 331, the user management information storing unit 332, and the device management information storing unit 333 illustrated in FIG. 26 are described with reference to FIGS. 30A-30C.

FIG. 30A is a table illustrating an exemplary data configuration of company management information stored in the company management information storing unit 331. FIG. 16B is a table illustrating an exemplary data configuration of user management information stored in the user management information storing unit 332. FIG. 16C is a table illustrating an exemplary data configuration of device management information stored in the device management information storing unit 333.

In FIGS. 30A-30C, “company code” (company ID) corresponds to information for identifying a group such as a company or an organization. The company code is information that can identify a group of one or more users or devices. The company code is not limited to identifying a company, but may also identify contract information identifying a contract with a group of users or devices, for example. Note that the company code is unique information assigned to each group, and the information (records) of FIGS. 30A-30C are managed based on the company code.

In FIG. 30B, “user name” corresponds to information for identifying a user. In one example, a user ID may be used as the user name. In other examples, information for identifying an electronic medium owned by the user such as an IC card, a mobile phone, a tablet terminal, an electronic book terminal (e.g., card ID, device serial ID, phone number, profile information of terminal) may be used as the user name. Further, a combination of the above information may be used as the user name as well. Note that the user name managed under a given company code has to be unique within the given company code. However, the user name may overlap if their corresponding company codes are different.

In FIG. 30C, “device authentication information” corresponds to information for determining whether a device (e.g., image forming apparatus 1101) meets certain conditions. For example, the “device authentication information” may be an ID indicating that a certain application is installed in the device or a device number indicating the type of the device.

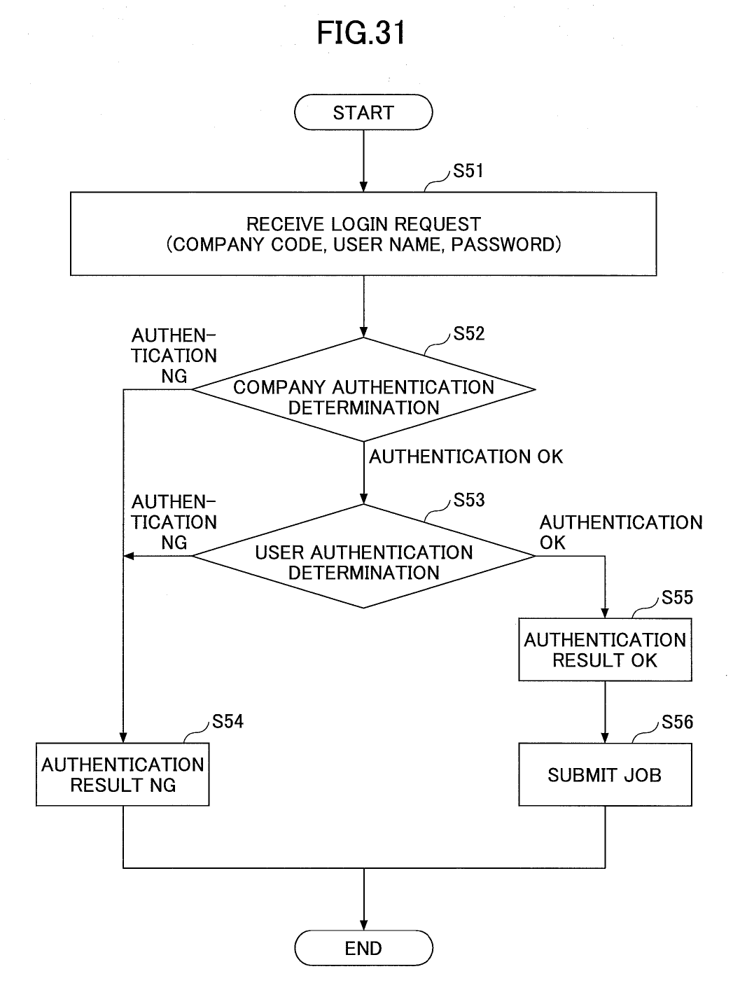

In the following, referring to FIG. 31, exemplary process operations that are performed after the biometric authentication and the executing function determination are described in a case where the client terminal 1104 or the mobile terminal 1105 or 1108 (simply referred to as “terminal” hereinafter) of the information processing system of FIG. 25 submits a job to the print service.

Note that although not shown, the terminal may be connected to or include a biometric information reading device in a manner similar to the image forming apparatus 1101. In this way, a “function to be executed” may be determined at the terminal based on biometric authentication performed by the biometric authentication server 1106. For example, the terminal may perform operations similar to the operations illustrated in FIG. 5A and the operations up to step S4-2 illustrated in FIG. 8 to determine the “function to be executed” based on biometric information obtained by the terminal. Note, however, that in this case, the “function to be executed” corresponds to a function for using the print service application 316 of the service providing system 300. Accordingly, login operations for logging into the service providing system 300 have to be performed before the terminal can submit a job to the print service application 316. FIG. 31 illustrates a process flow of operations for logging into the service providing system 300.

In FIG. 31, when a login request (including a company code, a user name, and a password) is sent from the terminal, the authentication processing unit 321 of the service providing system 300 receives the login request (step S51). Note that the company code, user name, and password (login information) included in the login request from the terminal may be input by the user operating the terminal. Alternatively, as with the fourth embodiment, a proxy user may be arranged, and a part or all of the login information may be stored beforehand so that required input operations by the user may be reduced or eliminated.

Upon receiving the login request, the authentication processing unit 321 of the service providing system 300 determines whether information matching the received company code is included in the company code stored (managed) in the company management information storing unit 331 (step S52 “company authentication determination”). If information matching the received company code is not found (authentication NG), the authentication result is determined to be authentication failure (step S54 “authentication result NG”). In this case, authentication failure as the authentication result is returned to the terminal corresponding to the login request origin.

On the other hand, in the case where company authentication (step S52) is successful (authentication OK), the authentication processing unit 321 determines whether information matching the received user information (user name and password) is included in the user information stored in association with the authenticated company code in the user management information storing unit 332 (step S53 “user authentication determination”). If information matching the received user information is not found, the user authentication result is determined to be authentication failure (authentication result NG). If information matching the received user information is found, the user authentication result is determined to be successful (S55 “authentication result OK”).

In the case where a successful authentication result is obtained, the service providing system 300 returns a login response to the terminal corresponding to the login request origin. Upon receiving the login response, the terminal requests the service providing system 300 to execute the “function to be executed” that was determined beforehand based on obtained biometric information as described above. Upon receiving such an execution request, the service providing system 300 selects a relevant service (print service in the present example) according to the execution request and submits a job. Note that job data (e.g., document data, image data) submitted in this manner may be processed by the data processing unit 322 as is necessary after which the processed job data may be stored at the data storage 335, for example.

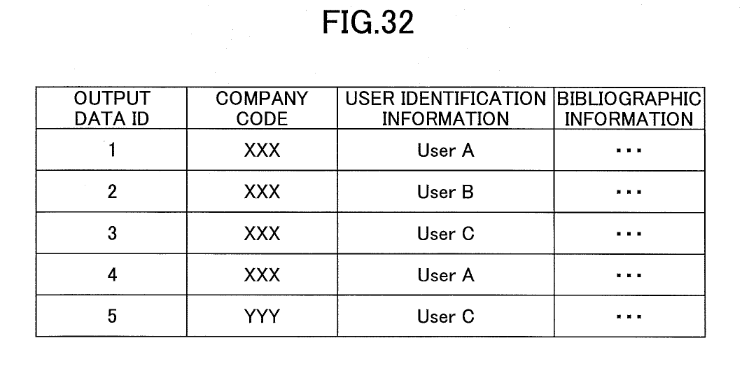

FIG. 32 is a table illustrating an exemplary data configuration of output management information stored in the output data management information storing unit 3164 of the print service application 316 in a case where a user selects a print service and submits a job as described above. Note that in FIG. 32, “output data ID” corresponds to identification information for identifying job data stored in the data storage 335.

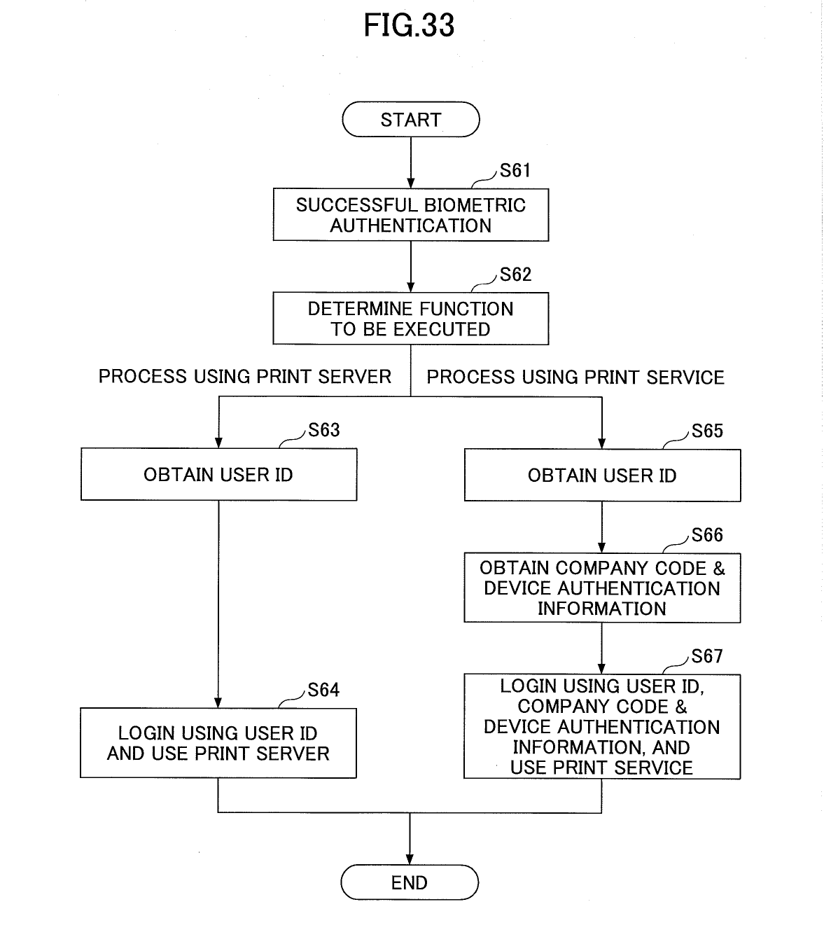

FIG. 33 is a flowchart illustrating exemplary process operations performed according to the “function to be executed” in the information processing system of FIG. 25.

The image forming apparatus 1101 or the terminal may perform operations from biometric authentication to determining a function to be executed as described above to authenticate biometric information (step S61 “successful biometric authentication”) and determine the function to be executed (step S62). For example, the image forming apparatus 1101 or the terminal may perform operations illustrated in FIG. 5A and operations up to step S4-2 of FIG. 8 to authenticate the biometric information and determine the “function to be executed.”

In the case where the determined “function to be executed” corresponds to a function of the print server 1107 (process using print server), the process proceeds to step S63. On the other hand, in the case where the “function to be executed” corresponds to a function of the print service application 316 (process using print service), the process proceeds to step S65.

In step S63, the image forming apparatus 1101 or the terminal obtains a user ID. Note that because the print server 1107 is a device located within the office 1100, the image forming apparatus 1101 or the terminal may log into the print server 1107 base on a user ID. The user ID may be obtained by referring to the information stored in setting information storing unit 1013 (see FIG. 29) and obtaining the user ID stored in association with the biometric information that has been successfully authenticated in step S61, for example.

The image forming apparatus 1101 or the terminal uses the obtained user ID to log into the print server 1107 and request the print server 1107 to execute the determined “function to be executed” (step S64). In this way, the print server 1107 may be used to execute a desired function.

On the other hand, in the case of using the print service application 316, in step S65, the image forming apparatus 1101 or the terminal obtains a user ID. The user ID may be obtained by referring to the information stored in setting information storing unit 1013 (see FIG. 29) and obtaining the user ID stored in association with the biometric information that has been successfully authenticated in step S61, for example.

Then, in step S66, the image forming apparatus 1101 or terminal obtains additional login information such as company code and device authentication information. The print service application 316 is included in the service providing system 300 established at an organization that provides cloud services. Thus, the image forming apparatus 1101 is required to provide company code and device authentication information as login information in addition to the user ID in order to log into the print service application 316. On the other hand, as illustrated in FIG. 31, the terminal does not need to provide device authentication information so that it may simply obtain company code as login information.

The company code and device authentication information may be stored in the setting information storing unit 1013 arranged within the image forming apparatus 1101 (see FIG. 27B). Thus, in the case where the image forming apparatus 1101 corresponds to the login request origin, the image forming apparatus 1101 may simply retrieve and use the company code and device authentication information from the setting information storing unit 1013. In the case where the terminal corresponds to the login request origin, the user of the terminal may directly input the company code, for example. Alternatively, a proxy user may be provided and a part or all of required login information may be stored within the terminal beforehand so that required user input operations may be reduced or eliminated, for example.

The image forming apparatus 1101 or the terminal uses the login information obtained in steps S65 and S66 to log into the service providing system 300 and requests the print service application 316 to execute the determined “function to be executed” (step S67). In this way, the print service application 316 may be used to execute a desired function.

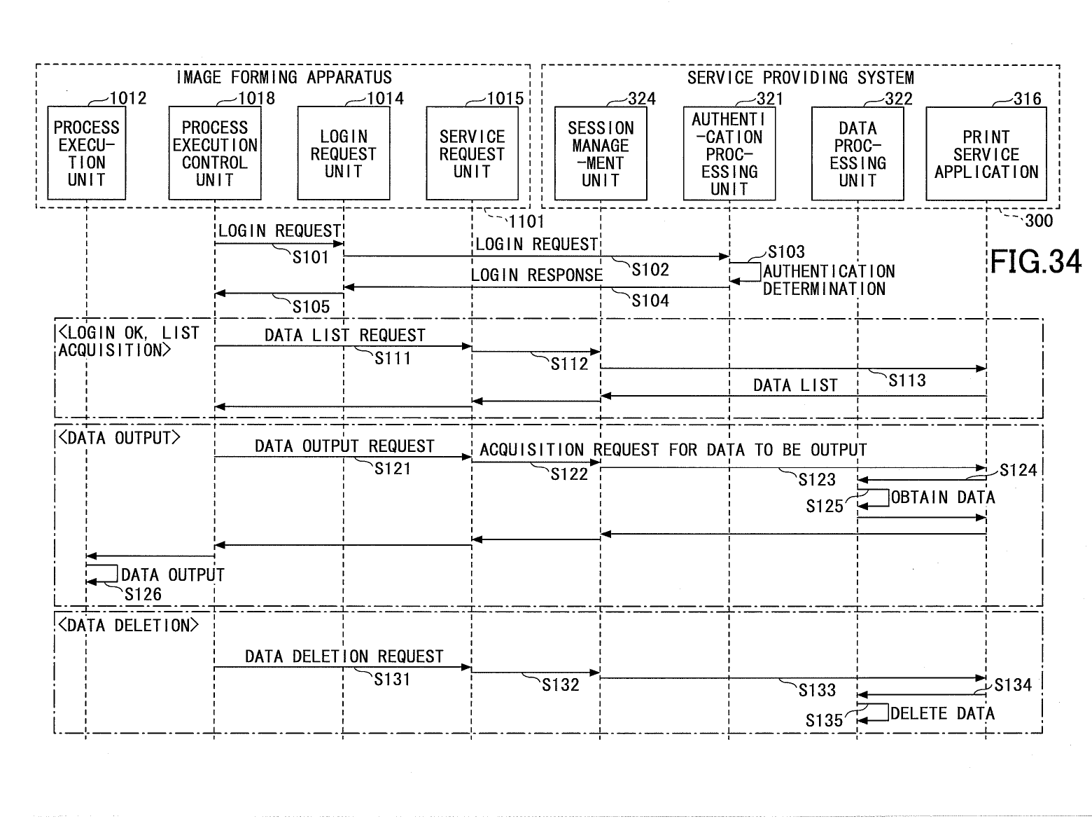

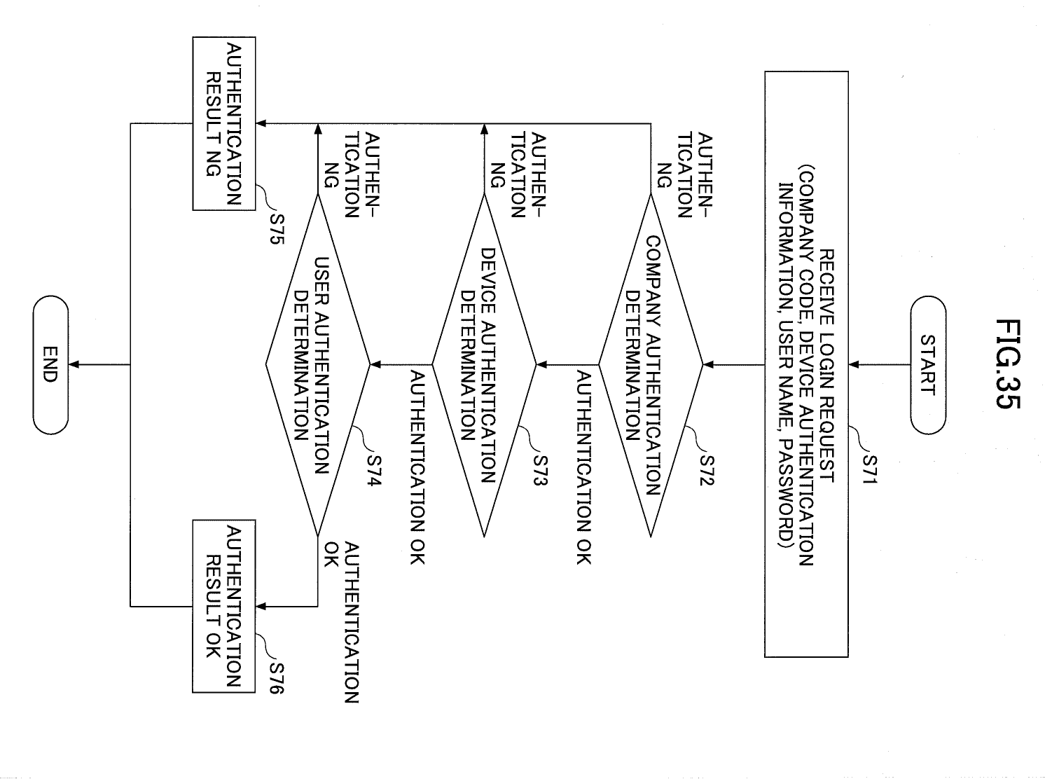

In the following, referring to FIG. 34, exemplary process operations performed after biometric authentication and determining a function to be executed are described in a case where the image forming apparatus 1101 uses the print service application 316 to execute the determined function. That is, FIG. 34 illustrates a specific example of operations performed in step S67 of FIG. 33.

In steps S101 and S102 of FIG. 34, the process execution control unit 1018 of the image forming apparatus 1101 sends a login request to the authentication processing unit 321 via the login request unit 1014. In turn, the authentication processing unit 321 performs authentication determination (step S103), and returns the result of the authentication (steps S104 and S105 “login response”). The authentication determination process is described in detail below with reference to FIG. 35.

In a case where the result of the above authentication determination is successful authentication (login OK) and the “function to be executed” determined based on the obtained biometric information in the above described operations corresponds to “list acquisition,” steps S111 to S113 are executed. Note that “list acquisition” refers to a function for obtaining a list of output data (e.g., document data, image data) stored in the data storage 335 that are included in the output data managed by the output data management unit 2162 of the print service application 312.

In step S111, the process execution control unit 1018 of the image forming apparatus 1101 sends a data list request to the service providing system 300 via the service request unit 1015 (steps S111, S112, and S113). The data list request is transmitted to the print service application 316 via the session management unit 324. Note that by transmitting the login request via the session management unit 324, the session management unit 324 may perform session confirmation by confirming that the token (e.g., cookie) generated in step S103 is included in the login request. The session confirmation using such a token may be identical to that described above with reference to FIG. 15 so that descriptions thereof are omitted.

Upon receiving the login request, the output data management unit 3162 of the print service application 316 executes data list acquisition according to the data list request. That is, the output data management unit 3162 extracts a list of output data associated with the user ID included in the login request of step S101 from data stored in the data storage 335 via the data processing unit 322 of the platform 320. Then, the output data management unit 3162 returns the obtained data list to the image forming apparatus 1101 via the session management unit 324. In turn, the service request unit 1015 of the image forming apparatus 1101 receives the data list and displays the data list at an operating display unit (operation panel), for example, so that the user may view the data list.

In a case where the result of the above authentication determination is successful authentication (login OK) and the “function to be executed” determined based on the obtained biometric information in the above described operations corresponds to “data output,” steps S121 to S126 are executed. Note that “data output” in this case refers to a function for selecting specific data designated in the “function to be executed” from the data list obtained through steps S111-S113 and outputting (e.g., printing) the selected data. For example, in the second record of FIG. 29, “print most recent job queued in print service” is set up as the corresponding “function to be executed.” In this case, the “most recent job” may be selected from the obtained data list and output.

In step S121, the process execution control unit 1018 of the image forming apparatus 1101 sends a data output request to have the selected data output to the service request unit 1015. In turn, the service request unit 1015 sends an output data acquisition request to the print service application 316 of the service providing system 300 via the session management unit 324 (steps S122 and S123).

In turn, the output data management unit 3162 of the print service application 316 reads the corresponding output data from data stored in the data storage 335 via the data processing unit 322 of the platform 320 (steps S124 and S125). Then, the output data management unit 3162 returns the obtained data to the image forming apparatus 1101 corresponding to the data output request origin via the session management unit 324.

In turn, the process execution control unit 1018 of the image forming apparatus 1101 receives the data via the service request unit 1015 and prompts the process execution unit 1012 to output (print) the received data (step S126).

In a case where the result of the above authentication determination is successful authentication (login OK) and the “function to be executed” determined based on the obtained biometric information in the above described operations corresponds to “data deletion,” steps S131 to S135 are executed. Note that “data deletion” in this case refers to a function for selecting specific data designated by the “function to be executed” from the data list obtained in steps S111-S113 and deleting the selected data from the data storage 335.

In step S131, the process execution control unit 1018 of the image forming apparatus 1101 sends a data deletion request to have the selected data deleted to the service request unit 1015. In turn, the service requests unit 1015 sends the data deletion request to the print service application 316 of the service providing system 300 via the session management unit 324 (steps S132 and S133).

Upon receiving the data deletion request, the output data management unit 3162 of the print service application 316 deletes the corresponding data from the data storage 335 via the data processing unit 322 of the platform 320 (steps S134 and S135).

Note that although operations for executing a function using a service provided by the print service application 316 are described above as an illustrative example, similar operations may be performed to execute a function using a service provided by the print server 1107, for example. However, because the print server 1107 is arranged within the office 1100 and a process corresponding to the function to be executed is executed within the office 1101, login and session confirmation operations may be omitted in this case. Also, in the case of using the print server 1107, the output data request unit 19 (see FIG. 27B) of the image forming apparatus 1101 may be used instead of the login request unit 1014 and the service request unit 1015.

Also, similar operations may be performed to execute a function using a service provided by the scan service application 317 instead of the print service application 316 (see e.g., fifth record of FIG. 29). In this case, the process execution control unit 1012 may be used to scan a document and store the scanned image data in an online storage using the a scan service provided by the scan service application 317. For example, operations similar to step S101-S105 of FIG. 34 may be performed to log into the service providing system 300 after which the scanned image data may be sent to the scan service application 317 of the service providing system 300 along with a request to have the scanned image data transferred and stored in the online storage.

In the following, referring to FIG. 35, an exemplary flow of authentication operations for logging into the service providing system 300 from the image forming apparatus 1101 in the information processing system of FIG. 25 is described. FIG. 35 illustrates a specific example of operations for executing step S103 (authentication determination) of FIG. 34.

Note that although the image forming apparatus 1101 corresponds to the login request origin in the following example, the image forming apparatus 1101 may be replaced by some other type of output device such as a projector as is described in detail below.

In step S71 of FIG. 35, the authentication processing unit 321 of the service providing system 300 receives a login request (including a company code, device authentication information, a user name, and a password) from the image forming apparatus 1101 via a network, for example.

In turn, in step S72, the authentication processing unit 321 determines whether information matching the company code included in the received login request is included in the company code stored in the company management information storing unit 331 (company authentication determination). If information matching the received company code is not found (company authentication failure), the authentication is determined to be authentication failure (authentication NG).

If the received company code is successfully authenticated (company authentication success (authentication OK)), the authentication processing unit 321 determines whether information matching the received device authentication information is included in the device authentication information managed in association with the authenticated company code of the device information stored in the device management information storing unit 333 (step S73 “device authentication determination”). If the information matching the received device authentication information is not found, the authentication result is determined to be authentication failure (authentication NG).

If the received device authentication information is successfully authenticated (device authentication success (authentication OK)), the authentication processing unit 321 determines whether information matching the received user information (user name and password) is included in the user information stored in association with the authenticated company code in the user management information storing unit 332 (step S74 “user authentication determination”). If information matching the received user information is not found, the user authentication result is determined to be authentication failure (step S75 “authentication result NG”). If the received user information is successfully authenticated, the user authentication result is determined to be successful (step S76 “authentication result OK”).

Note that in the information processing system according to the ninth embodiment, the biometric information storing unit of the biometric authentication server 1106 corresponds to an exemplary embodiment of an authentication information managing unit, and the biometric authentication unit of the biometric authentication server 1106 corresponds to an exemplary embodiment of an authentication unit. Also, the setting information storing unit 1013 of the image forming apparatus 1101 corresponds to an exemplary embodiment of an authentication information identification information storing unit, and the process execution control unit 1018 corresponds to an exemplary embodiment of a function determining unit. The process execution control unit 1018 also corresponds to an exemplary embodiment of an execution command unit. Also, in the case where the image forming apparatus 1101 has a configuration identical to that of the image forming apparatus 1 of FIG. 2, the scanner 101 and the plotter 102 correspond to exemplary embodiments of a function unit. Also, the biometric information reading device control unit 1016 corresponds to an exemplary embodiment of an authentication information obtaining unit.

### Tenth Embodiment

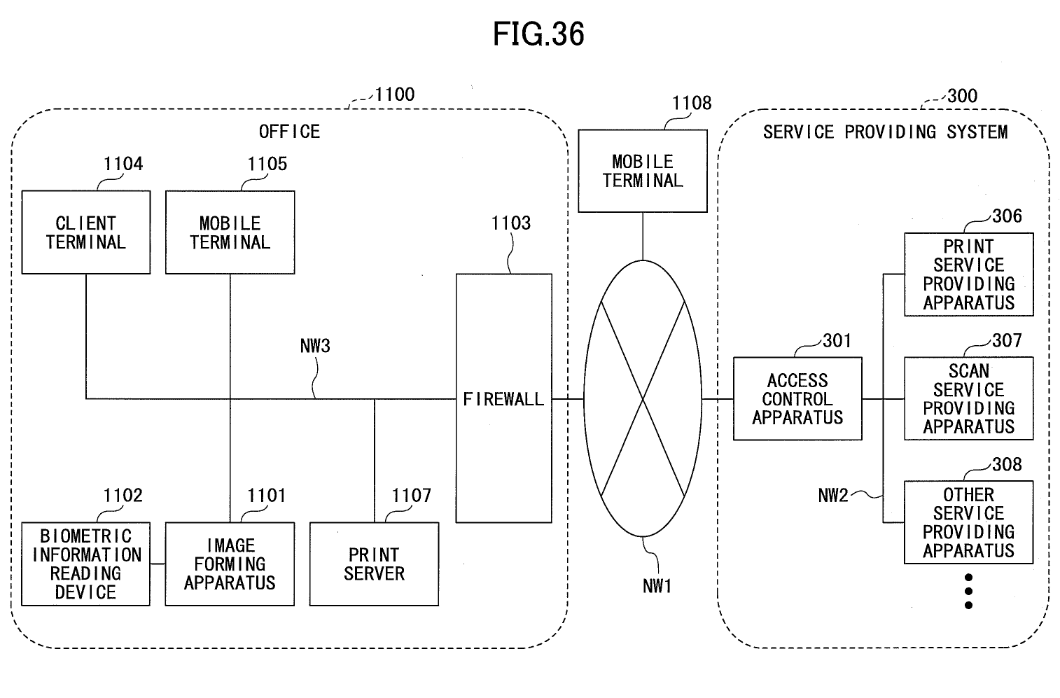

In the following, an information processing system according to a tenth embodiment of the present invention is described with reference to FIGS. 36-39D.

Note that the information processing system according to the tenth embodiment has features and functions similar to the information processing system according to the ninth embodiment. Therefore, identical features and functions are given the same reference numerals and their descriptions are omitted.

The information processing system according to the tenth embodiment differs from the information processing system according to the ninth embodiment in the following manner.

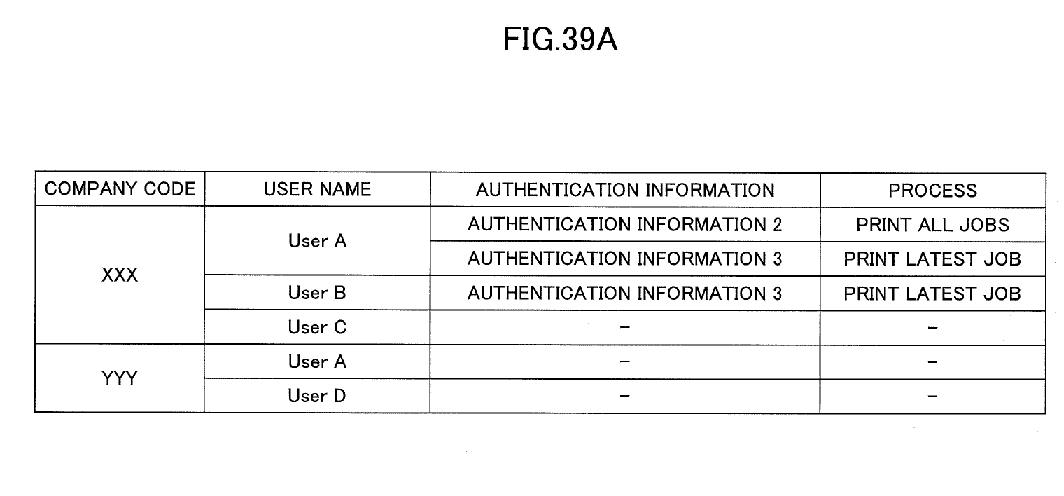

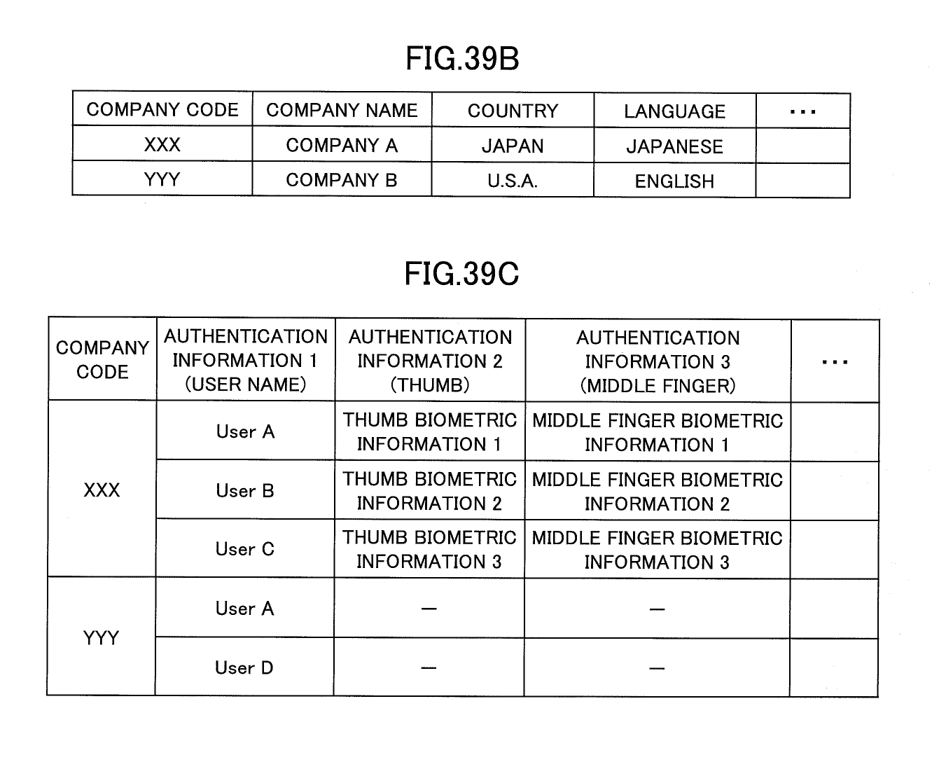

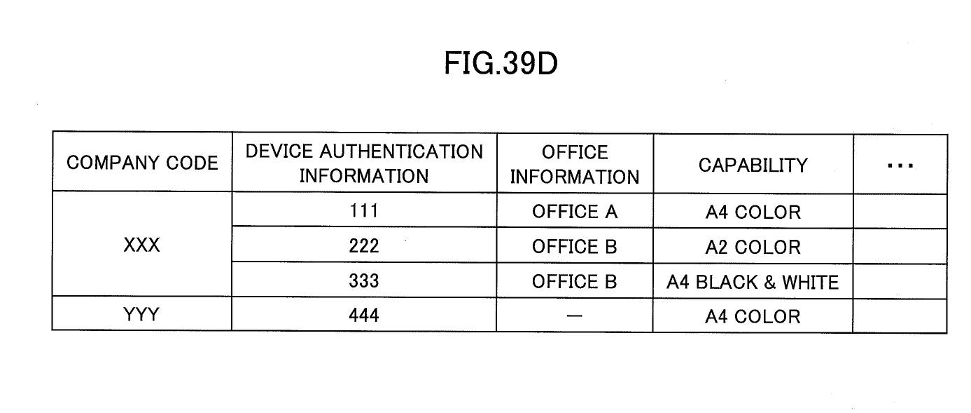

In the information processing system according to the ninth embodiment, the image forming apparatus 1101 determines a “function to be executed” based on an authentication result of biometric authentication performed by the biometric authentication server 1106. In contrast, in the information processing system according to the tenth embodiment, the authentication processing unit 321 of the service providing system 300 uses biometric information of a user obtained by the biometric information reading device 1102 and received via the image forming apparatus 1101 as a key to search biometric information included in user management information as illustrate in FIG. 39C. That is, the authentication processing unit 321 searches through “thumb biometric information 1,” “thumb biometric information 2,” “thumb biometric information 3,” “middle finger biometric information 1,” “middle finger biometric information 2,” “middle finger biometric information 3,” and so on to find information matching the key biometric information.

For example, in a case where “thumb biometric information 1” of FIG. 39C is found as biometric information matching the key biometric information, the authentication processing unit 321 may determine based on the user management information of FIG. 39C that the biometric information “thumb biometric information 1” corresponds to “authentication information 2 (thumb)” of user name (authentication information 1) “User A” of company code “XXX.” In turn, the authentication processing unit 321 communicates the information “authentication information 2 (thumb)” of user name (authentication information 1) “User A” of company code “XXX” to the print service application 316.

Note that the above information is communicated to the print service application 316 in the present example because the user management information of FIG. 39C is generated under the premise that the print service application 316 is to be used. However, applications of the present embodiment are not limited to such an example, and in other examples, user management information may be generated in contemplation of using the scan service application 317 as well. In such case, the user management information may include the information categories “company code,” “authentication information 1 (user name),” “authentication information 2 (thumb),” and “authentication information 3 (middle finger)” as illustrated in FIG. 39C as well as an additional information category “service type” under which a corresponding service to be used such as “print service” or “scan service” may be specified, for example. In this way, a corresponding service to be used may be determined with respect to each biometric information item.

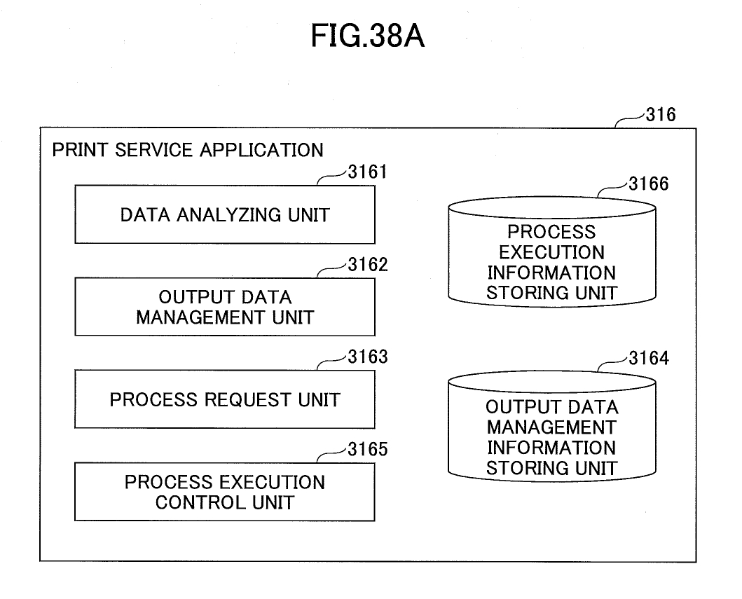

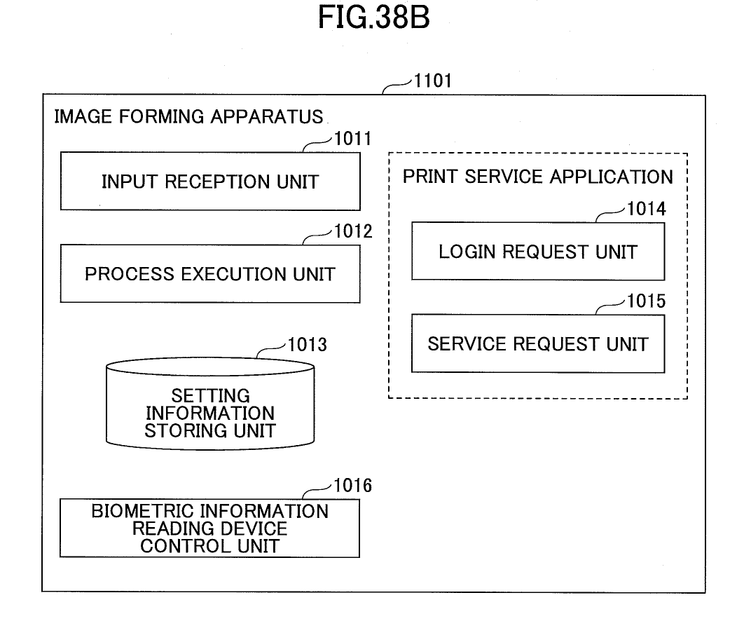

When the print service application 316 receives the above information “authentication information 2 (thumb)” of user name (authentication information 1) “User A” of company code “XXX” from the authentication processing unit 321, a process execution control unit 3165 (see FIG. 38A) of the print service application 316 uses the received information as a key to search process execution information as illustrated in FIG. 39A. Based on the received information “authentication information 2 (thumb)” of user name (authentication information 1) “User A” of company code “XXX,” the process execution control unit 3165 may determine that the first record of the process execution information of FIG. 39A corresponds to a match for the received information and that “print all jobs” corresponds to the process (function) to be executed.

In turn, the process execution control unit 3165 of the print service application 316 extracts all output data stored in association with the company code “XXX,” the user name (authentication information 1) “User A,” from the data storage 335, and sends an output request including the extracted output data to the image forming apparatus 1101 corresponding to the sender of the biometric information. In turn, the process execution unit 1012 of the image forming apparatus 1101 may output (print) the output data.

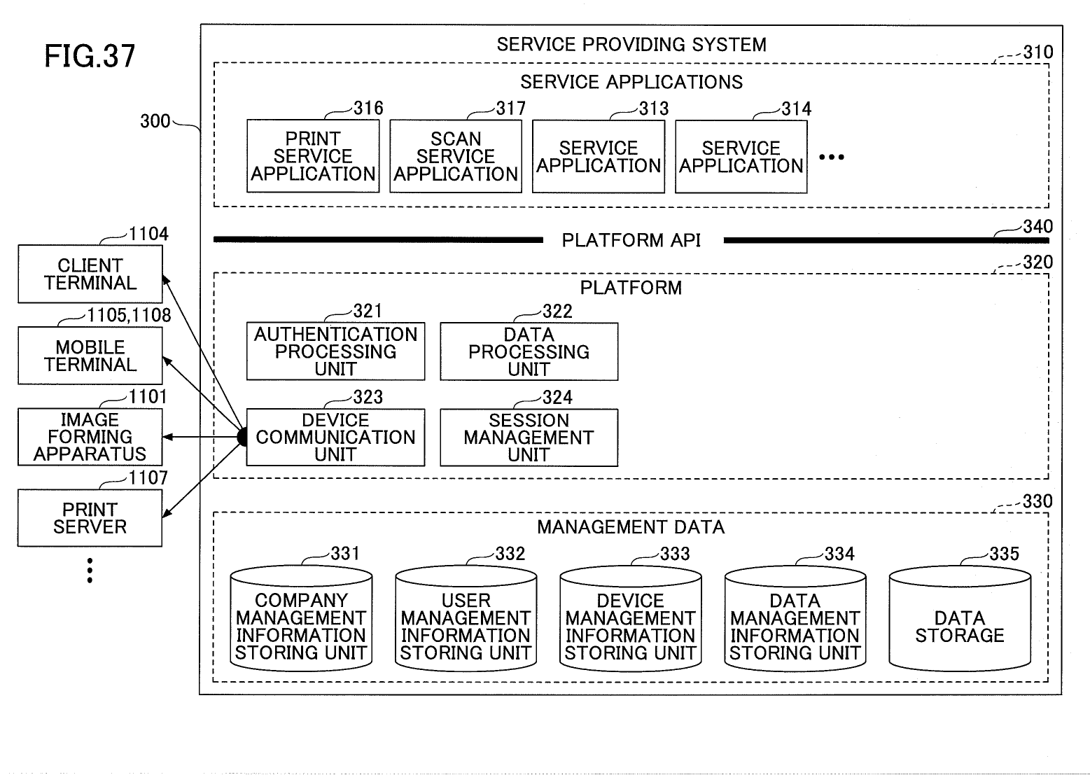

As illustrated in FIG. 38A, the print service application 316 illustrated in FIG. 37 includes the process execution control unit 3165 and a process execution information storing unit 3166 that stores process execution information such as that illustrated in FIG. 39A. The process execution control unit 3165 refers to the process execution information stored in the process execution information storing unit 3166 to determine a process (function) to be executed. In this way, a function to be executed may be determined based on information obtained from biometric authentication performed by the authentication processing unit 321.

FIG. 38A illustrates an exemplary functional configuration of the print service application 316 of the information processing system of FIG. 36. FIG. 38B illustrates an exemplary functional configuration of the image forming apparatus 1101 of the information processing system of FIG. 36. FIG. 39A is a table illustrating an exemplary data configuration of process execution information stored in the process execution information storing unit 3166 of the print service application 316. FIG. 39B is a table illustrating an exemplary data configuration of company management information stored in the company management information storing unit 331 illustrated in FIG. 37. FIG. 39C is a table illustrating an exemplary data configuration of user management information stored in the user management information storing unit 332 illustrated in FIG. 37. FIG. 39D is a table illustrating an exemplary data configuration of device management information stored in the device management information storing unit 333 illustrated in FIG. 37.

Note that the company management information of FIG. 39B may be similar to the company management information of FIG. 30A of the ninth embodiment. Also, the device management information of FIG. 39D may be similar to the device management information of FIG. 30C of the ninth embodiment.

On the other hand, in the user management information of FIG. 39C, biometric information of different body parts (e.g., thumb, middle finger) of each user of each company are registered. Also, in the process execution information of FIG. 39A, a corresponding process (function) to be executed is registered with respect to each biometric information item (e.g., thumb or finger) registered for each user of each company. Note that “authentication information 2” and “authentication information 3” of FIG. 39A respectively correspond to “authentication information 2 (thumb)” and “authentication information 3 (middle finger)” of FIG. 39C.

### Other Embodiments

Note that embodiments of the present invention are not limited applications for an image forming apparatus. Rather, aspects of the present invention may equally be applied to other various devices and apparatuses including a projector, an electronic blackboard, and a mobile terminal (e.g., mobile phone, PDA, smart phone). For example, in the case of using a projector, an image projecting function, a reservation setting function, and further functions such as 1-page/screen image projection, or 2-pages/screen image projection may be contemplated as functions to be executed. Accordingly, various types of authentication information (including biometric information) may be assigned to these functions so that these functions may be executed upon successful authentication through the corresponding authentication method, for example. Also, similar embodiments may be conceived using other types of devices and apparatuses as well.

According to an aspect of the present invention, a specific function of a device or apparatus having multiple functions may be associated with specific authentication information or authentication method. In this way, when a user performs authentication using the specific authentication information or authentication method, the corresponding function maybe automatically executed.

Although the present invention has been described above with reference to certain illustrative embodiments, the present invention is not limited to these embodiments, and numerous variations and modifications may be made without departing from the scope of the present invention.

The present invention can be implemented in any convenient form, for example, using dedicated hardware, or a mixture of dedicated hardware and software. The present invention may be implemented as computer software implemented by one or more networked processing apparatuses. The network can comprise any conventional terrestrial or wireless communications network, such as the Internet. The processing apparatuses can comprise any suitably programmed apparatuses such as a general purpose computer, personal digital assistant, mobile telephone (such as a WAP or 3G-compliant phone) and so on. Since the present invention can be implemented as software, each and every aspect of the present invention thus encompasses computer software implementable on a programmable device. The computer software can be provided to the programmable device using any non-transitory storage medium for storing processor readable code such as a floppy disk, a hard disk, a CD ROM, a magnetic tape device or a solid state memory device. The non-transitory storage medium can comprise any computer-readable medium except for a non-statutory transitory, propagating signal.

The hardware platform includes any desired hardware resources including, for example, a central processing unit (CPU), a random access memory (RAM), and a hard disk drive (HDD). The CPU may include processors of any desired type and number. The RAM may include any desired volatile or nonvolatile memory. The HDD may include any desired nonvolatile memory capable of recording a large amount of data. The hardware resources may further include an input device, an output device, and a network device in accordance with the type of the apparatus. The HDD may be provided external to the apparatus as long as the HDD is accessible from the apparatus. In this case, the CPU, for example, the cache memory of the CPU, and the RAM may operate as a physical memory or a primary memory of the apparatus, while the HDD may operate as a secondary memory of the apparatus.

What is claimed is:

1. An information processing system comprising:
a function unit having a plurality of functions;
an execution command unit that prompts the function unit to execute one of the plurality of functions;
an authentication information obtaining unit that obtains authentication information of a user; and
a user authentication and function determination unit that authenticates the user based on the authentication information of the user and determines one function from the plurality of functions;
wherein the execution command unit prompts the function unit to execute the one function determined by the user authentication and function determination unit.

2. The information processing system as claimed in claim 1, wherein:
the user authentication and function determination unit includes
an authentication information managing unit that manages records of authentication information in association with authentication information identification information that identifies the authentication information;
an authentication unit that obtains corresponding authentication information identification information associated with the authentication information of the user by searching the records of authentication information managed by the authentication information managing unit based on the authentication information of the user;
an authentication information identification information managing unit that manages records of authentication information identification information in association with the plurality of functions; and
a function determining unit that determines the one function from the plurality of functions by searching the records of authentication information identification information managed by the authentication information identification information managing unit based on the corresponding authentication information identification information;
wherein the information processing system includes
a device including the function unit,
the execution command unit, the authentication information obtaining unit, the authentication information identification information managing unit, and the function determining unit; and
an authentication apparatus including the authentication information managing unit and the authentication unit;
wherein the authentication unit of the authentication apparatus obtains the corresponding authentication information identification information by searching the records of authentication information managed by the authentication information managing unit based on the authentication information of the user obtained by the authentication information obtaining unit of the device;
the function determining unit of the device determines the one function from the plurality of functions by searching the records of authentication information identification information managed by the authentication information identification information managing unit based on the corresponding authentication information identification information obtained by the authentication unit of the authentication apparatus; and
the execution command unit of the device prompts the function unit to execute the one function determined by the function determining unit.

3. The information processing system as claimed in claim 1, further comprising:
a device including the function unit, the authentication information obtaining unit, and the execution command unit; and
an authentication apparatus including an authentication information managing unit that manages records of authentication information in association with the plurality of functions, and an authentication unit that determines the one function from the plurality of functions by searching the records of authentication information managed by the authentication information managing unit based on the authentication information of the user;
wherein the authentication unit of the authentication apparatus determines the one function from the plurality of functions by searching the records of authentication information managed by the authentication information managing unit based on the authentication information of the user obtained by the authentication information obtaining unit of the device; and
the execution command unit of the device prompts the function unit to execute the one function determined by the authentication unit of the authentication apparatus.

4. The information processing system as claimed in claim 1, wherein
the user authentication and function determination unit includes
an authentication information managing unit that manages records of authentication information in association with authentication information identification information that identifies the authentication information;
an authentication unit that obtains corresponding authentication information identification information associated with the authentication information of the user by searching the records of authentication information managed by the authentication information managing unit based on the authentication information of the user;
an authentication information identification information managing unit that manages records of authentication information identification information in association with the plurality of functions; and
a function determining unit that determines the one function from the plurality of functions by searching the records of authentication information identification information managed by the authentication information identification information managing unit based on the corresponding authentication information identification information;
wherein the information processing system includes
a device including the authentication information obtaining unit and the execution command unit;
an authentication apparatus including the authentication information managing unit and the authentication unit; and
an authentication control apparatus including the authentication information identification information managing unit and the function determining unit;
wherein the authentication unit of the authentication apparatus obtains the corresponding authentication information identification information by searching the records of authentication information managed by the authentication information managing unit based on the authentication information of the user obtained by the authentication information obtaining unit of the device;
the function determining unit of the authentication control apparatus determines the one function from the plurality of functions by searching the records of authentication information identification information managed by the authentication information identification information managing unit based on the corresponding authentication information identification information obtained by the authentication unit of the authentication apparatus; and
the execution command unit of the device prompts the function unit to execute the one function determined by the function determining unit of the authentication control apparatus.

5. The information processing system as claimed in claim 1, wherein
the function unit includes a first function unit and a second function unit;
the information processing system includes
a device including the first function unit; and
an information processing apparatus including the second function unit;
wherein the user authentication and function determination unit determines the one function from a plurality of functions of the first function unit and the second function unit based on the authentication information of the user; and
the execution command unit prompts a relevant one of the first function unit and the second function unit to execute the one function determined by the user authentication and function determination unit.

6. The information processing system as claimed in claim 1, wherein
the user authentication and function determination unit includes
an authentication information managing unit that manages records of authentication information in association with authentication information identification information that identifies the authentication information;
an authentication unit that obtains corresponding authentication information identification information associated with the authentication information of the user by searching the records of authentication information managed by the authentication information managing unit based on the authentication information of the user;
an authentication information identification information managing unit that manages records of authentication information identification information in association with the plurality of functions; and
a function determining unit that determines the one function from the plurality of functions by searching the records of authentication information identification information managed by the authentication information identification information managing unit based on the corresponding authentication information identification information;
wherein the information processing system includes
a device including the authentication information obtaining unit; and
an information processing apparatus including the function unit, the authentication information managing unit, the authentication unit, the authentication information identification information managing unit, the function determining unit, and the execution command unit;
wherein the authentication unit of the information processing apparatus obtains the corresponding authentication information identification information by searching the records of authentication information managed by the authentication information managing unit based on the authentication information of the user obtained by the authentication information obtaining unit of the device;
the function determining unit of the information processing apparatus determines the one function from the plurality of functions by searching the records of authentication information identification information managed by the authentication information identification information managing unit based on the corresponding authentication information identification information obtained by the authentication unit; and
the execution command unit of the information processing apparatus prompts the function unit to execute the one function determined by the function determining unit.

7. The information processing system as claimed in claim 6, wherein
the information processing apparatus includes a plurality of information processing apparatuses; and
the plurality of information processing apparatuses are configured to cooperatively execute a function of the user authentication and function determination unit for obtaining the corresponding authentication information identification information by searching the records of authentication information managed by the authentication information managing unit based on the authentication information of the user, and determining the one function from the plurality of functions by searching the records of authentication information identification information managed by the authentication information identification information managing unit based on the corresponding authentication information identification information.

8. The information processing system as claimed in claim 5, wherein
the device is included in a first information processing system established at a first organization; and
the information processing apparatus is included in a second information processing system established at a second organization that is different from the first organization.

9. The information processing system as claimed in claim 1, wherein the authentication information includes biometric information.

10. The information processing system as claimed in claim 1, wherein
the authentication information includes a plurality of authentication information items with respect to one user;
the user authentication and function determination unit authenticates the one user based on one authentication information item of the plurality of authentication information items and determines one function corresponding to the one authentication information item from the plurality of functions; and
the execution command unit executes the one function determined by the user authentication and function determination unit.

11. The information processing system as claimed in claim 9, wherein the biometric information includes biometric information of a finger.

12. The information processing system as claimed in claim 1, further comprising:
an image forming apparatus;
wherein the plurality of functions includes a function using at least one of a copy function, a scan function, and a print function of the image forming apparatus.

13. The information processing system as claimed in claim 1, wherein
the user authentication and function determination unit authenticates the user based on the authentication information of the user, determines the one function from the plurality of functions, and obtains login information of the user; and
the execution command unit performs a login operation for logging into an apparatus having the one function using the login information of the user obtained by the user authentication and function determination unit, and prompts the apparatus to execute the one function.

14. The information processing system as claimed in claim 2, wherein
the device is included in a first information processing system established at a first organization; and
the authentication apparatus is included in a second information processing system established at a second organization that is different from the first organization.

15. The information processing system as claimed in claim 3, wherein
the device is included in a first information processing system established at a first organization; and
the authentication apparatus is included in a second information processing system established at a second organization that is different from the first organization.

16. The information processing system as claimed in claim 4, wherein
the device is included in a first information processing system established at a first organization; and
the authentication apparatus is included in a second information processing system established at a second organization that is different from the first organization.

17. The information processing system as claimed in claim 4, wherein
the device is included in a first information processing system established at a first organization; and
the authentication control apparatus is included in a second information processing system established at a second organization that is different from the first organization.

18. A device comprising:
a function unit having a plurality of functions;
an execution command unit that prompts the function unit to execute one of the plurality of functions; and
an authentication information obtaining unit that obtains authentication information of a user;
wherein the execution command unit prompts the function unit to execute one function determined by a user authentication and function determination unit that authenticates the user based on the authentication information of the user and determines the one function from the plurality of functions.

19. An authentication apparatus comprising:
a user authentication and function determination unit that authenticates a user based on authentication information of the user and determines one function from a plurality of functions, or an authentication unit that authenticates the user and obtains authentication information identification information that identifies the authentication information of the user;
wherein a function unit having the one function determined by the user authentication and function determination unit executes the one function, or a function determining unit determines the one function from the plurality of functions based on the authentication information identification information obtained by the authentication unit and the function unit executes the one function determined by the function determining unit.
